(19) United States
(12) Patent Application Publication
(10) Pub. No.: US 2026/0020935 A1
(43) Pub. Date: Jan. 22, 2026

(54) DENTAL FILLING RETAINMENT DEVICE AND METHODS OF USING SAME

(71) Applicant: Infinity Matrix, Inc., Santa Cruz, CA (US)

(72) Inventors: Mark Ryan Christie, Santa Cruz, CA (US); Stephen Riddle McDaniel, San Rafael, CA (US); Henry Hsu, Aliso Viejo, CA (US)

(21) Appl. No.: 19/269,698

(22) Filed: Jul. 15, 2025

Related U.S. Application Data
(60) Provisional application No. 63/672,086, filed on Jul. 16, 2024.
(60) Provisional application No. 63/804,369, filed on May 12, 2025.
(60) Provisional application No. 63/823,661, filed on Jun. 13, 2025.

(51) Int. Cl. A61C 3/16

(52) U.S. Cl. CPC A61C 5/88; A61C 5/85

(57) ABSTRACT

A dental matrix device positioned between a pair of teeth, the device having a first guide member, a second guide member, and a matrix band. The first guide member configured to be positioned on a first side of the pair of teeth and a second guide member configured to be positioned on a second side of the pair of teeth. The matrix band configured to, in the operable state, extend around at least a portion of the first guide member, between the pair of teeth, and around at least a portion of the second guide member, where the second side of the pair of teeth is opposite the first side of the pair of teeth, and the matrix band is configured to provide a barrier between the teeth during a dental procedure.

### INCORPORATION BY REFERENCE TO ANY PRIORITY APPLICATIONS

This application claims the benefit of priority to U.S. Provisional Application No. 63/672,086, filed Jul. 16, 2024, U.S. Provisional Application No. 63/804,369, filed May 12, 2025, and U.S. Provisional Application No. 63/823,661, filed Jun. 13, 2025. Each of the above-referenced applications are incorporated by reference herein in its entirety. Any and all applications for which a foreign or domestic priority claim is identified in the Application Data Sheet as filed with the present application are hereby incorporated by reference under 37 CFR 1.57.

### BACKGROUND

### Field

The following described device and methods relate to the repair of interproximal tooth damage from caries, fracture, or previous failed dental fillings, and the iterations of dental matrix band devices currently used in dentistry for the restoration of teeth.

### Description of the Related Art

Dental caries is a biofilm-mediated disease which causes demineralization and physical damage to the structure of teeth. Dental caries require surgical intervention when the surface of the tooth is damaged to a point of physical cavitation. Repairs made to damaged teeth require the removal of damaged tooth structure and replacement with a dental filling material approximating the original form of the natural tooth. Clinically, one of the more common and challenging locations to repair dental caries is the space between adjacent teeth, also called the interproximal surface. A dental matrix band system is required to place filling material interproximally. Matrix bands serve in providing stable confinement during placement of dental filling material when repairing the interproximal tooth structure. Matrix bands also provide anatomical replication of tooth contour from the proximal cervical margin to the top of the marginal ridge.

Matrix bands are important to contain the dental filling material inside a surgically prepared tooth for repairing interproximal tooth damage from caries, fracture, or previous failed dental fillings. However, the existing systems and methods for placing and retaining dental matrix bands present many difficulties and challenges. First, existing systems are generally not conservative, requiring excessive tooth removal to achieve consistent results. Second, existing systems are generally technique sensitive, having a narrow functional envelope which is challenged by routine patient anatomical variation leading to unpredictable rates of success. Third, existing systems are generally time consuming, requiring the placement of multiple components and can be unstable when set up in the mouth.

Widely used dental matrices such as circumferential bands and sectional matrix bands have limitations leading to variable outcomes. Some of the common challenges to producing reliable restorations using the aforementioned are: (1) light or open contacts between teeth after band is removed due to insufficient/no temporary orthodontic distraction; (2) clamp pressure changes over time due to metal fatigue of clamps; (3) time consuming to place matrix band, clamp and wedge; (4) highly technique sensitive to properly place matrix band and stabilize with wedge and clamp; (5) not surgically conservative due to modification of tooth beyond disease to achieve proper adaptation of preformed convex matrix bands; (6) poor contour of matrix bands can lead to final restorations without proper anatomy or function; and (7) excess time and effort required to remove ledges, overhangs and bulk after filling is completed.

Therefore, a need exists for an improved matrix band system that allows for conservative tooth removal, is less sensitive to technique, and is less time consuming to set up and operate.

### SUMMARY OF SOME EXAMPLE EMBODIMENTS

Various implementations of systems, methods, and devices within the scope of the appended claims each have several aspects, no single one of which is solely responsible for the desirable attributes described herein. Without limiting the scope of the appended claims, the description below describes some prominent features.

Details of one or more implementations of the subject matter described in this specification are set forth in the accompanying drawings and the description below. Other features, aspects, and advantages will become apparent from the description, the drawings, and the claims. Note that relative dimensions of the following figures may not be drawn to scale.

Disclosed herein are embodiments of a dental matrix device. In some embodiments, the dental matrix device, includes a first guide member including a body portion having a proximal end and a distal end, the first guide member configured to be positioned on a first side of a pair of teeth such that, in an operable state of the dental matrix device, the distal end of the body portion of the first guide member is positioned closer to the pair of teeth than the proximal end of the first guide member, a second guide member including a body portion including a proximal end and a distal end, the second guide member configured to be positioned on a second side of the pair of teeth such that, in the operable state, the distal end of the body portion of the second guide member is positioned closer to the pair of teeth than the proximal end of the second guide member, and a matrix band configured to, in the operable state of the dental matrix device, extend around at least a portion of the first guide member, between the pair of teeth, and around at least a portion of the second guide member, where the second side of the pair of teeth is opposite the first side of the pair of teeth, and the matrix band is configured to provide a barrier between the teeth during a dental procedure.

In some embodiments, the distal end of the first guide member includes a wedge shape, and the distal end of the second guide member includes a wedge shape.

In some embodiments, in the operable state of the dental matrix device, the dental matrix device is configured to force the first guide member to move toward the second guide member when the matrix band is tightened around at least a portion of the first and the second guide members.

In some embodiments, the first guide member includes a first retainment element, where the first guide member is configured to receive the matrix band between the first retainment element of the first guide member and an outside surface of the body portion of the first guide member such that at least a portion of the matrix band is positioned between the first retainment element of the first guide member and the body portion of the first guide member in the operable state.

In some embodiments, the first guide member includes a second retainment element, where the first guide member is configured to receive the matrix band between the second retainment element of the first guide member and an outside surface of the body portion of the first guide member such that at least a portion of the matrix band is positioned between the second retainment element of the first guide member and the body portion of the first guide member in the operable state.

In some embodiments, the first retainment element includes a first portion extending towards the distal end of the body portion and a second portion extending towards a bottom of the body portion, and the second retainment element includes a first portion extending towards the distal end of the body portion and a second portion extending towards the bottom of the body portion.

In some embodiments, the second portion of the first retainment element is positioned towards the distal end of the body portion and the second portion of the second retainment element is positioned towards the distal end of the body portion.

In some embodiments, a distal edge of the first portion of the first retainment element tapers proximally from a top of the first portion to the bottom of the first portion such that the top of the first portion of the first retainment element extends further in a distal direction than the bottom of the first portion of the first retainment element, and a distal edge of the first portion of the second retainment element tapers proximally from a top of the first portion to the bottom of the first portion such that the top of the first portion of the second retainment element extends further in a distal direction than the bottom of the first portion of the second retainment element.

In some embodiments, the dental matrix device further includes an over-mold on an outer surface of the first retainment element and an over-mold on an outer surface of the second retainment element.

In some embodiments, the dental matrix device further includes a gap between the first retainment element and the second retainment element such that at least a portion of the matrix band extends through the gap.

In some embodiments, the first retainment element and the second retainment element are integral to a cap positioned over the body portion of the first guide member.

In some embodiments, the first retainment element further includes a snap configured to engage with the body portion of the first guide member.

In some embodiments, the second guide member includes a first retainment element, where the second guide member is configured to receive the matrix band between the first retainment element of the second guide member and an outside surface of the body portion of the second guide member such that at least a portion of the matrix band is positioned between the first retainment element of the second guide member and the body portion of the second guide member in the operable state.

In some embodiments, the second guide member includes a second retainment element, where the second guide member is configured to receive the matrix band between the second retainment element of the second guide member and an outside surface of the body portion of the second guide member such that at least a portion of the matrix band is positioned between the second retainment element of the second guide member and the body portion of the second guide member in the operable state.

In some embodiments, the dental matrix device further includes a gap between the first retainment element and the second retainment element such that at least a portion of the matrix band extends through the gap.

In some embodiments, the first retainment element is integral to a cap positioned over the body portion of the second guide member.

In some embodiments, the first guide member includes a first lower retainment element positioned closer to a bottom than a top of the first guide member, where the first guide member is configured to receive the matrix band between the first lower retainment element of the first guide member and an outside surface of the body portion of the first guide member such that at least a portion of the matrix band is positioned between the first lower retainment element of the first guide member and the body portion of the first guide member in the operable state.

In some embodiments, first guide member includes a second lower retainment element positioned closer to a bottom than a top of the first guide member, where the first guide member is configured to receive the matrix band between the second retainment element of the first guide member and the outside surface of the body portion of the first guide member such that at least a portion of the matrix band is positioned between the second retainment element of the first guide member and the body portion of the first guide member in the operable state.

In some embodiments, each of the first and the second retainment elements of the first guide member includes a first portion extending upward along a height of the first guide member and a second portion extending towards the distal end of the body portion of the first guide member.

In some embodiments, the first and the second retainment elements of the first guide member are integral to the body portion of the first guide member.

In some embodiments, the first and the second retainment elements of the first guide member are separate from and attached to the body portion of the first guide member.

In some embodiments, the first guide member includes a first lower retainment element positioned closer to a bottom than a top of the first guide member, where the first retainment element extends over the first lower retainment element, and where the first lower retainment element is configured to receive the matrix band between the first lower retainment element of the first guide member and an outside surface of the body portion of the first guide member such that at least a portion of the matrix band is positioned between the first lower retainment element of the first guide member and the body portion of the first guide member in the operable state.

In some embodiments, the first guide member includes a second retainment element positioned closer to the bottom than the top end of the first guide member, where the second retainment element extends over the second retainment element, and where the second retainment element is configured to receive the matrix band between the second retainment element of the first guide member and an outside surface of the body portion of the first guide member such that at least a portion of the matrix band is positioned between the second retainment element of the first guide member and the body portion of the first guide member in the operable state.

In some embodiments, the second guide member includes a first lower retainment element, where the second guide member is configured to receive the matrix band between the first lower retainment element of the second guide member and an outside surface of the body portion of the second guide member such that at least a portion of the matrix band is positioned between the first lower retainment element of the second guide member and the body portion of the second guide member in the operable state.

In some embodiments, the second guide member includes a second retainment element, where the second guide member is configured to receive the matrix band between the second retainment element of the second guide member and the outside surface of the body portion of the second guide member such that at least a portion of the matrix band is positioned between the second retainment element of the second guide member and the body portion of the second guide member in the operable state.

In some embodiments, an angle between a proximal edge of the first lower retainment element and a proximal edge of the second retainment element of the second guide member is between 90 and 150 degrees.

In some embodiments, a most proximal edge of the first lower retainment element is proximal from a most distal edge of the first lower retainment element and where a most proximal edge of the second lower retainment element is proximal from a most distal edge of the second lower retainment element.

In some embodiments, each of the first and the second retainment elements of the second guide member includes a first portion extending upward along a height of the second guide member and a second portion extending towards the distal end of the body portion of the second guide member.

In some embodiments, the first and the second retainment elements of the second guide member are integral to the body portion of the second guide member.

In some embodiments, the first and the second retainment elements of the second guide member are separate from and attached to the body portion of the second guide member.

In some embodiments, the body portion of each of the first guide member and the second guide member has a tapered shaped where, in the operable state, the proximal end the body portion of the first guide member is wider than the distal end of the body portion of the first guide member and the proximal end the body portion of the second guide member is wider than the distal end of the body portion of the second guide member.

In some embodiments, the distal end of the body portion of each of the first and the second guide members is longer at a lower portion than at an upper portion.

In some embodiments, the dental matrix device further includes silicone over-molding.

In some embodiments, each of the first guide member and the second guide member includes a retainment element.

In some embodiments, a matrix retainer configured to generate a tension force in the matrix band.

In some embodiments, the matrix retainer is attached to the matrix band against the proximal end of the first guide member.

In some embodiments, the body portion of each of the first and the second guide members includes a first width at a bottom of the body portion and a second width at a top of the body portion where the first width is wider than the second width.

Disclosed herein are embodiments of a method of providing stable confinement during placement of dental filling material when repairing an interproximal tooth structure. In some embodiments, the method includes providing a dental matrix device including a first guide member, a second guide member, and a matrix band, positioning the matrix band around the first and the second guide members, passing the matrix band between a first pair of teeth with the first guide member positioned on a first side of the first pair of teeth and the second guide member positioned on a second side of the first pair of teeth, and constricting the matrix band around the first and the second guide members to cause the first guide member to move toward the second guide member.

In some embodiments, the method further includes providing a second dental matrix device including a first guide member, a second guide member, and a matrix band, positioning the matrix band around the first and the second guide members, passing the matrix band between a second pair of teeth with the first guide member positioned on a first side of the second pair of teeth and the second guide member positioned on a second side of the second pair of teeth, where the second pair of teeth is in successive to the first pair of teeth, and constricting the matrix band around the first and the second guide members to cause the first guide member to move towards the second guide member.

In some embodiments, the method further includes attaching a cap to the first guide member over the matrix band and attaching a second cap to the second guide member over the matrix band.

Disclosed herein are embodiments of a system for performing a repair of dental defects. In some embodiments, the system includes a first guide member including a body portion including a proximal end and a distal end, the first guide member configured to be positioned on a first side of a pair of teeth such that, in an operable state, the distal end of the body portion of the first guide member is positioned closer to the pair of teeth than the proximal end of the first guide member, a second guide member including a body portion including a proximal end and a distal end, the second guide member configured to be positioned on a second side of the pair of teeth such that, in the operable state, the distal end of the body portion of the second guide member faces toward the pair of teeth, a matrix band configured to, in the operable state, extend around at least a portion of the first guide member, between the pair of teeth, and around at least a portion of the second guide member, and a matrix retainer configured to selectively tighten the matrix band around the first and the second guide members in the operable state of the system.

Disclosed herein are embodiments of a dental matrix device configured to be positioned between a pair of teeth. In some embodiments, the dental matrix device includes a first matrix band extending from a first end of the first matrix band to a second end of the first matrix band, the first matrix band having a first coupling element at the first end of the first matrix band and a second coupling element at the second end of the first matrix band, a second matrix band extending from a first end of the second matrix band to a second end of the second matrix band, the second matrix band having a first coupling element at the first end of the second matrix band and a second coupling element at the second end of the second matrix band, a first guide member configured to be positioned on a first side of the pair of teeth, where at least a portion of the first guide member is positioned between the first matrix band and the second matrix band, a second guide member configured to be positioned on a second side of the pair of teeth, where the second side is opposite the first side and where at least a portion of the second guide member is positioned between the first matrix band and the second matrix band, a first retainment member coupled with the first end of the first matrix band and the first end of the second matrix band at least when the dental matrix device is in an operable state, and a second retainment member coupled with the second end of the first matrix band and the second end of the second matrix band at least when the dental matrix device is in the operable state, and where the dental matrix device is configured to bias the first guide member toward the second guide member when the dental matrix device is in the operable state.

In some embodiments, the first guide member has a first channel and a second channel, where the first matrix band is positioned at least partially within the first channel, and where the second matrix band is positioned at least partially within the second channel.

In some embodiments, each of the first guide member and the second guide member are wedge shaped.

In some embodiments, each of the first guide member and the second guide member have a tapered shaped where, in the operable state, an end of the first guide member and an end of the second guide member that are further away from the pair of teeth are wider than an end of the first guide member and an end of the second guide member that are closer to the pair of teeth.

In some embodiments, the first guide member includes a narrow end and a wide end, the second guide member includes a narrow end and a wide end, and the narrow end of the first guide member faces the narrow end of the second guide member.

In some embodiments, the first retainment member includes a first retainment portion attached to the first coupling element of the first matrix band and a second retainment portion attached to the first coupling element of the second matrix band, and the second retainment member includes a first retainment portion attached to the second coupling element of the first matrix band and a second retainment portion attached to the second coupling element of the second matrix band.

In some embodiments, the first coupling element of the first matrix band is a loop configured to receive the first retainment portion of the first retainment member, and the second coupling element of the first matrix band is a loop configured to receive the first retainment portion of the second retainment member, and the first coupling element of the second matrix band is a loop configured to receive the second retainment portion of the first retainment member, and the second coupling element of the second matrix band is a loop configured to receive the second retainment portion of the second retainment member.

In some embodiments, the first retainment member is a torsional spring and the second retainment member is a torsional spring.

In some embodiments, the first retainment member further includes a first helically coiled portion and the second retainment member further includes a second helically coiled portion.

In some embodiments, the first helically coiled portion and the second helically coiled portion are each configured to receive a tip of a snap ring pliers.

In some embodiments, the dental matrix device further includes a first cover element positioned over the first guide member and a second cover element positioned over the second guide member.

In some embodiments, the first guide member and the second guide member each include an hourglass shaped profile.

In some embodiments, each of the first guide member and the second guide member includes a mounting feature.

Disclosed herein are embodiments of a method of providing stable confinement during placement of dental filling material when repairing an interproximal tooth structure. In some embodiments, the method includes providing a dental matrix device including a first retainment member, a second retainment member, a pair of matrix bands, and a pair of guide members, applying an opposing force to the first retainment member and the second retainment member to move the first retainment member away from the second retainment member and to move the pair of matrix bands extending between the first retainment member and the second retainment member into an extended state, passing the extended matrix bands between a pair of teeth, and reducing the opposing force to cause the first retainment member to move toward the second retainment member or the second retainment member to move toward the first retainment member.

In some embodiments, the method further includes guiding each matrix band of the pair of matrix bands around a portion of one of the pair of teeth via the pair of guide members positioned between the matrix bands.

Disclosed herein are embodiments of a kit for performing a repair of dental caries. In some embodiments, the kit includes a first wedge shaped guide member, a second wedge shaped guide member, a first retainment member configured to couple to one or more matrix bands, and a second retainment member configured to couple to the one or more matrix bands.

In some embodiments, the kit further includes one or more matrix bands.

Disclosed herein are embodiments of a dental matrix device configured to be positioned between a pair of teeth. In some embodiments, the dental matrix device includes a first wedge shaped guide member configured to be positioned on a proximal side of the pair of teeth, a second wedge shaped guide member configured to be positioned on a distal side of the pair of teeth, where the distal side is opposite the proximal side, a first retainment member positioned proximal to the first guide member, the first retainment member including a helically coiled portion, a first retainment portion, and a second retainment portion, and a second retainment member positioned distal to the second guide member, the second retainment member including a helically coiled portion, a first retainment portion, and a second retainment portion.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only some embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein and illustrated in the figures, may be arranged, substituted, combined, and designed in a wide variety of different configurations, all of which are explicitly contemplated and make part of this disclosure.

FIG. 1 shows a view of an embodiment of a dental matrix device, a portion of which is placed between a pair of teeth.

FIG. 2 shows another view of the embodiment of the dental matrix device shown in FIG. 1.

FIG. 3 shows a view of an embodiment of a dental matrix device, a portion of which is placed between a pair of teeth.

FIG. 4 shows a perspective view of an embodiment of a guide member.

FIG. 5A shows a perspective view of another embodiment of a guide member.

FIG. 5B shows another perspective view of the embodiment of the guide member illustrated in FIG. 5A.

FIG. 6 shows a perspective view of another embodiment of a guide member.

FIG. 7 shows a perspective view of the embodiment of a guide member illustrated in FIG. 3.

FIG. 8 shows a perspective view of another embodiment of a guide member.

FIG. 9 shows a perspective view of another embodiment of a guide member.

FIG. 10 shows a perspective view of another embodiment of a guide member.

FIG. 11A shows a perspective view of another embodiment of a guide member.

FIG. 11B shows another perspective view of the embodiment of the guide member illustrated in FIG. 11A.

FIG. 12 shows a view of another embodiment of a dental matrix device, a portion of which is placed between a pair of teeth.

FIG. 13A shows a perspective view of another embodiment of a guide member.

FIGS. 13B and 13C show exploded perspective views of the embodiment of the guide member illustrated in FIG. 13A.

FIG. 13D shows a multi-view drawing of the embodiment of the guide member illustrated in FIG. 13A.

FIG. 14A shows a perspective view of another embodiment of a guide member.

FIGS. 14B and 14C show exploded perspective views of the embodiment of the guide member illustrated in FIG. 13A.

FIG. 14D shows a multi-view drawing of the embodiment of the guide member illustrated in FIG. 14A.

FIG. 15 shows a flow chart illustrating a method of providing stable confinement during placement of dental filling material when repairing an interproximal tooth structure.

FIG. 16 shows a view of a pair of dental matrix devices of the embodiment illustrated in FIG. 13A, a portion of each dental matrix device placed between a pair of teeth in successive pairs of teeth.

FIG. 17 shows a perspective view of another embodiment of a dental matrix device.

FIG. 18A shows a perspective view of an embodiment of a dental matrix device being placed between a pair of teeth, showing the embodiment of the dental matrix device being spread apart by a spreader device.

FIG. 18B shows a perspective view of the embodiment of the dental matrix device shown in FIG. 18A placed between a pair of teeth, after the dental matrix device has been released from the spreader device.

FIG. 18C shows a flow chart illustrating a method of placing a dental matrix device.

FIG. 19 shows a perspective view illustrating an embodiment of a pair of guide members positioned in a space between a pair of teeth.

FIG. 20 shows a perspective view of the embodiment of the guide member shown in FIG. 19.

FIG. 21 shows a top view of the embodiment of the guide member shown in FIG. 19.

FIG. 22 shows a rear view of the embodiment of the guide member shown in FIG. 19.

FIG. 23 shows a front view of the embodiment of the guide member shown in FIG. 19.

FIG. 24 shows a side view of the embodiment of the guide member shown in FIG. 19.

FIG. 25 shows a perspective view of an embodiment of a matrix band.

FIG. 26 shows a perspective view of another embodiment of a matrix band.

FIG. 27 shows a top view of an embodiment of a cover element.

FIG. 28 shows a top view of another embodiment of a guide member.

FIG. 29 shows a side view of the embodiment of the guide member shown in FIG. 28.

### DETAILED DESCRIPTION

Embodiments of systems, components, devices, methods of assembly, and/or methods of manufacture will now be described with reference to the accompanying figures, wherein like numerals refer to like or similar elements throughout. Although multiple embodiments, examples, and illustrations are disclosed herein, the embodiments described herein extend beyond the specifically disclosed embodiments, examples, and illustrations disclosed herein and can include other uses of the inventions and modifications and equivalents thereof, and combinations of any of the embodiments or the components, features, and/or details of any of the embodiments disclosed herein. Additionally, it should be noted that the descriptions of the embodiments disclosed herein should be interpreted to include any of the features, components, and other details of any of the other embodiments disclosed here in combination with or in the alternative to any of the features, components, and other details explicitly described herein. Therefore, any embodiments of the dental matrix band device or components thereof disclosed herein can have any of the features, components, and/or other details of any of the other dental matrix band device embodiments or components thereof disclosed herein, including the matrix band device embodiments and components thereof recited in the claims, to form additional embodiments having any combination of any of the features disclosed herein.

Some embodiments of the devices disclosed herein are directed to an improved dental matrix device. In some embodiments, the improved dental matrix device includes a matrix band that is positionable between a patient's teeth. Some embodiments of the dental matrix device support restoration material during proximal wall construction while carrying anatomical information from the proximal cervical margin to the top of the marginal ridge. For example and without limitation, some embodiments of the dental matrix device conform to the shape and/or curvature of an adjacent tooth from where the root meets the crown, near the gum line, to approximately the highest point of the crown of the tooth. Therefore, some embodiments of the dental matrix device disclosed herein aid in forming a final restoration with functional contact between teeth to prevent food impaction and damage to underlying bone and gingival tissue.

Some embodiments of the dental matrix band device disclosed herein include a pair of guide members (e.g., a first guide member and a second guide member) and a matrix band which, when used together, overcome limitations of conventional devices. Some embodiments of the dental matrix band device disclosed herein include a pair of matrix bands (e.g., a first matrix band and a second matrix band), a pair of guide members (e.g., a first guide member and a second guide member) and a means for retaining the guide members in contact with the adjacent teeth on both sides of the teeth, which when used together, overcomes limitations of previous matrices. Some embodiments of the dental matrix device provide an improved matrix band device that is less technique sensitive to place relative to conventional devices, is faster and easier to place and use relative to conventional devices, features an integrated wedge to reduce steps, has adequate pressure for temporary orthodontic distraction, carries anatomical shape information to provide placement of composite to form a functional tooth restoration using common dental filling materials, and can aid in the repair of two adjacent teeth without additional setup steps.

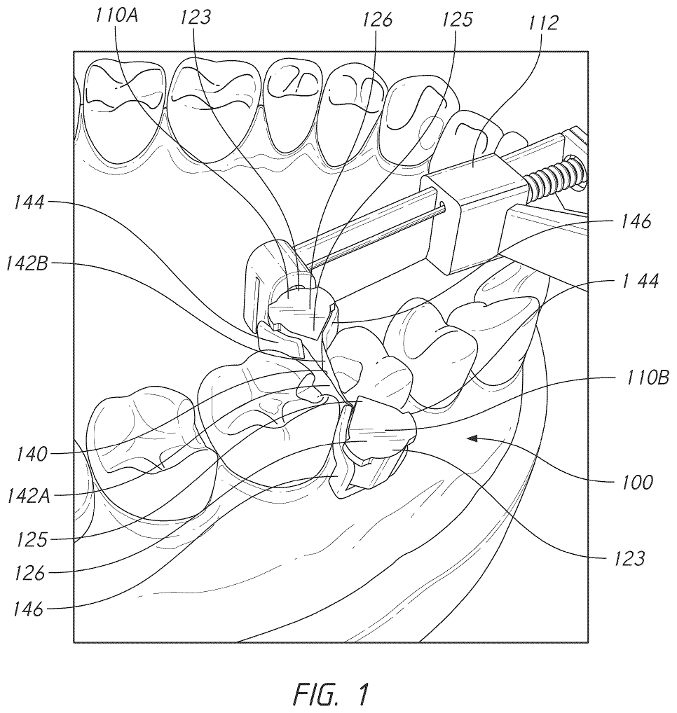

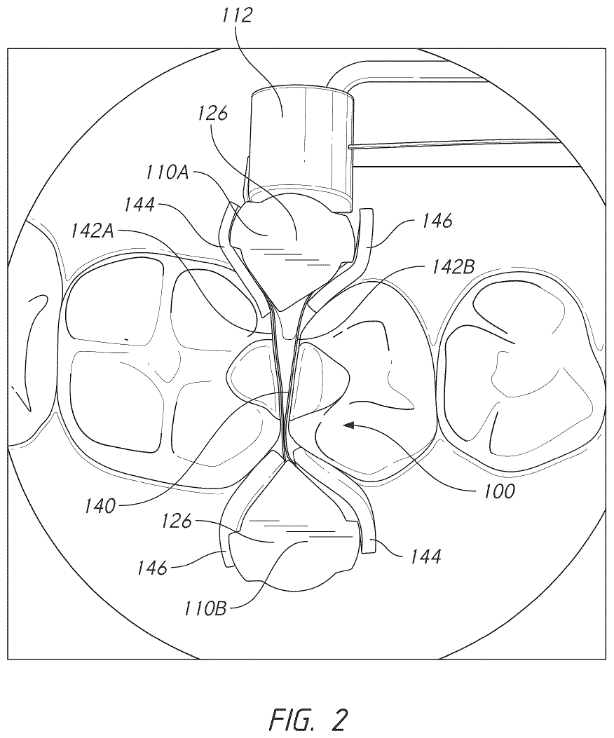

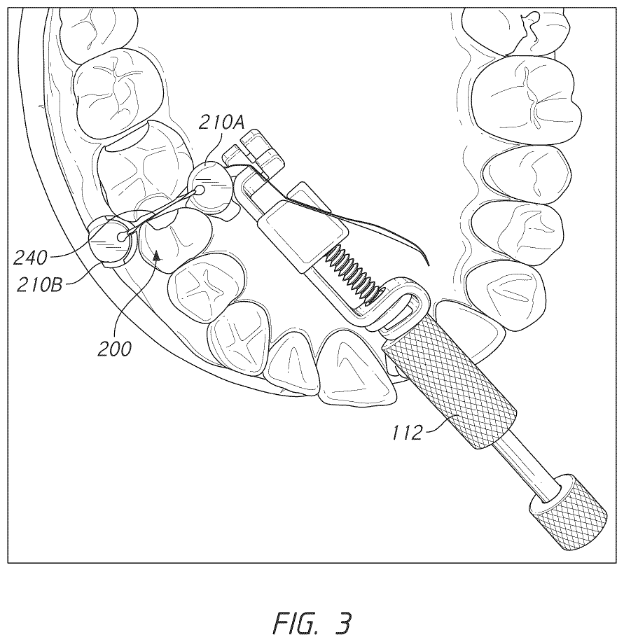

Referring to the drawings, FIGS. 1 and 2 illustrate views of an embodiment of a dental matrix device 100 in an operable state wherein a portion of the dental matrix device 100 is between a pair of teeth. As illustrated, a pair of prepared teeth in a dental model are shown. In some embodiments of the dental matrix device 100, the dental matrix device 100 includes a pair of guide members 110A, 110B, a matrix band 140, and an instrument 112 (referred to herein as a matrix retainer or matrix tensioner) that can be used to at least tension or tighten the matrix band 140. While FIGS. 1 and 2 are illustrated with an embodiment of guide members 110A and 110B, it should be understood that any of the embodiments of guide members described herein in FIGS. 3-14B (e.g., guide members 110, 210, 310, 410, 610, 510, 710, 810, 910, 1010, or 1110) can be installed in the dental matrix device 100 in substantially the same manner as the guide members 110A and 110B. In some embodiments, both ends of the matrix band 140 can be coupled with or held by the instrument so that a middle portion of the matrix band 140 extends from the instrument in looping fashion. A portion of the matrix band 140 can be positioned between a pair of teeth while the matrix band 140 extends or loops completely around a body portion 126 of one of the guide members 110B and around at least a portion of a body portion 126 of the other of the guide members 110A that is closer to the instrument. As the instrument is used to tighten the matrix band 140, the tightening of the matrix band 140 will cause the two guide members 110A, 110B to move toward each other between the teeth, providing the temporary orthodontic distraction needed to perform a dental filling, for example.

The first guide member 110A can include the body portion 126 having a proximal end 123, a distal end 125, a first retainment element 144, and a second retainment element 146. In some embodiments, the proximal end 123 can be the end of the guide member 110A that is further from the subject teeth or is facing away from the subject teeth and the distal end 125 can be the end of the guide member 110A that is closer to the subject teeth or is facing toward the subject teeth. Additionally, in some embodiments, the body portion 126 of the first guide member 110A can be wedge shaped, having a thicker or wider proximal end 123 and tapering to a narrower distal end 125. In some embodiments, the distal end 125 can have a smooth contour or be curved. In some embodiments, the first retainment element 144 and the second retainment element 146 are positioned between the proximal end 123 and the distal end 125 of the first guide member 110A—for example and without limitation, on the sides of the body portion 126 of the first guide member 110A. For example and without limitation, the first retainment element 144 can be on an opposite side of the body portion 126 of the first guide member 110A from the second retainment element 146.

A second guide member 110B can be similar to or identical to the first guide member 110A or at least have any of the same or similar features, in some embodiments. For example and without limitation, the second guide member 110B can include the body portion 126 having a proximal end 123, a distal end 125, a first retainment element 144, and a second retainment element 146. In some embodiments, the first retainment element 144 is on an opposite side of the body portion 126 of the first guide member 110A from the second retainment element 146.

In some embodiments, the first guide member 110A and the second guide member 110B can be positioned with the distal end 125 of the guide member 110A facing the distal end 125 of the second guide member 110B. The first guide member 110A can receive the matrix band 140. The second guide member 110B can receive the matrix band 140. The matrix band 140 can have a portion or length 142A extending from a first side of the proximal end 123 of the first guide member 110A and around the proximal end 123 of the second guide member 110B. The matrix band 140 can have a second portion or portion 142B extending from the proximal end 123 of the second guide member 110B to a second side of the proximal end 123 of the first guide member 110A. The first guide member 110A can receive the portion 142A of the matrix band 140 between an outside surface of the body portion 126 of the first guide member 110A and the first retainment element 144 of the first guide member 110A in some embodiments. The second guide member 110B can receive the portion 142A of the matrix band 140 between an outside surface of the body portion 126 of the second guide member 110B and the second retainment element 146 of the second guide member 110B in some embodiments. The second guide member 110B can receive the portion 142B of the matrix band 140 between the outside surface of the body portion 126 of the second guide member 110B and the first retainment element 144 of the second guide member 110B in some embodiments. The first guide member 110A can receive the portion 142B of the matrix band 140 between the outside surface of the body portion 126 of the first guide member 110A and the second retainment element 146 of the guide member 110A.

In some embodiments, the first guide member 110A can be positioned on a first side of a pair of teeth. The second guide member 110B can be positioned on a second side of the pair of teeth. In some embodiments, the matrix band 140 can pass between the pair of teeth. The matrix band 140 can provide a barrier between the teeth during a dental procedure. Both the portion 142A and the portion 142B of the matrix band 140 can pass between the pair of teeth in some embodiments. The dental matrix device 100 can force the first guide member 110 to move toward the second guide member 110B when the matrix band 140 is tightened around at least a portion of the first and second guide members 110A, 110B. In some embodiments, both ends of the matrix band 140 can be attached to a matrix retainer 112. In some embodiments, the matrix retainer 112 can be positioned against the proximal end of the first guide member 110A. The matrix retainer 112 can generate a tension force in the matrix band 140 in some embodiments. The matrix retainer 112 can selectively tighten the matrix band 140 around the first and second guide members 110A, 110B. The tension force can cause the first guide member 110A to move toward the second guide member 110B. In some embodiments, the tension force can be, can be about, or can be at least about 10 lbf, 11 lbf, 12 lbf, 13 lbf, 14 lbf, 15 lbf, 16 lbf, 17 lbf, 18 lbf, 19 lbf, 20 lbf, 21 lbf, 22 lbf, 23 lbf, 24 lbf, 25 lbf, 26 lbf, 27 lbf, 28 lbf, 29 lbf, 30 lbf, or any values, approximate values, or ranges of values in any of the foregoing range. In some embodiments, applying the tension force to the guide members 110A and 110B can generate temporary orthodontic distraction between the pair of teeth.

The retainment elements 144 and 146 can advantageously force or pinch the portion 142A of the matrix band 140 against the adjacent portion 142B of the matrix band 140 in an upper portion of the matrix band 140 which can be positioned towards the top of the teeth. The shape of the distal end 125 can advantageously pinch the portion 142A of the matrix band 140 against one of the teeth and advantageously pinch the portion 142B of the matrix band 140 against the other tooth.

FIG. 3 illustrates a view of an embodiment of a dental matrix device 200 in an operable state wherein a portion of the dental matrix device 200 is between a pair of teeth. As illustrated, a pair of prepared teeth in a dental model are shown. In some embodiments of the dental matrix device 200, the dental matrix device 200 includes a pair of guide members 210A, 210B, a matrix band 240, and a matrix retainer 112 that can be used to at least tension or tighten the matrix band 240. While FIG. 3 illustrates an embodiment of guide members 210A and 210B, it should be understood that any of the embodiments of guide members described herein in FIGS. 3-14B (e.g., guide members 110, 210, 310, 410, 510, 610, 710, 810, 910, 1010, or 1110) can be installed in the dental matrix device 200 in substantially the same manner as the guide members 210A and 210B. In some embodiments, both ends of the matrix band 240 can be coupled with or held by the matrix retainer 112 so that a middle portion of the matrix band 240 extends from the instrument in looping fashion. A portion of the matrix band 240 can be positioned between a pair of teeth while the matrix band 240 extends or loops completely around a body portion 226 of one of the guide members 210B and around at least a portion of a body portion 226 of the other of the guide members 210A that is closer to the matrix retainer 112. As illustrated, the matrix band 240 is in a relaxed state. As the matrix retainer 112 is used to tighten the matrix band 240, the tightening of the matrix band 240 will cause the two guide members 210A, 210B to move toward each other between the teeth, providing the temporary orthodontic distraction needed to perform a dental filling, for example.

In some embodiments, the matrix band 240 can have a length of 150 mm, of about 150 mm, or of at least about 150 mm. In some embodiments, the matrix band can have a length of, of about, or of at least about from 50 mm or about 50 mm to 200 mm or about 200 mm, or of any value in the foregoing range. The operative value when the matrix is doubled on itself around the guide members and tensioned is 5-10 mm. In any embodiments disclosed herein, the matrix band can have any desired height or a range of heights, depending on the size of the patient's teeth and/or depending on the size of the other components of the dental matrix system.

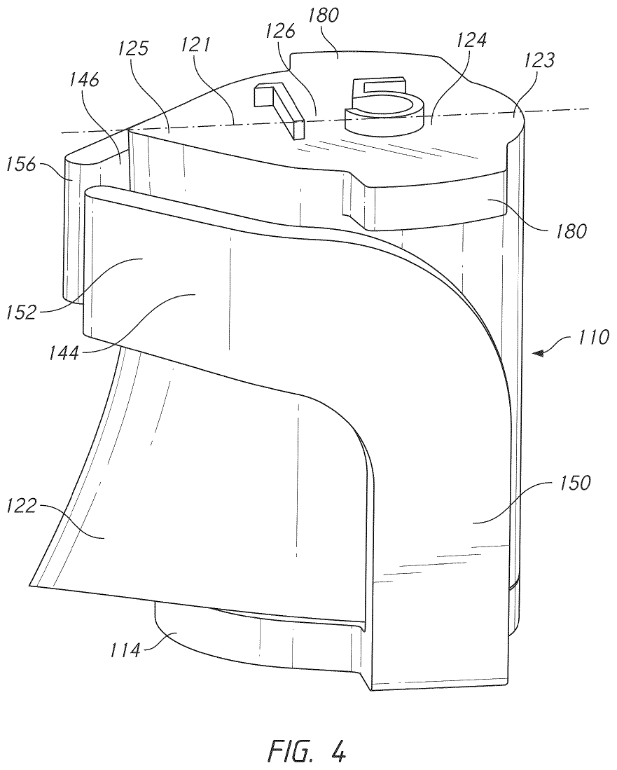

FIG. 4 illustrates the embodiment of the guide member 110 of the dental matrix device 100 that is shown in FIGS. 1 and 2. In some embodiments, the guide member 110 can include a proximal end 123, a distal end 125, a bottom 122, and a top 124. In some embodiments, the distal end 125 of the guide member 110 can be longer at the bottom 122 than the top 124. In some embodiments, the distal end 125 of the guide member 110 can be longer at a lower portion than at an upper portion. In some embodiments, the bottom 122 of the distal end 125 can be 20% or about 20% longer, or at least 20% or about at least 20% longer than the top 124 of the distal end 125, or from 15% or about 15% to 40% or about 40% longer. In some embodiments, the top 124 of the distal end 125 can be 2% or about 2% longer, or at least 2% or about at least 2% longer than the middle of the distal end 125, or from 0% or about 0% to 10% or about 10% longer. In some embodiments, the distal end 125 of the guide member 110 can be the same length at the bottom 122 and the top 124. In some embodiments, the distal end 125 can have an hourglass shape between the bottom 122 and the top 124. In some embodiments, the distal end 125 of the guide member 110 can have a concavely curved profile.

In some embodiments, the guide member 110 can include one or more retainment tabs 180 (also referred to herein as retainment lips). The retainment tabs 180 can be spaced around a portion of the perimeter of the top 124 of the body portion 126 of the guide member 110. In some embodiments, the retainment tabs 180 can be positioned towards the proximal end 123 of the guide member 110. The retainment tabs 180 can advantageously hold a matrix band in place or bias a matrix band to remain in place around the guide member 110. The retainment tabs 180 can advantageously inhibit the matrix band from sliding upward and outward from between a patient's teeth. The retainment tabs 180 can reduce an aspiration risk when installing the dental matrix device 100 in a patient's mouth.

In some embodiments, a first retainment element 144 and/or a second retainment element 146 can attach to or be integrally formed with the guide member 110. In some embodiments, the guide member 110 can be substantially symmetrical about a midline 121 illustrated in FIG. 4 and defined by the point or vertex of the distal end 125. The first retainment element 144 and the second retainment element 146 can be positioned on opposing sides of the midline 121 in some embodiments. The first retainment element 144 can be spaced a distance away from the body portion 126 of the guide member 110, thereby forming a channel between the first retainment element 144 and the body portion 126 of the guide member 110. The first retainment element 144 can be spaced apart from body portion 126 of the guide member 110 a distance of, of about, or of at least about 0.002 inches to 0.05 inches in some embodiments. The first retainment element 144 can be contoured to conform to the shape of the distal end 125 of the guide member 110. The second retainment element 146 can be spaced a distance away from the body portion 126 of the guide member, thereby forming a channel between the second retainment element 146 and the body portion 126 of the guide member 110. The second retainment element 146 can be spaced apart from the body portion 126 of the guide member 110 a distance of, of about, or of at least about 0.002 inches to 0.05 inches in some embodiments. The second retainment element 146 can be contoured to conform to the shape of the distal end 125 of the guide member 110.

The first retainment element 144 can include a portion 150 which can extend upward along the height of the guide member 110. The portion 150 can extend from the bottom 122 of the guide member 110 towards the top 124. The portion 150 can attach to the bottom 122 of the guide member 110. In some embodiments, the first portion 150 can extend across, across about, or across at least about 50% of the height of the body portion 126. In some embodiments, the first portion 150 can extend across, across about between 30% and 100% of the height of the body portion 126. The first retainment element 144 can include a second portion 152 which extends from the portion 150 towards the distal end 125. The second portion 152 can connect to the upper end of the portion 150. The second portion 152 can form an L-shape with the portion 150 in some embodiments. The second portion 152 can be at an angle from the first portion 150. In some embodiments, the second portion 152 can be at or at about a 90-degree angle, or at least a 90-degree angle from the first portion 150. In some embodiments, the second portion 152 can be or be about from a 30-degree angle to a 120-degree from the first portion 150.

The second retainment element 146 can include a portion 154 which can extend upward along the height of the guide member 110. The portion 154 can extend from the bottom 122 of the guide member 110 towards the top 124. The portion 154 can attach to the bottom 122 of the guide member 110. The second retainment element 146 can include a second portion 156 which extends from the portion 154 towards the distal end 125. The second portion 156 can connect to the upper end of the portion 154. The second portion 156 can form an L-shape with the portion 154 in some embodiments. The second portion 156 can be at an angle from the first portion 154. In some embodiments, the second portion 156 can be at or at about a 90-degree angle, or at least a 90-degree angle from the first portion 154. In some embodiments, the second portion 156 can be at or at about from a 30-degree to a 120-degree from the first portion 154. In some embodiments, the first portion 154 can extend across, across about, or across at least about 50% of the height of the body portion 126. In some embodiments, the first portion 154 can extend across, or across about between 30% and 100% of the height of the body portion 126. In some embodiments, a retainment tab 180 can be positioned above the portion 150 of the first retainment element 144. In some embodiments, a retainment tab 180 can be positioned above the portion 150 of the second retainment element 146.

In some embodiments, the first retainment element 144 and the second retainment element 146 can be integral to the guide member 110. In some embodiments, the first retainment element 144 and the second retainment element 146 can be attached to the guide member 110. In some embodiments, the first and second retainment elements 144, 146 are separate from and attached to the body portion 126 of the guide member 110. In some embodiments, the first retainment element 144 and the second retainment element 146 can attach to a base 114 which can attach to the guide member 110. The base 114 can extend into the body portion 126 of the guide member 110 to attach the retainment elements 144 and 146 to the guide member 110. In some embodiments, the base 114 can snap fit into the body portion 126.

In some embodiments, the guide member 110 can include 1, 2, 3, 4, 5, 6 or more retainment tabs 180. The retainment elements can be spaced around the perimeter of the proximal end 123 in some embodiments. In some embodiments, the guide member 110 can include a retainment tab 180 positioned centrally along the proximal end 123 and opposite the distal end 125.

In any embodiments disclosed herein, the guide member 110 can be formed from a thermoplastic such as Polyethylene (PE), Polypropylene (PP), or Polyetheretherketone (PEEK) in some embodiments. The guide member 110 can be formed from silicone or wood in some embodiments. The guide member 110 can include a rubberized overlay in some embodiments. The guide member 110 can be injection molded. The guide member 110 can have various sizes. The guide member 110 can be small to accommodate a very small tooth, for example a pediatric tooth. The guide member 110 can be slightly larger than the pediatric sized guide member to accommodate a small tooth. The guide member 110 can be slightly larger than the small sized guide member to accommodate a medium tooth. The guide member 110 can be slightly larger than the medium band to accommodate a large tooth. Advantageously, the dental matrix device 100 can be used with any size of guide member 110 described herein.

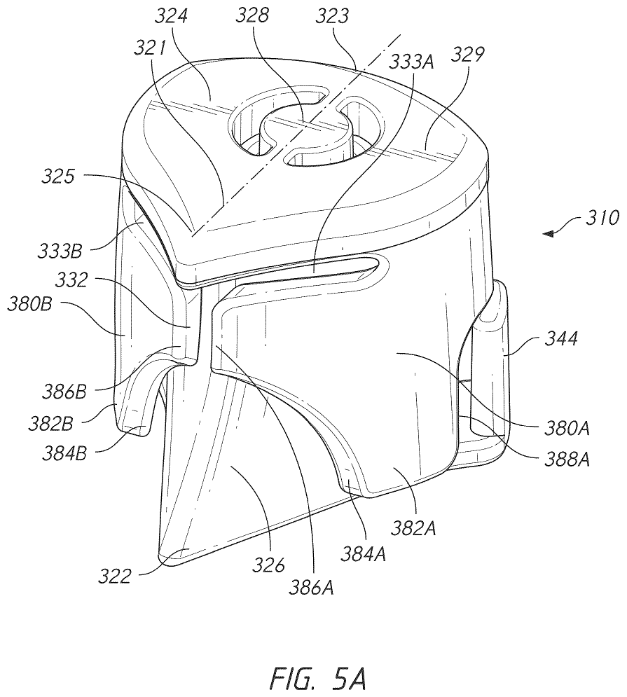

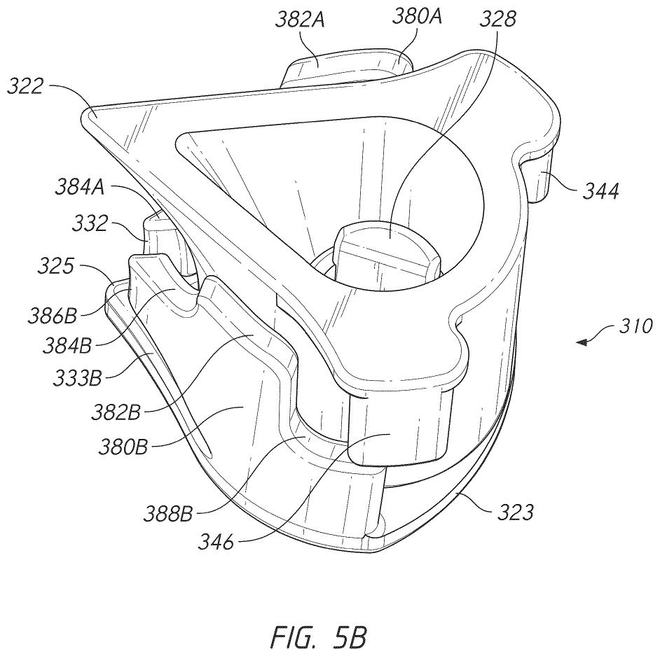

FIGS. 5A and 5B illustrate another embodiment of a guide member. In some embodiments, the guide member 310 can include a body portion 326 having a proximal end 323, a distal end 325, a bottom 322, and a top 324. In some embodiments, the distal end 325 of the body portion 326 can have a wedge shape. In some embodiments, the body portion 326 can taper to a point at the distal end 325. In some embodiments, the distal end 325 of the body portion 326 can be longer at the bottom 322 than the top 324—e.g., the lower portion of the body portion 326 can protrude or extend further in the distal direction than the upper portion of the body portion 326. In some embodiments, the distal end 325 of the body portion 326 can be longer at a lower portion than at an upper portion of the body portion. In some embodiments, the bottom 322 of the distal end 325 can be 20% or about 20% longer, or at least 20% or about at least 20% longer than the top 324 of the distal end 325, or from 15% or about 15% to 40% or about 40% longer. In some embodiments, the top 324 of the distal end 325 can be 2% or about 2% longer, or at least 2% or about at least 2% longer than the middle of the distal end 325, or from 0% or about 0% to 10% or about 10% longer. In some embodiments, the distal end 325 of the body portion 326 can be the same length at the bottom 322 and the top 324. In some embodiments, the distal end 325 can have a curved or an hourglass shape between the bottom 322 and the top 324. In some embodiments, the distal end 325 of the guide member 310 can have a concavely curved profile in a vertical direction, such as between the bottom 322 and the top 324. In some embodiments, a distal edge of the distal end 325 of the body portion 326 can have a curved profile. In some embodiments, a distal edge of the distal end 325 of the body portion 326 can be shaped and configured to fill or substantially fill the embrasure space between a user's teeth.

In some embodiments, the guide member 310 can include a cap 329 which can include a first upper retainment tab 380A (also referred to herein as a first retainment tab, a first retainment element, or a first upper retainment element) and a second upper retainment tab 380B (also referred to herein as a first retainment tab, a first retainment element, or a first upper retainment element). The first upper retainment tab 380A and the second upper retainment tab 380B can be spaced around a portion of the perimeter of the top 324 of the cap 329 of the guide member 310. In some embodiments, the features and components described herein as being included in the cap 329 can be integrally formed with the body portion 326. In some embodiments, the first upper retainment tab 380A and the second upper retainment tab 380B can be positioned so that the retainment tabs 380A and 380B are around an outside surface of the body portion 326. In some embodiments, the retainment tabs 380A and 380B can be spaced apart from the outside surface of the body portion 326. In some embodiments, the first upper retainment tab 380A and the second upper retainment tab 380B can extend towards the distal end 325 of the body portion 326. The matrix band loops around the proximal end 323 of the body portion 326 such that the matrix band positioned between the body portion 326 and the first upper retainment tab 380A and the body portion 326 and the second upper retainment tab 380B. The first upper retainment tab 380A and the second upper retainment tab 380B can advantageously guide or restrain a matrix band that is positioned between the outside surface of the body portion 326 of the guide member 310 that can receive the matrix band and an inside surface of at least the first upper retainment tab 380A and the second upper retainment tab 380B. A lower portion of the matrix band is positioned against or at least biased toward a surface of a tooth and the upper portion of the matrix band is pinched together or at least drawn together by the first upper retainment tab 380A and the second upper retainment tab 380B. The first upper retainment tab 380A can be spaced a distance away from the body portion 326 of the guide member 310, thereby forming a channel between the first upper retainment tab 380A and the body portion 326 of the guide member 310 that can receive the matrix band. The first upper retainment tab 380A can be spaced apart from body portion 326 of the guide member 310 a distance of, of about, or of at least about 0.002 inches to 0.05 inches in some embodiments. The first upper retainment tab 380A can be contoured to conform to the shape of the distal end 325 of the body portion 326. The second upper retainment tab 380B can be spaced a distance away from the body portion 326 of the guide member 310, thereby forming a channel between the second upper retainment tab 380B and the body portion 326. The second upper retainment tab 380B can be spaced apart from the body portion 326 of the guide member 310 a distance of, of about, or of at least about 0.002 inches to 0.05 inches in some embodiments. The second upper retainment tab 380B can be contoured to conform to the shape of the distal end 325 of the body portion 326.

The first upper retainment tab 380A and the second upper retainment tab 380B can advantageously hold a matrix band in place or bias a matrix band to remain in place around the guide member 310. The first upper retainment tab 380A and the second upper retainment tab 380B can, in some embodiments, advantageously inhibit the matrix band from sliding upward and outward from between a patient's teeth. The first upper retainment tab 380A and the second upper retainment tab 380B can, in some embodiments, reduce an aspiration risk when installing a dental matrix device including the guide member 310 in a patient's mouth.

The first upper retainment tab 380A can attach to or be integrally formed with the top of the cap 329 and can include a first portion 382A which can extend downward along the height of the guide member 310. The first portion 382A can extend from the top 324 of the guide member 310 towards the bottom 322. In some embodiments, the first portion 382A can extend across, across about, or across at least about 90% of the height of the body portion 326. In some embodiments, the first portion 382A can extend across, or across about 30% to 100% of the height of the body portion 326. The first upper retainment tab 380A can include a second portion 386A which extends from the first portion 382A towards the distal end 325. The second portion 386A can connect to or be integrally formed with the first portion 382A near the middle of the first portion 382A. The second portion 386A can be at an angle from the first portion 382A. In some embodiments, the second portion 386A can be at or at about a 90-degree angle, or at least a 90-degree angle from the first portion 382A. In some embodiments, the second portion 386A can be or be about from a 30-degree angle to a 120-degree from the first portion 382A. The first upper retainment tab 380A can include a cutout 384A positioned between the first portion 382A and the second portion 386A. The cutout 384A can provide space between the bottom 322 of the distal end 325 and the second portion 386A. In some embodiments, the distal end 325 can extend outward through the cutout 384A. In some embodiments, the first upper retainment tab 380A can include a cutout 388A positioned above a first lower retainment element 344 so that the cap 329 can fit around the first lower retainment element 344. The cutout 388A can provide space between the first lower retainment element 344 and the first upper retainment tab 380A.

In some embodiments, the second upper retainment tab 380B can be a mirror image of the first upper retainment tab 380A. The first upper retainment tab 380A can be positioned on a first side of a midline 321 and the second upper retainment tab 380B can be positioned on a second side of the midline 321. The midline 321 is illustrated in FIG. 5A and defined by the point or vertex of the distal end 325. The second upper retainment tab 380B can attach to the top 324 of the cap 329 and can include a first portion 382B which can extend downward along the height of the guide member 310. In some embodiments, the first portion 382B can extend across, across about, or across at least about 90% of the height of the body portion 326. In some embodiments, the first portion 382B can extend across, or across about 30% to 100% of the height of the body portion 326. The second upper retainment tab 380B can include a second portion 386B which extends from the first portion 382B towards the distal end 325. The second portion 386B can connect to or be integrally formed with the first portion 382B near the middle of the first portion 382B. The second portion 386B can be at an angle from the first portion 382B. In some embodiments, the second portion 386B can be at or at about a 90-degree angle, or at least a 90-degree angle from the first portion 382B. In some embodiments, the second portion 386B can be or be about from a 30-degree angle to a 120-degree from the first portion 382B. The second upper retainment tab 380B can include a cutout 384B positioned between the first portion 382B and the second portion 386B. The cutout 384B can provide space between the bottom 322 of the distal end 325 and the second portion 386B. In some embodiments, the distal end 325 can extend outward through the cutout 384B. In some embodiments, the second upper retainment tab 380B can include a cutout 388B positioned above a second lower retainment element 346 so that the cap 329 can fit around the second lower retainment element 346. The cutout 388B can provide space between the second lower retainment element 346 and the second upper retainment tab 380B.

In some embodiments, a gap 332 can be positioned between the first and second upper retainment tabs 380A, 380B. In some embodiments, the gap 332 can be positioned between the second portion 386A of the first upper retainment tab 380A and the second portion 386B of the second upper retainment tab 380B. In some embodiments, a matrix band can pass through the gap 332. In some embodiments, a matrix band can pass through the gap 332, around the body portion 326 of the guide member 310, and then back through the gap 332. In some embodiments, when the matrix band is positioned around a pair of guide members 310 and between a pair of teeth, the tension on the matrix band can cause the first upper retainment tab 380A and the second upper retainment tab 380B to flex outward, thereby increasing the width of the gap 332. In some embodiments, a relief slot 333A can extend from the gap 332 towards the proximal end 323. The relief slot 333A can be positioned above the second portion 386A. In some embodiments, a relief slot 333B can extend from the gap 332 towards the proximal end 323. The relief slot 333B can be positioned above the second portion 386B. The relief slots 333A and 333B can advantageously increase the flexibility of the first upper retainment tab 380A and the second upper retainment tab 380B (for example and without limitation, the second portion 386A of the first upper retainment tab 380A and the second portion 386B of the second upper retainment tab 380B) so that the first upper retainment tab 380A and the second upper retainment tab 380B and/or the second portion 386A of the first upper retainment tab 380A and the second portion 386B of the second upper retainment tab 380B, can flex together when driven into the surfaces of the teeth allowing approximation of the paralleling matrix bands in the operable state.

In some embodiments, the first upper retainment tab 380A and the second upper retainment tab 380B can be integral to the cap 329 which can be attached to the body portion 326. In some embodiments, the first upper retainment tab 380A and the second upper retainment tab 380B can be integral to the body portion 326. In some embodiments, the first upper retainment tab 380A and the second upper retainment tab 380B can be attached to the body portion 326. In some embodiments, the first upper retainment tab 380A and the second upper retainment tab 380B are separate from and attached to the body portion 326 of the guide member 310. As illustrated in FIG. 5B, the cap 329 can attach to or couple to the body portion 326 or be integrally formed with the body portion 326. In some embodiments, the body portion 326 can be hollow. In some embodiments, the cap 329 can snap fit to the body portion 326 through the top 324 of the body portion 326. In some embodiments, the cap 329 can include two flexible prongs 328 which can snap fit into an opening in the body portion 326.

In some embodiments, a matrix band can be received between the first upper retainment tab 380A of the guide member 310 and an outside surface of the body portion 326 of the guide member 310 such that at least a portion of the matrix band is positioned between the first upper retainment tab 380A of the guide member 310 and the body portion 326 of the guide member 310 in the operable state. In some embodiments, a matrix band can be received between the second upper retainment tab 380B of the guide member 310 and an outside surface of the body portion 326 of the guide member 310 such that at least a portion of the matrix band is positioned between the second upper retainment tab 380B of the guide member 310 and the body portion 326 of the guide member 310 in the operable state. In some embodiments, at least a portion of a matrix band can extend through the gap 332 in an operable state.

In some embodiments, a first lower retainment element 344 and/or a second lower retainment element 346 can attach to or be integrally formed with the body portion 326. In some embodiments, the body portion 326 can be formed without the first lower retainment element 344 and a second lower retainment element 346. In some embodiments, the guide member 310 can be substantially symmetrical across the midline 321. The first lower retainment element 344 and the second lower retainment element 346 can be positioned on opposing sides of the midline 321 in some embodiments. The first upper retainment tab 380A and second upper retainment tab 380B can be positioned on opposing sides of the midline 321 in some embodiments.

In any embodiments disclosed herein, the guide member 310 and/or any other components disclosed herein can be formed from a thermoplastic such as Polyethylene (PE), Polypropylene (PP), or Polyetheretherketone (PEEK), ABS, Nylons, Acetal Copolymer, and Composites (e.g. glass or carbon filled) in some embodiments. The guide member 310 can be formed from silicone or wood in some embodiments. The guide member 310 can include a rubberized overlay in some embodiments. The guide member 310 can be injection molded. The guide member 310 can have or be provided in various sizes. Some embodiments of the guide member 310 can be small to accommodate a very small tooth, for example a pediatric tooth. Some embodiments of the guide member 310 can be slightly larger than the pediatric sized guide member to accommodate a small tooth. Some embodiments of the guide member 310 can be slightly larger than the small sized guide member to accommodate a medium tooth. The guide member 310 can be slightly larger than the medium band to accommodate a large tooth.

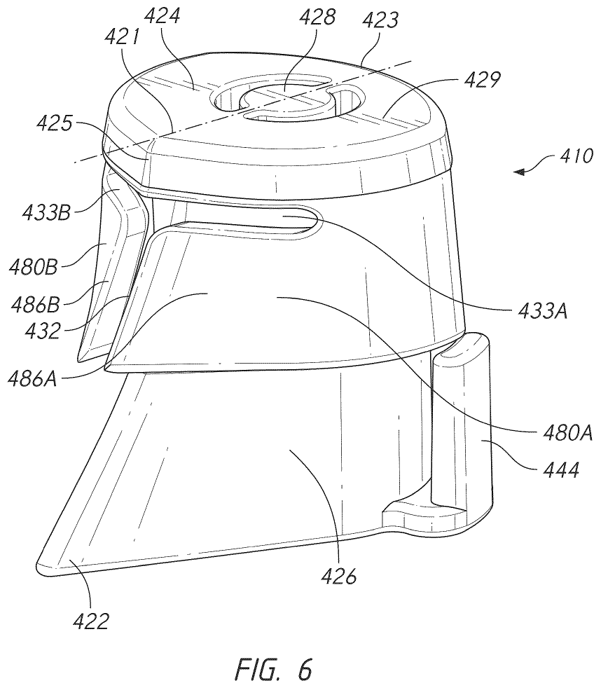

FIG. 6 illustrates another embodiment of a guide member 410. In some embodiments, the guide member 410 can include a body portion 426 having a proximal end 423, a distal end 425, a bottom 422, and a top 424. In some embodiments, the distal end 425 of the body portion 426 can have a wedge shape. In some embodiment, the body portion 426 can taper to a point at the distal end 425. In some embodiments, the distal end 425 of the body portion 426 can be longer at the bottom 422 than the top 424—e.g., the lower portion of the body portion 426 can protrude or extend further in the distal direction than the upper portion of the body portion 426. In some embodiments, the distal end 425 of the body portion 426 can be longer at a lower portion than at an upper portion. In some embodiments, the bottom 422 of the distal end 425 can be 20% or about 20% longer, or at least 20% or about at least 20% longer than the top 424 of the distal end 425, or from 15% or about 15% to 40% or about 40% longer. In some embodiments, the top 424 of the distal end 425 can be 2% or about 2% longer, or at least 2% or about at least 2% longer than the middle of the distal end 425, or from 0% or about 0% to 10% or about 10% longer. In some embodiments, the distal end 425 of the body portion 426 can be the same length at the bottom 422 and the top 424. In some embodiments, the distal end 425 can have a curved or an hourglass shape between the bottom 422 and the top 424. In some embodiments, the distal end 425 of the body portion 426 can have a concavely curved profile in a vertical direction, such as between the bottom 422 and the top 424.

In some embodiments, the guide member 410 can include a cap 429 which can include a first upper retainment tab 480A (also referred to herein as a first retainment tab, a first retainment element, or a first upper retainment element) and a second upper retainment tab 480B (also referred to herein as a first retainment tab, a first retainment element, or a first upper retainment element). In some embodiments, the features and components described herein as being included in the cap 429 can be integrally formed with the body portion 426. The first upper retainment tab 480A and the second upper retainment tab 480B can be spaced around a portion of the perimeter of the top 424 of the cap 429 of the guide member 410. In some embodiments, the first upper retainment tab 480A and the second upper retainment tab 480B can be positioned so that the upper retainment tabs 480A and 480B are around an outside surface of the body portion 426 and spaced apart from the outside surface of the body portion 426. In some embodiments, the first upper retainment tab 480A and the second upper retainment tab 480B can extend towards the distal end 425 of the body portion 426. The first upper retainment tab 480A and the second upper retainment tab 480B can advantageously guide or restrain a matrix band that is positioned between the outside surface of the body portion 426 of the guide member 410 and an inside surface of at least the first upper retainment tab 480A and the second upper retainment tab 480B so that a lower portion of the matrix band is positioned against a surface of a tooth and the upper portion of the matrix band is pinched together or at least drawn together by the first upper retainment tab 480A and the second upper retainment tab 480B. The first upper retainment tab 480A can be spaced a distance away from the body portion 426 of the guide member 410, thereby forming a channel between the first upper retainment tab 480A and the body portion 426 of the guide member 410. The first upper retainment tab 480A can be spaced apart from body portion 426 of the guide member 410 a distance of, of about, or of at least about 0.002 inches to 0.05 inches in some embodiments. The first upper retainment tab 480A can be contoured to conform to the shape of the distal end 425 of the guide member 410. The second upper retainment tab 480B can be spaced a distance away from the body portion 426 of the guide member 410, thereby forming a channel between the second upper retainment tab 480B and the body portion 426 of the guide member 410. The second upper retainment tab 480B can be spaced apart from the body portion 426 of the guide member 410 a distance of, of about, or of at least about 0.002 inches to 0.05 inches in some embodiments. The second upper retainment tab 480B can be contoured to conform to the shape of the distal end 425 of the body portion 426.

The first upper retainment tab 480A and the second upper retainment tab 480B can advantageously hold a matrix band in place or bias a matrix band to remain in place around the guide member 410. The first upper retainment tab 480A and the second upper retainment tab 480B can advantageously inhibit the matrix band from sliding upward and outward from between a patient's teeth. The first upper retainment tab 480A and the second upper retainment tab 480B can, in some embodiments, reduce an aspiration risk when installing the dental matrix device including the guide member 410 in a patient's mouth.

The first upper retainment tab 480A can attach to or be integrally formed with the top of the cap 429 and can include a portion 486A which extends towards the distal end 425. In some embodiments, the portion 486A can be horizonal (e.g., parallel to the top and/or bottom of the guide member 410) or substantially horizontal. In some embodiments, the portion 486A can be or be about from a −60-degree angle to a 60-degree from horizontal. The first upper retainment tab 480A can extend across, across about, or across at least about 50% of the height of the body portion 426. In some embodiments, the first upper retainment tab 480A can extend across, or across about 20% to 100% of the height of the body portion 426.

The second upper retainment tab 480B can be a mirror image of the first upper retainment tab 480A. The second upper retainment tab 480B can attach to or be integrally formed with the top of the cap 429 and can include a portion 486B which extends towards the distal end 425. The first upper retainment tab 480A can be positioned on a first side of a midline 421 and the second upper retainment tab 480B can be positioned on a second side of the midline 421. The midline 421 is defined by the point of the distal end 425. In some embodiments, the portion 486B can be horizonal (e.g., parallel to the top and/or bottom of the guide member 410) or substantially horizontal. In some embodiments, the portion 486B can be or be about from a −60-degree angle to a 60-degree from horizontal. The second upper retainment tab 480B can extend across, across about, or across at least about 50% of the height of the body portion 426. In some embodiments, the second upper retainment tab 480B can extend across, across about 20% to 100% of the height of the body portion 426.

In some embodiments, a gap 432 can be positioned between the first and second upper retainment tabs 480A and 480B. In some embodiments, the gap 432 can be positioned between the portion 486A of the first upper retainment tab 480A and the portion 486B of the second upper retainment tab 480B. In some embodiments, a matrix band can pass through the gap 432. Some embodiments are configured such that, when the matrix band is positioned around a pair of guide members 410 and between a pair of teeth, as the tension on the matrix band is increased and the pair of guide members are drawn toward the teeth, engagement of the first upper retainment tab 480A and the second upper retainment tab 480B with the teeth can cause the first upper retainment tab 480A and the second upper retainment tab 480B to be forced inwardly and thereby flex inwardly, decreasing the width of the gap 432 therebetween. In some embodiments, a relief slot 433A can extend from the gap 432 and extend towards the proximal end 423. The relief slot 433A can be positioned above the portion 486A. In some embodiments, a relief slot 433B can extend from the gap 432 towards the proximal end 423. The relief slot 433B can be positioned above the portion 486B. The relief slots 433A and 433B can advantageously increase the flexibility of the first upper retainment tab 480A and the second upper retainment tab 480B so that the first upper retainment tab 480A and the second upper retainment tab 480B can flex inward to place pressure on the paralleling matrix band, holding the top portion of the matrix band together while the body portion 426 presses the lower portion of the matrix band outward and into the tooth while in operable state.

In some embodiments, the cap 429 can include one upper retainment tab that extends around all, substantially all, or the majority of the perimeter of the body portion 426. In some embodiments, the gap 432 is positioned between the ends of the one upper retainment tab.

In some embodiments, the first upper retainment tab 480A and the second upper retainment tab 480B can be integral to the cap 429 which can be attached to the body portion 426. In some embodiments, the first upper retainment tab 480A and the second upper retainment tab 480B can be integral to the body portion 426. In some embodiments, the first upper retainment tab 480A and the second upper retainment tab 480B can be attached to body portion 426 of the guide member 410. In some embodiments, the first upper retainment tab 480A and the second upper retainment tab 480B are separate from and attached to the body portion 426 of the guide member 410. The cap 429 can attach to the body portion 426. In some embodiments, the body portion 426 can be hollow. In some embodiments, the cap 429 can snap fit to the body portion 426 through the top 424 of the body portion 426. In some embodiments, the cap 429 can include two flexible prongs 428 which can snap fit into an opening in the body portion 426.

In some embodiments, a matrix band can be received between the first upper retainment tab 480A of the guide member 410 and an outside surface of the body portion 426 of the guide member 410 such that at least a portion of the matrix band is positioned between the first upper retainment tab 480A of the guide member 410 and the body portion 426 of the guide member 410 in the operable state. In some embodiments, a matrix band can be received between the second upper retainment tab 480B of the guide member 410 and an outside surface of the body portion 426 of the guide member 410 such that at least a portion of the matrix band is positioned between the second upper retainment tab 480B of the guide member 410 and the body portion 426 of the guide member 410 in the operable state. In some embodiments, at least a portion of a matrix band can extend through the gap 432 in an operable state.

In some embodiments, a first lower retainment element 444 and/or a second lower retainment element 446 can attach to or be integrally formed with the body portion 426. In some embodiments, the guide member 410 can be substantially symmetrical across the midline 421. The first lower retainment element 444 and the second lower retainment element 446 can be positioned on opposing sides of the midline 421 in some embodiments. The first upper retainment tab 480A and second upper retainment tab 480B can be positioned on opposing sides of the midline 421 in some embodiments.

In any embodiments disclosed herein, the guide member 410 can be formed from a thermoplastic such as Polyethylene (PE), Polypropylene (PP), or Polyetheretherketone (PEEK), ABS, Nylons, Acetal Copolymer, and composites (e.g. glass or carbon filled) in some embodiments. The guide member 410 can be formed from silicone or wood in some embodiments. The guide member 410 can include a rubberized overlay in some embodiments. The guide member 410 can be injection molded. The guide member 410 can have various sizes. The guide member 410 can be small to accommodate a very small tooth, for example a pediatric tooth. The guide member 410 can be slightly larger than the pediatric sized guide member to accommodate a small tooth. The guide member 410 can be slightly larger than the small sized guide member to accommodate a medium tooth. The guide member 410 can be slightly larger than the medium band to accommodate a large tooth.

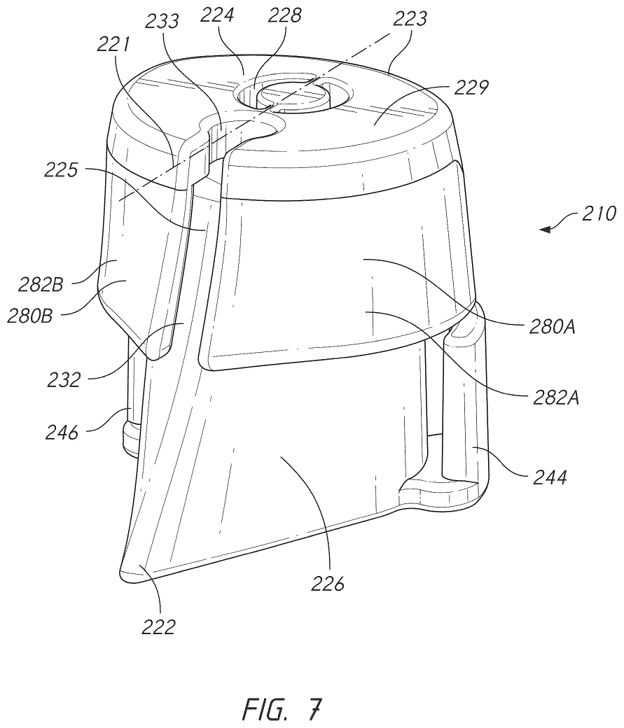

FIG. 7 illustrates another embodiment of a guide member 210. In some embodiments, the guide member 210 can include a body portion 226 having a proximal end 223, a distal end 225, bottom 222, and a top 224. In some embodiments, the distal end 225 of the body portion 226 can have a wedge shape. In some embodiments, the body portion 226 can taper to a point at the distal end 225. In some embodiments, the distal end 225 of the body portion 226 can be longer at the bottom 222 than the top 224—e.g., the lower portion of the body portion 226 can protrude or extend further in the distal direction than the upper portion of the body portion 226. In some embodiments, the distal end 225 of the body portion 226 can be longer at a lower portion than at an upper portion. In some embodiments, the bottom 222 of the distal end 225 can be 20% or about 20% longer, or at least 20% or about at least 20% longer than the top 224 of the distal end 225, or from 15% or about 15% to 40% or about 40% longer. In some embodiments, the top 224 of the distal end 225 can be 2% or about 2% longer, or at least 2% or about at least 2% longer than the middle of the distal end 225, or from 0% or about 0% to 10% or about 10% longer. In some embodiments, the distal end 225 of the body portion 226 can be the same length at the bottom 222 and the top 224. In some embodiments, the distal end 225 can have an hourglass shape between the bottom 222 and the top 224. In some embodiments, the distal end 225 of the body portion 226 can have a concavely curved profile in a vertical direction, such as between the bottom 222 and the top 224.

In some embodiments, the guide member 210 can include a cap 229 which can include a first upper retainment tab 280A and a second upper retainment tab 280B. The first upper retainment tab 280A and the second upper retainment tab 280B can be spaced around a portion of the perimeter of the top 224 of the cap 229 of the guide member 210. In some embodiments, the features and components described herein as being included in the cap 229 can be integrally formed with the body portion 226. In some embodiments, the first upper retainment tab 280A and the second upper retainment tab 280B can be positioned so that the retainment tabs 280A and 280B are around an outside surface of the body portion 226 and spaced apart from the outside surface of the body portion 226. In some embodiments, the first upper retainment tab 280A and the second upper retainment tab 280B can extend towards the distal end 225 of the body portion 226. The first upper retainment tab 280A and the second upper retainment tab 280B can advantageously guide or restrain a matrix band that is positioned between the outside surface of the body portion 226 of the guide member 210 and an inside surface of at least the first upper retainment tab 280A and the second upper retainment tab 280B so that a lower portion of the matrix band is positioned against a surface of a tooth and the upper portion of the matrix band is pinched together or at least drawn together by the first upper retainment tab 280A and the second upper retainment tab 280B. The first upper retainment tab 280A can be spaced a distance away from the body portion 226 of the guide member 210, thereby forming a channel between the first upper retainment tab 280A and the body portion 226 of the guide member 210. The first upper retainment tab 280A can be spaced apart from body portion 226 of the guide member 210 a distance of, of about, or of at least about 0.002 inches to 0.05 inches in some embodiments. The first upper retainment tab 280A can be contoured to conform to the shape of the distal end 225 of the body portion 226. The second upper retainment tab 280B can be spaced a distance away from the body portion 226 of the guide member 210, thereby forming a channel between the second upper retainment tab 280B and the body portion 226. The second upper retainment tab 280B can be spaced apart from the body portion 226 of the guide member 210 a distance of, of about, or of at least about 0.002 inches to 0.05 inches in some embodiments. The second upper retainment tab 280B can be contoured to conform to the shape of the distal end 225 of the body portion 226.

The first upper retainment tab 280A and the second upper retainment tab 280B can advantageously hold a matrix band in place or bias a matrix band to remain in place around the guide member 210. The first upper retainment tab 280A and the second upper retainment tab 280B can, in some embodiments, advantageously inhibit the matrix band from sliding upward and outward from between a patient's teeth. The first upper retainment tab 280A and the second upper retainment tab 280B can reduce an aspiration risk when installing the dental matrix device 200 in a patient's mouth.

The first upper retainment tab 280A can attach to the top of the cap 229 and can include a portion 282A which can extend downward along the height of the guide member 210. The portion 282A can extend from the top 224 of the guide member 210 towards the bottom 222. In some embodiments, the portion 282A can extend across, across about, or across at least about 50% of the height of the body portion 226. In some embodiments, the portion 282A can extend across, or across about 20% to 100% of the height of the body portion 226.

The second upper retainment tab 280B can be a mirror image of the first upper retainment tab 280A. The first upper retainment tab 280A can be positioned on a first side of a midline 221 and the second upper retainment tab 280B can be positioned on a second side of the midline 221. The midline 221 is illustrated in FIG. 7 and defined by the point of the distal end 225. The second upper retainment tab 280B can attach to the top of the cap 229 and can include a portion 282B which can extend downward along the height of the guide member 210. The portion 282B can extend from the top 224 of the guide member 210 towards the bottom 222. In some embodiments, the portion 282B can extend across, across about, or across at least about 50% of the height of the body portion 226. In some embodiments, the portion 282B can extend across, or across about 20% to 100% of the height of the body portion 226.

In some embodiments, a gap 232 can be positioned between the first and second upper retainment tabs 280A and 280B. In some embodiments, the gap 232 can be positioned between the portion 282A of the first upper retainment tab 280A and the portion 282B of the second upper retainment tab 280B. In some embodiments, a matrix band can pass through the gap 232. Some embodiments are configured such that, when the matrix band is positioned around a pair of guide members 210 and between a pair of teeth, as the tension on the matrix band is increased and the pair of guide members are drawn toward the teeth, engagement of the first upper retainment tab 280A and the second upper retainment tab with the teeth can cause the first upper retainment tab 280A and the second upper retainment tab 280B to be forced inwardly and thereby flex inwardly, decreasing the width of the gap 232 therebetween. In some embodiments, a relief slot 233 can extend through the top of the cap 229 and connect to the gap 232. The relief slot 233 can advantageously increase the flexibility of the first upper retainment tab 280A and the second upper retainment tab 280B so that the first upper retainment tab 280A and the second upper retainment tab 280B can flex inward in an operable state to place pressure on the paralleling matrix band, holding the top portion of the matrix band together while the body portion 226 presses the lower portion of the matrix band outward and into the tooth. In some embodiments, the upper portion of the matrix band is pinched together or at least drawn together by the first upper retainment tab 280A and the second upper retainment tab 280B contacting the teeth.

In some embodiments, the first upper retainment tab 280A and the second upper retainment tab 280B can attach to or be integral to the cap 229 which can be attached to the body portion 226. In some embodiments, the first upper retainment tab 280A and the second upper retainment tab 280B can be integral to the body portion 226. In some embodiments, the first upper retainment tab 280A and the second upper retainment tab 280B can be attached to the body portion 226. In some embodiments, the first upper retainment tab 280A and the second upper retainment tab 280B are separate from and attached to the body portion 226 of the guide member 210. The cap 229 can attach to the body portion 226. In some embodiments, the body portion 226 can be hollow. In some embodiments, the cap 229 can snap fit to the body portion 226 through the top 284 of the body portion 226. In some embodiments, the cap 229 can include two flexible prongs 228 which can snap fit into an opening in the body portion 226. The two flexible prongs 228 can extend from a top surface of the cap 229 toward the bottom of the guide member 210.

In some embodiments, a matrix band can be received between the first upper retainment tab 280A of the guide member 210 and an outside surface of the body portion 226 of the guide member 210 such that at least a portion of the matrix band is positioned between the first upper retainment tab 280A of the guide member 210 and the body portion 226 of the guide member 210 in the operable state. In some embodiments, a matrix band can be received between the second upper retainment tab 280B of the guide member 210 and an outside surface of the body portion 226 of the guide member 210 such that at least a portion of the matrix band is positioned between the second upper retainment tab 280B of the guide member 210 and the body portion 226 of the guide member 210 in the operable state. In some embodiments, at least a portion of a matrix band can extend through the gap 232 in an operable state.

In some embodiments, a first retainment element 244 and/or a second retainment element 246 can attach to or be integrally formed with the body portion 226. In some embodiments, the guide member 210 can be substantially symmetrical across the midline 221. The first retainment element 244 and the second retainment element 246 can be positioned on opposing sides of the midline 221 in some embodiments. The first upper retainment tab 280A and second upper retainment tab 280B can be positioned on opposing sides of the midline 221 in some embodiments.

In any embodiments disclosed herein, the guide member 210 can be formed from a thermoplastic such as Polyethylene (PE), Polypropylene (PP), or Polyetheretherketone (PEEK), ABS, Nylons, Acetal Copolymer, and composites (e.g. glass or carbon filled) in some embodiments. The guide member 210 can be formed from silicone or wood in some embodiments. The guide member 210 can include a rubberized overlay in some embodiments. The guide member 210 can be injection molded. The guide member 210 can have various sizes. The guide member 210 can be small to accommodate a very small tooth, for example a pediatric tooth. The guide member 210 can be slightly larger than the pediatric sized guide member to accommodate a small tooth. The guide member 210 can be slightly larger than the small sized guide member to accommodate a medium tooth. The guide member 210 can be slightly larger than the medium band to accommodate a large tooth.

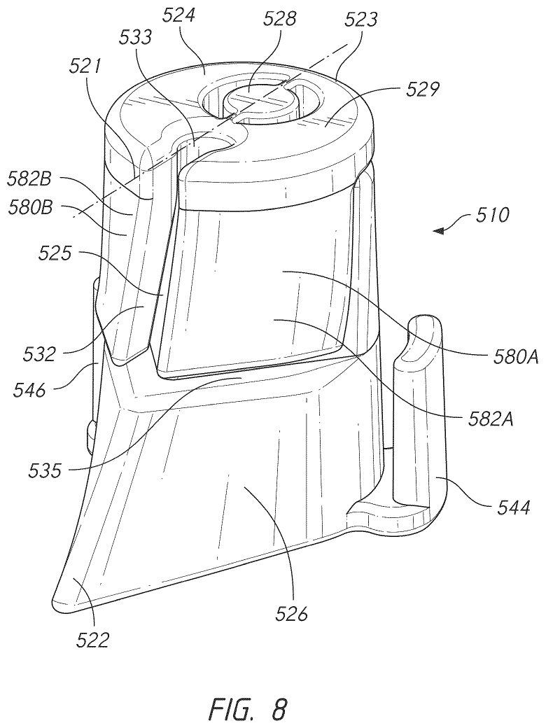

FIG. 8 illustrates another embodiment of a guide member 510. In some embodiments, the guide member 510 can include a body portion 526 and can have a proximal end 523, a distal end 525, bottom 522, and a top 524. In some embodiments, the distal end 525 of the body portion 526 can have a wedge shape. In some embodiments, the body portion 526 can taper to a point at the distal end 525. In some embodiments, the distal end 525 of the body portion 526 can be longer at the bottom 522 than the top 524—e.g., the lower portion of the body portion 526 can protrude or extend further in the distal direction than the upper portion of the body portion 526. In some embodiments, the distal end 525 of the body portion 526 can be longer at a lower portion than at an upper portion. In some embodiment, the distal end 525 can include a step 535 such that the distal end 525 extends further outward below the step 535 and cuts inward above the step 535. In some embodiments, the step 535 can be positioned at or about at 50% of the height of the body portion 526. In some embodiments, the step 535 can be positioned at or at about 20% to 80% of the height of the body portion 526. In some embodiments, the bottom 522 of the distal end 525 can be 20% or about 20% longer, or at least 20% or about at least 20% longer than the top 524 of the distal end 525, or from 15% or about 15% to 40% or about 40% longer. In some embodiments, the top 524 of the distal end 525 can be 2% or about 2% longer, or at least 2% or about at least 2% longer than the middle of the distal end 525, or from 0% or about 0% to 10% or about 10% longer. In some embodiments, the distal end 525 of the body portion 526 can be the same length at the bottom 522 and the top 524. In some embodiments, the distal end 525 can have an hourglass shape between the bottom 522 and the top 524. In some embodiments, the distal end 525 of the body portion 526 can have a concavely curved profile in a vertical direction, such as between the bottom 522 and the top 524.

In some embodiments, the guide member 510 can include a cap 529 which can include a first upper retainment tab 580A (also referred to herein as a first retainment tab, a first retainment element, or a first upper retainment element) and a second upper retainment tab 580B (also referred to herein as a first retainment tab, a first retainment element, or a first upper retainment element). In some embodiments, the features and components described herein as being included in the cap 529 can be integrally formed with the body portion 526. The first upper retainment tab 580A and the second upper retainment tab 580B can be spaced around a portion of the perimeter of the top of the cap 529 of the guide member 510. In some embodiments, the first upper retainment tab 580A and the second upper retainment tab 580B can be positioned so that the retainment tabs 580A and 580B are around an outside surface of the body portion 526 and spaced apart from the outside surface of the body portion 526. In some embodiments, the first upper retainment tab 580A and the second upper retainment tab 580B can extend towards the distal end 525 of the body portion 526. The first upper retainment tab 580A and the second upper retainment tab 580B can advantageously guide or restrain a matrix band that is positioned between the outside surface of the body portion 526 of the guide member 510 and an inside surface of at least the first upper retainment tab 580A and the second upper retainment tab 580B so that a lower portion of the matrix band is positioned against a surface of a tooth and the upper portion of the matrix band is pinched together or at least drawn together by the first upper retainment tab 580A and the second upper retainment tab 580B. The first upper retainment tab 580A can be spaced a distance away from the body portion 526 of the guide member 510, thereby forming a channel between the first upper retainment tab 580A and the body portion 526 of the guide member 510. The first upper retainment tab 580A can be spaced apart from body portion 526 of the guide member 510 a distance of, of about, or of at least about 0.002 inches to 0.05 inches in some embodiments. The first upper retainment tab 580A can be contoured to conform to the shape of the distal end 525 of the body portion 526. The second upper retainment tab 580B can be spaced a distance away from the body portion 526 of the guide member 510, thereby forming a channel between the second upper retainment tab 580B and the body portion 526. The second upper retainment tab 580B can be spaced apart from the body portion 526 of the guide member 510 a distance of, of about, or of at least about 0.002 inches to 0.05 inches in some embodiments. The second upper retainment tab 580B can be contoured to conform to the shape of the distal end 525 of the body portion 526.

The first upper retainment tab 580A and the second upper retainment tab 580B can advantageously hold a matrix band in place or bias a matrix band to remain in place around the guide member 510. The first upper retainment tab 580A and the second upper retainment tab 580B can, in some embodiments, advantageously inhibit the matrix band from sliding upward and outward from between a patient's teeth. The first upper retainment tab 580A and the second upper retainment tab 580B can reduce an aspiration risk when installing a dental matrix device including the guide member 510 in a patient's mouth.

The first upper retainment tab 580A can attach to or be integrally formed with the top of the cap 529 and can include a portion 582A which can extend downward along the height of the guide member 510. The portion 582A can extend from the top 524 of the guide member 510 towards the bottom 522. In some embodiments, the portion 582A can extend across, across about, or across at least about 50% of the height of the body portion 526. In some embodiments, the portion 582A can extend across, or across about 20% to 100% of the height of the body portion 526.

The second upper retainment tab 580B can be a mirror image of the first upper retainment tab 580A. The first upper retainment tab 580A can be positioned on a first side of a midline 521 and the second upper retainment tab 580B can be positioned on a second side of the midline 521. The midline 521 is defined by the point of the distal end 525. The second upper retainment tab 580B can attach to or be integrally formed with the top of the cap 529 and can include a portion 582B which can extend downward along the height of the guide member 510. The portion 582B can extend from the top 524 of the guide member 510 towards the bottom 522. In some embodiments, the portion 582B can extend across, across about, or across at least about 50% of the height of the body portion 526. In some embodiments, the portion 582B can extend across, across about 20% to 100% of the height of the body portion 526.

In some embodiments, a gap 532 can be positioned between the first and second upper retainment tabs 580A and 580B. In some embodiments, the gap 532 can be positioned between the portion 582A of the first upper retainment tab 580A and the portion 582B of the second upper retainment tab 580B. In some embodiments, a matrix band can pass through the gap 532. Some embodiments are configured such that, when the matrix band is positioned around a pair of guide members 510 and between a pair of teeth, as the tension on the matrix band is increased and the pair of guide members are drawn toward the teeth, engagement of the first upper retainment tab 580A and the second upper retainment tab 580B with the teeth can cause the first upper retainment tab 580A and the second upper retainment tab 580B to be forced inwardly and thereby flex inwardly, decreasing the width of the gap 532 therebetween. In some embodiments, a relief slot 533 can extend through the top 524 of the cap 529 and connect to the gap 532. The relief slot 533 can advantageously increase the flexibility of the first upper retainment tab 580A and the second upper retainment tab 580B so that the first upper retainment tab 580A and the second upper retainment tab 580B can flex inward in an operable state to place pressure on the paralleling matrix band, holding the top portion of the matrix band together while the body portion 226 presses the lower portion of the matrix band outward and into the tooth. In some embodiments, the upper portion of the matrix band is pinched together or at least drawn together by the first upper retainment tab 580A and the second upper retainment tab 580B contacting the teeth.

In some embodiments, the first upper retainment tab 580A and the second upper retainment tab 580B can be integral to the cap 529 which can be attached to the body portion 526. In some embodiments, the first upper retainment tab 580A and the second upper retainment tab 580B can be integral to the body portion 526. In some embodiments, the first upper retainment tab 580A and the second upper retainment tab 580B can be attached to the body portion 526. In some embodiments, the first upper retainment tab 580A and the second upper retainment tab 580B are separate from and attached to the body portion 526 of the guide member 510. The cap 529 can attach to the body portion 526. In some embodiments, the body portion 526 can be hollow. In some embodiments, the cap 529 can snap fit to the body portion 526 through the top 524 of the body portion 526. In some embodiments, the cap 529 can include two flexible prongs 528 which can snap fit into an opening in the body portion 526.

In some embodiments, a matrix band can be received between the first upper retainment tab 580A of the guide member 510 and an outside surface of the body portion 526 of the guide member 510 such that at least a portion of the matrix band is positioned between the first upper retainment tab 580A of the guide member 510 and the body portion 526 of the guide member 510 in the operable state. In some embodiments, a matrix band can be received between the second upper retainment tab 580B of the guide member 510 and an outside surface of the body portion 526 of the guide member 510 such that at least a portion of the matrix band is positioned between the second upper retainment tab 580B of the guide member 510 and the body portion 526 of the guide member 510 in the operable state. In some embodiments, at least a portion of a matrix band can extend through the gap 532 in an operable state.

In some embodiments, a first lower retainment element 544 and/or a second lower retainment element 546 can attach to or be integrally formed with the body portion 526. In some embodiments, the guide member 510 can be substantially symmetrical across the midline 521. The first lower retainment element 544 and the second lower retainment element 546 can be positioned on opposing sides of the midline 521 in some embodiments. The first upper retainment tab 580A and second upper retainment tab 580B can be positioned on opposing sides of the midline 521 in some embodiments.

In any embodiments disclosed herein, the guide member 510 can be formed from a thermoplastic such as Polyethylene (PE), Polypropylene (PP), or Polyetheretherketone (PEEK), ABS, Nylons, Acetal Copolymer, and composites (e.g. glass or carbon filled) in some embodiments. The guide member 510 can be formed from silicone or wood in some embodiments. The guide member 510 can include a rubberized overlay in some embodiments. The guide member 510 can be injection molded. The guide member 510 can have various sizes. The guide member 510 can be small to accommodate a very small tooth, for example a pediatric tooth. The guide member 510 can be slightly larger than the pediatric sized guide member to accommodate a small tooth. The guide member 510 can be slightly larger than the small sized guide member to accommodate a medium tooth. The guide member 510 can be slightly larger than the medium band to accommodate a large tooth.

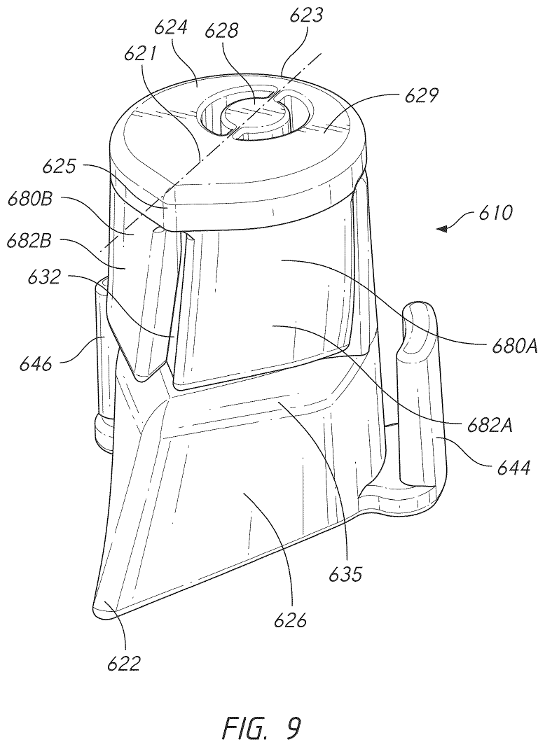

FIG. 9 illustrates another embodiment of a guide member 610. In some embodiments, the guide member 610 can include a body portion 226 having a proximal end 623, a distal end 625, a bottom 622, and a top 624. In some embodiments, the distal end 625 of the body portion 626 can have a wedge shape. In some embodiments, the body portion 626 can taper to a point at the distal end 625. In some embodiments, the distal end 625 of the body portion 626 can be longer at the bottom 622 than the top 624—e.g., the lower portion of the body portion 626 can protrude or extend further in the distal direction than the upper portion of the body portion 626. In some embodiments, the distal end 625 of the body portion 626 can be longer at a lower portion than at an upper portion. In some embodiment, the distal end 625 can include a step 635 such that the distal end 625 extends further outward below the step 635 and cuts inward above the step 635. In some embodiments, the step 635 can be positioned at or about at 50% of the height of the body portion 626. In some embodiments, the step 635 can be positioned at, or at about 20% to 80% of the height of the body portion 626. In some embodiments, the bottom 622 of the distal end 625 can be 20% or about 20% longer, or at least 20% or about at least 20% longer than the top 624 of the distal end 625, or from 15% or about 15% to 40% or about 40% longer. In some embodiments, the top 624 of the distal end 625 can be 2% or about 2% longer, or at least 2% or about at least 2% longer than the middle of the distal end 625, or from 0% or about 0% to 10% or about 10% longer. In some embodiments, the distal end 625 of the body portion can be the same length at the bottom 622 and the top 624. In some embodiments, the distal end 625 can have an hourglass shape between the bottom 622 and the top 624. In some embodiments, the distal end 625 of the guide member 610 can have a concavely curved profile in a vertical direction, such as between the bottom 622 and the top 624.

In some embodiments, the guide member 610 can include a cap 629 which can include a first upper retainment tab 680A (also referred to herein as a first retainment tab, a first retainment element, or a first upper retainment element) and a second upper retainment tab 680B (also referred to herein as a first retainment tab, a first retainment element, or a first upper retainment element). In some embodiments, the features and components described herein as being included in the cap 629 can be integrally formed with the body portion 626. The first upper retainment tab 680A and the second upper retainment tab 680B can be spaced around a portion of the perimeter of the top 624 of the cap 629 of the guide member 610. In some embodiments, the first upper retainment tab 680A and the second upper retainment tab 680B can be positioned so that the retainment tabs 680A and 680B are around an outside surface of the body portion 626 and spaced apart from the outside surface of the body portion 626. In some embodiments, the first upper retainment tab 680A and the second upper retainment tab 680B can extend towards the distal end 625 of the body portion 626. The first upper retainment tab 680A and the second upper retainment tab 680B can advantageously guide or restrain a matrix band that is positioned between the outside surface of the body portion 626 of the guide member 610 and an inside surface of at least the first upper retainment tab 680A and the second upper retainment tab 680B so that a lower portion of the matrix band is positioned against a surface of a tooth and the upper portion of the matrix band is pinched together or at least drawn together by the first upper retainment tab 680A and the second upper retainment tab 680B. The first upper retainment tab 680A can be spaced a distance away from the body portion 626 of the guide member 610, thereby forming a channel between the first upper retainment tab 680A and the body portion 626 of the guide member 610. The first upper retainment tab 680A can be spaced apart from body portion 626 of the guide member 610 a distance of, of about, or of at least about 0.002 inches to 0.05 inches in some embodiments. The first upper retainment tab 680A can be contoured to conform to the shape of the distal end 625 of the body portion 626. The second upper retainment tab 680B can be spaced a distance away from the body portion 626 of the guide member 610, thereby forming a channel between the second upper retainment tab 680B and the body portion 626. The second upper retainment tab 680B can be spaced apart from the body portion 626 of the guide member 610 a distance of, of about, or of at least about 0.002 inches to 0.05 inches in some embodiments. The second upper retainment tab 680B can be contoured to conform to the shape of the distal end 625 of the body portion 626.

The first upper retainment tab 680A and the second upper retainment tab 680B can advantageously hold a matrix band in place or bias a matrix band to remain in place around the guide member 610. The first upper retainment tab 680A and the second upper retainment tab 680B can, in some embodiments, advantageously inhibit the matrix band from sliding upward and outward from between a patient's teeth. The first upper retainment tab 680A and the second upper retainment tab 680B can reduce an aspiration risk when installing the dental matrix device including the guide member 610 in a patient's mouth.

The first upper retainment tab 680A can attach to or be integral to the top of the cap 629 and can include a portion 682A which can extend downward along the height of the guide member 610. The portion 682A can extend from the top 624 of the guide member 610 towards the bottom 622. In some embodiments, the portion 682A can extend across, across about, or across at least about 50% of the height of the body portion 626. In some embodiments, the portion 682A can extend across, or across about 20% to 100% of the height of the body portion 626.

The second upper retainment tab 680B can be a mirror image of the first upper retainment tab 680A. The first upper retainment tab 680A can be positioned on a first side of a midline 621 and the second upper retainment tab 680B can be positioned on a second side of the midline 621. The midline 621 is defined by the point of the distal end 625. The second upper retainment tab 680B can attach to or be integral to the top of the cap 629 and can include a portion 682B which can extend downward along the height of the guide member 610. The portion 682B can extend from the top 624 of the guide member 610 towards the bottom 622. In some embodiments, the portion 682B can extend across, across about, or across at least about 50% of the height of the body portion 626. In some embodiments, the portion 682B can extend across, or across about 20% to 100% of the height of the body portion 626.

In some embodiments, a gap 632 can be positioned between the first and second upper retainment tabs 680A and 680B. In some embodiments, the gap 632 can be positioned between the portion 682A of the first upper retainment tab 680A and the portion 682B of the second upper retainment tab 680B. In some embodiments, a matrix band can pass through the gap 632. Some embodiments are configured such that, when the matrix band is positioned around a pair of guide members 610 and between a pair of teeth, as the tension on the matrix band is increased and the pair of guide members are drawn toward the teeth, engagement of the first upper retainment tab 680A and the second upper retainment tab 680B with the teeth can cause the first upper retainment tab 680A and the second upper retainment tab 680B to be forced inwardly and thereby flex inwardly, decreasing the width of the gap 632 therebetween.

In some embodiments, the first upper retainment tab 680A and the second upper retainment tab 680B can attach to or be integral to the cap 629 which can be attached to the body portion 626. In some embodiments, the first upper retainment tab 680A and the second upper retainment tab 680B can be integral to the body portion 626. In some embodiments, the first upper retainment tab 680A and the second upper retainment tab 680B can be attached to the body portion 626. In some embodiments, the first upper retainment tab 680A and the second upper retainment tab 680B are separate from and attached to the body portion 626 of the guide member 610. The cap 629 can attach to the body portion 626. In some embodiments, the body portion 626 can be hollow. In some embodiments, the cap 629 can snap fit to the body portion 626 through the top 624 of the body portion 626. In some embodiments, the cap 629 can include two flexible prongs 628 which can snap fit into an opening in the body portion 626.

In some embodiments, a matrix band can be received between the first upper retainment tab 680A of the guide member 610 and an outside surface of the body portion 626 of the guide member 610 such that at least a portion of the matrix band is positioned between the first upper retainment tab 680A of the guide member 610 and the body portion 626 of the guide member 610 in the operable state. In some embodiments, a matrix band can be received between the second upper retainment tab 680B of the guide member 610 and an outside surface of the body portion 626 of the guide member 610 such that at least a portion of the matrix band is positioned between the second upper retainment tab 680B of the guide member 610 and the body portion 626 of the guide member 610 in the operable state. In some embodiments, at least a portion of a matrix band can extend through the gap 632 in an operable state.

In some embodiments, a first lower retainment element 644 and/or a second lower retainment element 646 can attach to or be integrally formed with the body portion 626. In some embodiments, the guide member 610 can be substantially symmetrical across the midline 621. The first lower retainment element 644 and the second lower retainment element 646 can be positioned on opposing sides of the midline 621 in some embodiments. The first upper retainment tab 680A and second upper retainment tab 680B can be positioned on opposing sides of the midline 621 in some embodiments.

In any embodiments disclosed herein, the guide member 610 can be formed from a thermoplastic such as Polyethylene (PE), Polypropylene (PP), or Polyetheretherketone (PEEK), ABS, Nylons, Acetal Copolymer, and composites (e.g. glass or carbon filled) in some embodiments. The guide member 610 can be formed from silicone or wood in some embodiments. The guide member 610 can include a rubberized overlay in some embodiments. The guide member 610 can be injection molded. The guide member 610 can have various sizes. The guide member 610 can be small to accommodate a very small tooth, for example a pediatric tooth. The guide member 610 can be slightly larger than the pediatric sized guide member to accommodate a small tooth. The guide member 610 can be slightly larger than the small sized guide member to accommodate a medium tooth. The guide member 610 can be slightly larger than the medium band to accommodate a large tooth.

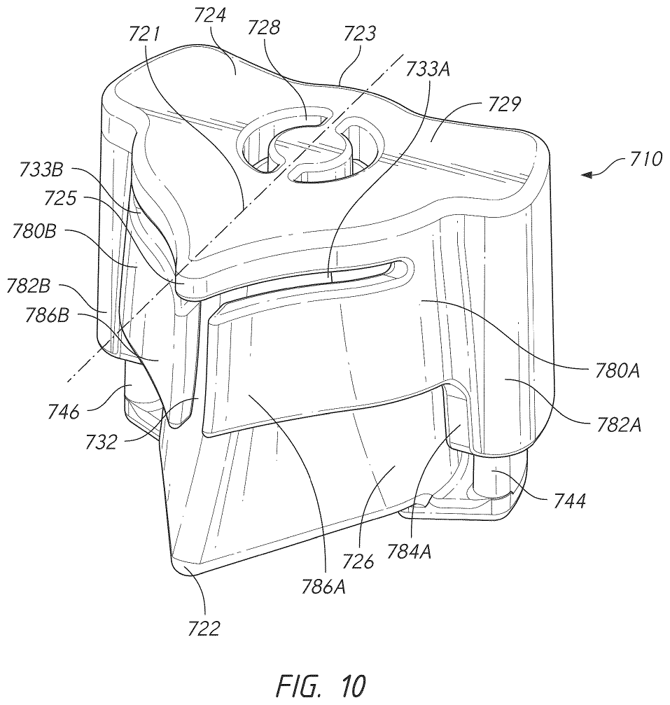

FIG. 10 illustrates another embodiment of a guide member. In some embodiments, the guide member 710 can include a body portion 726 having a proximal end 723, a distal end 725, a bottom 722, and a top 724. In some embodiments, the distal end 725 of the body portion 726 can have a wedge shape. In some embodiments, the body portion 726 can taper to a point at the distal end 725. In some embodiments, the distal end 725 of the body portion 726 can be longer at the bottom 722 than the top 724—e.g., the lower portion of the body portion 726 can protrude or extend further in the distal direction than the upper portion of the body portion 726. In some embodiments, the distal end 725 of the body portion 726 can be longer at a lower portion than at an upper portion of the body portion 726. In some embodiments, the bottom 722 of the distal end 725 can be 20% or about 20% longer, or at least 20% or about at least 20% longer than the top 724 of the distal end 725, or from 15% or about 15% to 40% or about 40% longer. In some embodiments, the top 724 of the distal end 725 can be 2% or about 2% longer, or at least 2% or about at least 2% longer than the middle of the distal end 725, or from 0% or about 0% to 10% or about 10% longer. In some embodiments, the distal end 725 of the body portion 726 can be the same length at the bottom 722 and the top 724. In some embodiments, the distal end 725 can have a curved or an hourglass shape between the bottom 722 and the top 724. In some embodiments, the distal end 725 of the guide member 710 can have a concavely curved profile in a vertical direction, such as between the bottom 722 and the top 724. In some embodiments, a distal edge of the distal end 725 of the body portion 726 can have a curved profile. In some embodiments, a distal edge of the distal end 725 of the body portion 726 can be shaped and configured to fill or substantially fill the embrasure space between a user's teeth.

In some embodiments, a first lower retainment element 744 and/or a second lower retainment element 746 can attach to or be integrally formed with the body portion 726. The first lower retainment element 744 can attach to the body portion 726 at the bottom 722 and extend towards the top 724. The first lower retainment element 744 can be spaced a distance away from the body portion 726 of the guide member 710, thereby forming a channel between the first lower retainment element 744 and the body portion 726 of the guide member 710 that can receive the matrix band. The first lower retainment element 744 can be spaced apart from the body portion 726 of the guide member 710 a distance of, of about, or of at least about 0.002 inches to 0.05 inches in some embodiments. The second lower retainment element 746 can attach to the body portion 726 at the bottom 722 and extend towards the top 724. The second lower retainment element 746 can be spaced a distance away from the body portion 726 of the guide member 710, thereby forming a channel between the second lower retainment element 746 and the body portion 726 of the guide member 710 that can receive the matrix band. The second lower retainment element 746 can be spaced apart from body portion 726 of the guide member 710 a distance of, of about, or of at least about 0.002 inches to 0.05 inches in some embodiments. In some embodiments, the guide member 710 can be substantially symmetrical across the midline 721. The first lower retainment element 744 and the second lower retainment element 746 can be positioned on opposing sides of the midline 721 in some embodiments.

In some embodiments, the guide member 710 can include a cap 729 which can include a first skirt portion 780A (also referred to herein as a first retainment tab, a first retainment element, or a first upper retainment element) and a second skirt portion 780B (also referred to herein as a second retainment tab, a first retainment element, or a first upper retainment element). In some embodiments, the features and components described herein as being included in the cap 729 can be integrally formed with the body portion 726. The first skirt portion 780A and the second skirt portion 780B can be spaced around a portion of the perimeter of the top 724 of the cap 729 of the guide member 710. In some embodiments, the first skirt portion 780A and the second skirt portion 780B can be positioned so that the skirt portions 780A and 780B are around an outside surface of the body portion 726. In some embodiments, the skirt portions 780A and 780B can be spaced apart from the outside surface of the body portion 726. In some embodiments, the first skirt portion 780A and the second skirt portion 780B can extend towards the distal end 725 of the body portion 726. The matrix band loops around the proximal end 723 of the body portion 726 such that the matrix band positioned between the body portion 726 and the first skirt portion 780A and the body portion 726 and the second skirt portion 780B. The first skirt portion 780A and the second skirt portion 780B can advantageously guide or restrain a matrix band that is positioned between the outside surface of the body portion 726 of the guide member 710 that can receive the matrix band and an inside surface of at least the first skirt portion 780A and the second skirt portion 780B so that a lower portion of the matrix band is positioned against or at least biased toward a surface of a tooth and the upper portion of the matrix band is pinched together or at least drawn together by the first skirt portion 780A and the second skirt portion 780B. The first skirt portion 780A can be spaced a distance away from the body portion 726 of the guide member 710, thereby forming a channel between the first skirt portion 780A and the body portion 726 of the guide member 710 that can receive the matrix band. The first skirt portion 780A can be spaced apart from body portion 726 of the guide member 710 a distance of, of about, or of at least about 0.002 inches to 0.05 inches in some embodiments. The first skirt portion 780A can be contoured to conform to the shape of the distal end 725 of the body portion 726. The second skirt portion 780B can be spaced a distance away from the body portion 726 of the guide member 710, thereby forming a channel between the second skirt portion 780B and the body portion 726. The second skirt portion 780B can be spaced apart from the body portion 726 of the guide member 710 a distance of, of about, or of at least about 0.002 inches to 0.05 inches in some embodiments. The second skirt portion 780B can be contoured to conform to the shape of the distal end 725 of the body portion 726. The first skirt portion 780A and second skirt portion 780B can be positioned on opposing sides of the midline 721 in some embodiments.

The first skirt portion 780A and the second skirt portion 780B can advantageously hold a matrix band in place or bias a matrix band to remain in place around the guide member 710. The first skirt portion 780A and the second skirt portion 780B can, in some embodiments, advantageously inhibit the matrix band from sliding upward and outward from between a patient's teeth. The first skirt portion 780A and the second skirt portion 780B can, in some embodiments, reduce an aspiration risk when installing a dental matrix device including the guide member 710 in a patient's mouth.

The first skirt portion 780A can attach to or be integrally formed with the top of the cap 729 and can include a first portion 782A which can extend downward along the height of the guide member 710. The first portion 782A can extend from the top 724 of the guide member 710 towards the bottom 722. In some embodiments, the first portion 782A can extend across, across about, or across at least about 90% of the height of the body portion 726. In some embodiments, the first portion 782A can extend across, or across about 30% to 100% of the height of the body portion 726. In some embodiments, the first portion 782A can extend over and around the first lower retainment element 744 so that the cap 729 can fit around the first lower retainment element 744. The first portion 782A can engage with the first lower retainment element 744. Advantageously, the first portion 782A extending over and around the first lower retainment element 744 can reduce rotation and tilting of the cap 729 relative to the body portion 726 when a matrix band is tensioned around the guide member 710. The first skirt portion 780A can include a second portion 786A (also referred to herein as a tab portion) which extends from the first portion 782A towards the distal end 725. The second portion 786A can connect to or be integrally formed with the first portion 782A near the middle of the first portion 782A. The second portion 786A can be at an angle from the first portion 782A. In some embodiments, the second portion 786A can be at or at about a 90-degree angle, or at least a 90-degree angle from the first portion 782A. In some embodiments, the second portion 786A can be or be about from a 30-degree angle to a 120-degree from the first portion 782A. The first skirt portion 780A can include a cutout 784A positioned between the first portion 782A and the second portion 786A. The cutout 784A can provide space between the bottom 722 of the distal end 725 and the second portion 786A. In some embodiments, the distal end 725 can extend outward through the cutout 784A.

In some embodiments, the second skirt portion 780B can be a mirror image of the first skirt portion 780A. The first skirt portion 780A can be positioned on a first side of a midline 721 and the second skirt portion 780B can be positioned on a second side of the midline 721. The midline 721 is defined by the point or vertex of the distal end 725. The second skirt portion 780B can attach to the top 724 of the cap 729 and can include a first portion 782B which can extend downward along the height of the guide member 710. In some embodiments, the first portion 782B can extend across, across about, or across at least about 90% of the height of the body portion 726. In some embodiments, the first portion 782B can extend across, or across about 30% to 100% of the height of the body portion 726. In some embodiments, the first portion 782B can extend over and around the second lower retainment element 746 so that the cap 729 can fit around the second lower retainment element 746. The first portion 782B can engage with the second lower retainment element 746. Advantageously, the first portion 782B extending over and around the second lower retainment element 746 can reduce rotation and tilting of the cap 729 relative to the body portion 726 when a matrix band is tensioned around the guide member 710. The second skirt portion 780B can include a second portion 786B (also referred to herein as a tab portion) which extends from the first portion 782B towards the distal end 725. The second portion 786B can connect to or be integrally formed with the first portion 782B near the middle of the first portion 782B. The second portion 786B can be at an angle from the first portion 782B. In some embodiments, the second portion 786B can be at or at about a 90-degree angle, or at least a 90-degree angle from the first portion 782B. In some embodiments, the second portion 786B can be or be about from a 30-degree angle to a 120-degree from the first portion 782B. The second skirt portion 780B can include a cutout 784B positioned between the first portion 782B and the second portion 786B. The cutout 784B can provide space between the bottom 722 of the distal end 725 and the second portion 786B. In some embodiments, the distal end 725 can extend outward through the cutout 784B.

In some embodiments, a gap 732 can be positioned between the first and second skirt portions 780A, 780B. In some embodiments, the gap 732 can be positioned between the second portion 786A of the first skirt portion 780A and the second portion 786B of the second skirt portion 780B. In some embodiments, a matrix band can pass through the gap 732. In some embodiments, a matrix band can pass through the gap 732, around the body portion 726 of the guide member 710, and then back through the gap 732. Some embodiments are configured such that, when the matrix band is positioned around a pair of guide members 710 and between a pair of teeth, as the tension on the matrix band is increased and the pair of guide members are drawn toward the teeth, engagement of the tab portion 786A of the first skirt portion 780A and the tab portion 786B of the second skirt portion 780B with the teeth can cause the tab portion 786A of the first skirt portion 780A and the tab portion 786B of the second skirt portion 780B to be forced inwardly and thereby flex inwardly, decreasing the width of the gap 732 therebetween. In some embodiments, a relief slot 733A can extend from the gap 732 towards the proximal end 723. The relief slot 733A can be positioned above the tab portion 786A. In some embodiments, a relief slot 733B can extend from the gap 732 towards the proximal end 723. The relief slot 733B can be positioned above the tab portion 786B. The relief slots 733A and 733B can advantageously increase the flexibility of the first skirt portion 780A and the second skirt portion 780B (for example and without limitation, the second portion 786A of the first skirt portion 780A and the second portion 786B of the second skirt portion 780B) so that the first skirt portion 780A and the second skirt portion 780B and/or the tab portion 786A of the first skirt portion 780A and the tab portion 786B of the second skirt portion 780B, can flex together when driven into the surfaces of the teeth allowing approximation of the paralleling matrix bands in the operable state.

In some embodiments, the first skirt portion 780A and the second skirt portion 780B can be integral to the cap 729 which can be attached to the body portion 726. In some embodiments, the first skirt portion 780A and the second skirt portion 780B can be integral to the body portion 726. In some embodiments, the first skirt portion 780A and the second skirt portion 780B can be attached to the body portion 726. In some embodiments, the first skirt portion 780A and the second skirt portion 780B are separate from and attached to the body portion 726 of the guide member 710. The cap 729 can attach to or couple to the body portion 726 or be integrally formed with the body portion 726. In some embodiments, the body portion 726 can be hollow. In some embodiments, the cap 729 can snap fit to the body portion 726 through the top 724 of the body portion 726. In some embodiments, the cap 729 can include two flexible prongs 728 which can snap fit into an opening in the body portion 726.

In some embodiments, a matrix band can be received between the first skirt portion 780A of the guide member 710 and an outside surface of the body portion 726 of the guide member 710 such that at least a portion of the matrix band is positioned between the first skirt portion 780A of the guide member 710 and the body portion 726 of the guide member 710 in the operable state. In some embodiments, a matrix band can be received between the second skirt portion 780B of the guide member 710 and an outside surface of the body portion 726 of the guide member 710 such that at least a portion of the matrix band is positioned between the second skirt portion 780B of the guide member 710 and the body portion 726 of the guide member 710 in the operable state. In some embodiments, a matrix band can be received between the first lower retainment element 744 and an outside surface of the body portion 726 of the guide member 710 such that at least a portion of the matrix band is positioned between the first lower retainment element 744 of the guide member 710 and the body portion 726 of the guide member 710 in the operable state. In some embodiments, a matrix band can be received between the second lower retainment element 746 of the guide member 710 and an outside surface of the body portion 726 of the guide member 710 such that at least a portion of the matrix band is positioned between the second lower retainment element 746 and the body portion 726 of the guide member 710 in the operable state. In some embodiments, at least a portion of a matrix band can extend through the gap 732 in an operable state.

In any embodiments disclosed herein, the guide member 710 and/or any other components disclosed herein can be formed from a thermoplastic such as Polyethylene (PE), Polypropylene (PP), or Polyetheretherketone (PEEK), ABS, Nylons, Acetal Copolymer, and Composites (e.g. glass or carbon filled) in some embodiments. The guide member 710 can be formed from silicone or wood in some embodiments. The guide member 710 can include a rubberized overlay in some embodiments. The guide member 710 can be injection molded. The guide member 710 can have or be provided in various sizes. Some embodiments of the guide member 710 can be small to accommodate a very small tooth, for example a pediatric tooth. Some embodiments of the guide member 710 can be slightly larger than the pediatric sized guide member to accommodate a small tooth. Some embodiments of the guide member 710 can be slightly larger than the small sized guide member to accommodate a medium tooth. The guide member 710 can be slightly larger than the medium band to accommodate a large tooth.

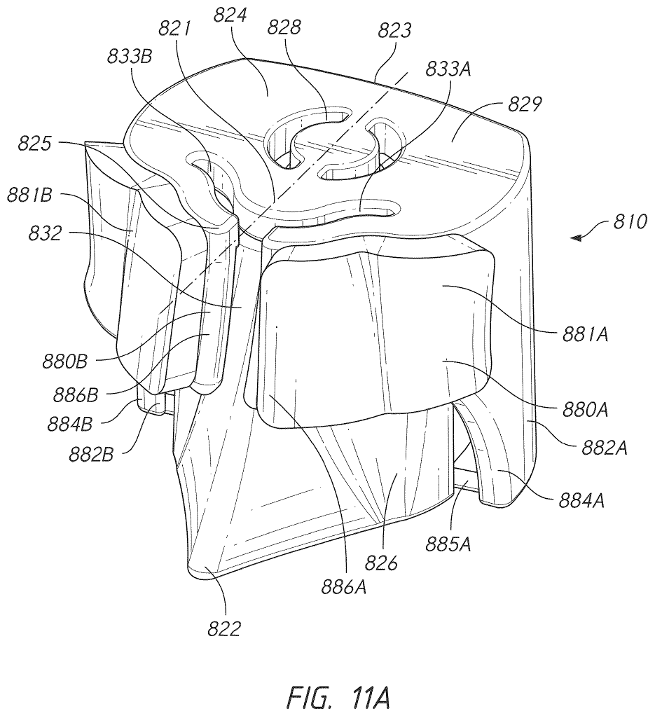

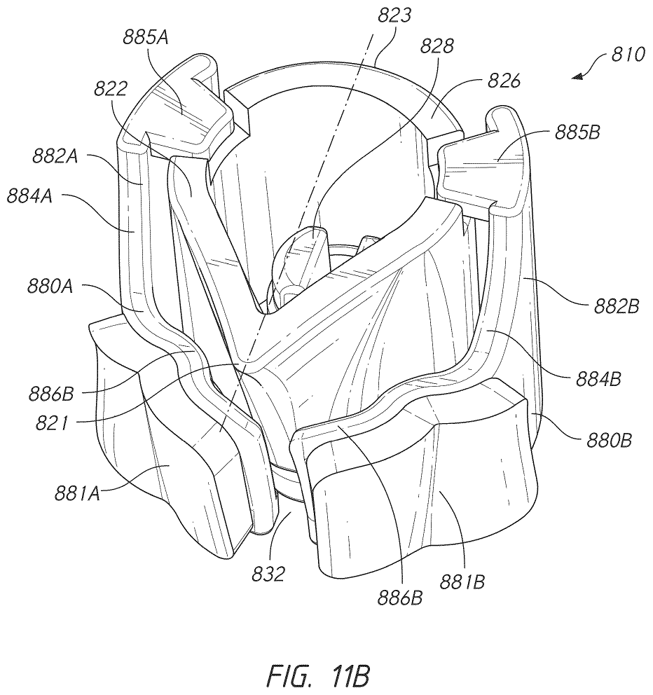

FIGS. 11A and 11B illustrate another embodiment of a guide member. In some embodiments, the guide member 810 can include a body portion 826 having a proximal end 823, a distal end 825, a bottom 822, and a top 824. In some embodiments, the distal end 825 of the body portion 826 can have a wedge shape. In some embodiments, the body portion 826 can taper to a point at the distal end 825. In some embodiments, the distal end 825 of the body portion 826 can be longer at the bottom 822 than the top 824—e.g., the lower portion of the body portion 826 can protrude or extend further in the distal direction than the upper portion of the body portion 826. In some embodiments, the distal end 825 of the body portion 826 can be longer at a lower portion than at an upper portion of the body portion. In some embodiments, the bottom 822 of the distal end 825 can be 20% or about 20% longer, or at least 20% or about at least 20% longer than the top 824 of the distal end 825, or from 15% or about 15% to 40% or about 40% longer. In some embodiments, the top 824 of the distal end 825 can be 2% or about 2% longer, or at least 2% or about at least 2% longer than the middle of the distal end 825, or from 0% or about 0% to 10% or about 10% longer. In some embodiments, the distal end 825 of the body portion 826 can be the same length at the bottom 822 and the top 824. In some embodiments, the distal end 825 can have a curved or an hourglass shape between the bottom 822 and the top 824. In some embodiments, the distal end 825 of the guide member 810 can have a concavely curved profile in a vertical direction, such as between the bottom 822 and the top 824. In some embodiments, a distal edge of the distal end 825 of the body portion 826 can have a curved profile. In some embodiments, a distal edge of the distal end 825 of the body portion 826 can be shaped and configured to fill or substantially fill a space between a user's teeth.

In some embodiments, the guide member 810 can include a cap 829 which can include a first upper retainment tab 880A (also referred to herein as a first retainment tab, a first retainment element, or a first upper retainment element) and a second upper retainment tab 880B (also referred to herein as a first retainment tab, a first retainment element, or a first upper retainment element). In some embodiments, the features and components described herein as being included in the cap 829 can be integrally formed with the body portion 826. The first upper retainment tab 880A and the second upper retainment tab 880B can be spaced around a portion of the perimeter of the top 824 of the cap 829 of the guide member 810. In some embodiments, the first upper retainment tab 880A and the second upper retainment tab 880B can be positioned so that the retainment tabs 880A and 880B are around an outside surface of the body portion 826. In some embodiments, the retainment tabs 880A and 880B can be spaced apart from the outside surface of the body portion 826. In some embodiments, the first upper retainment tab 880A and the second upper retainment tab 880B can extend towards the distal end 825 of the body portion 826. The matrix band loops around the proximal end 823 of the body portion 826 such that the matrix band positioned between the body portion 826 and the first upper retainment tab 880A and the body portion 826 and the second upper retainment tab 880B. The first upper retainment tab 880A and the second upper retainment tab 880B can advantageously guide or restrain a matrix band that is positioned between the outside surface of the body portion 826 of the guide member 810 that can receive the matrix band and an inside surface of at least the first upper retainment tab 880A and the second upper retainment tab 880B so that a lower portion of the matrix band is positioned against or at least biased toward a surface of a tooth and the upper portion of the matrix band is pinched together or at least drawn together by the first upper retainment tab 880A and the second upper retainment tab 880B. The first upper retainment tab 880A can be spaced a distance away from the body portion 826 of the guide member 810, thereby forming a channel between the first upper retainment tab 880A and the body portion 826 of the guide member 810 that can receive the matrix band. The first upper retainment tab 880A can be spaced apart from body portion 826 of the guide member 810 a distance of, of about, or of at least about 0.002 inches to 0.05 inches in some embodiments. The first upper retainment tab 880A can be contoured to conform to the shape of the distal end 825 of the body portion 826. The second upper retainment tab 880B can be spaced a distance away from the body portion 826 of the guide member 810, thereby forming a channel between the second upper retainment tab 880B and the body portion 826. The second upper retainment tab 880B can be spaced apart from the body portion 826 of the guide member 810 a distance of, of about, or of at least about 0.002 inches to 0.05 inches in some embodiments. The second upper retainment tab 880B can be contoured to conform to the shape of the distal end 825 of the body portion 826.

The first upper retainment tab 880A and the second upper retainment tab 880B can advantageously hold a matrix band in place or bias a matrix band to remain in place around the guide member 810. The first upper retainment tab 880A and the second upper retainment tab 880B can, in some embodiments, advantageously inhibit the matrix band from sliding upward and outward from between a patient's teeth. The first upper retainment tab 880A and the second upper retainment tab 880B can, in some embodiments, reduce an aspiration risk when installing a dental matrix device including the guide member 810 in a patient's mouth.

The first upper retainment tab 880A can attach to or be integrally formed with the top of the cap 829 and can include a first portion 882A which can extend downward along the height of the guide member 810. The first portion 882A can extend from the top 824 of the guide member 810 towards the bottom 822. In some embodiments, the first portion 882A can extend across, across about, or across at least about 100% of the height of the body portion 826. In some embodiments, the first portion 882A can extend across, or across about 30% to 100% of the height of the body portion 826. In some embodiments, the first portion 882A can include a snap 885A which can attach to or engage with the bottom 822. In some embodiments, the snap 885A can snap to the bottom 822. Advantageously, the snap 885A engaging with the bottom 822 can reduce rotation and tilting of the cap 829 relative to the body portion 826 when a matrix band is tensioned around the guide member 810. The first upper retainment tab 880A can include a second portion 886A which extends from the first portion 882A towards the distal end 825. The second portion 886A can connect to or be integrally formed with the first portion 882A near the middle of the first portion 882A. The second portion 886A can be at an angle from the first portion 882A. In some embodiments, the second portion 886A can be at or at about a 90-degree angle, or at least a 90-degree angle from the first portion 882A. In some embodiments, the second portion 886A can be or be about from a 30-degree angle to a 120-degree from the first portion 882A. An over-mold 881A can be positioned on an outer surface of the second portion 886A. The over-mold 881A can advantageously provide a compliant grip between the guide member 810 and a tooth. The first upper retainment tab 880A can include a cutout 884A positioned between the first portion 882A and the second portion 886A. The cutout 884A can provide space between the bottom 822 of the distal end 825 and the second portion 886A. In some embodiments, the distal end 825 can extend outward through the cutout 884A. The first portion 882A, second portion 886A, and the cutout 884A can be shaped such that the cap 829 can be positioned outside of the interproximal region when the guide member 810 is positioned in a patient's mouth.

In some embodiments, the second upper retainment tab 880B can be a mirror image of the first upper retainment tab 880A. The first upper retainment tab 880A can be positioned on a first side of a midline 821 and the second upper retainment tab 880B can be positioned on a second side of the midline 821. The midline 821 is defined by the point or vertex of the distal end 825. The second upper retainment tab 880B can attach to the top 824 of the cap 829 and can include a first portion 882B which can extend downward along the height of the guide member 810. In some embodiments, the first portion 882B can extend across, across about, or across at least about 100% of the height of the body portion 826. In some embodiments, the first portion 882B can extend across, or across about 30% to 100% of the height of the body portion 826. In some embodiments, the first portion 882B can include a snap 885B which can attach to or engage with the bottom 822. In some embodiments, the snap 885B can snap to the bottom 822. Advantageously, the snap 885B engaging with the bottom 822 can reduce rotation and tilting of the cap 829 relative to the body portion 826 when a matrix band is tensioned around the guide member 810. The second upper retainment tab 880B can include a second portion 886B which extends from the first portion 882B towards the distal end 825. The second portion 886B can connect to or be integrally formed with the first portion 882B near the middle of the first portion 882B. The second portion 886B can be at an angle from the first portion 882B. In some embodiments, the second portion 886B can be at or at about a 90-degree angle, or at least a 90-degree angle from the first portion 882B. In some embodiments, the second portion 886B can be or be about from a 30-degree angle to a 120-degree from the first portion 882B. An over-mold 881B can be positioned on an outer surface of the second portion 886B. The over-mold 881B can advantageously provide a compliant grip between the guide member 810 and a tooth. The second upper retainment tab 880B can include a cutout 884B positioned between the first portion 882B and the second portion 886B. The cutout 884B can provide space between the bottom 822 of the distal end 825 and the second portion 886B. In some embodiments, the distal end 825 can extend outward through the cutout 884B. The first portion 882B, second portion 886B, and the cutout 884B can be shaped such that the cap 829 can be positioned outside of the interproximal region when the guide member 810 is positioned in a patient's mouth.

In some embodiments, a gap 832 can be positioned between the first and second upper retainment tabs 880A, 880B. In some embodiments, the gap 832 can be positioned between the second portion 886A of the first upper retainment tab 880A and the second portion 886B of the second upper retainment tab 880B. In some embodiments, a matrix band can pass through the gap 832. In some embodiments, a matrix band can pass through the gap 832, around the body portion 826 of the guide member 810, and then back through the gap 832. Some embodiments are configured such that, when the matrix band is positioned around a pair of guide members 810 and between a pair of teeth, as the tension on the matrix band is increased and the pair of guide members are drawn toward the teeth, engagement of the first upper retainment tab 880A and the second upper retainment tab 880B with the teeth can cause the first upper retainment tab 880A and the second upper retainment tab 880B to be forced inwardly and thereby flex inwardly, decreasing the width of the gap 832 therebetween. In some embodiments, a relief slot 833A can extend from the gap 832 towards the proximal end 823. The relief slot 833A can be positioned in the top 824 and above the second portion 886A. In some embodiments, a relief slot 833B can extend from the gap 832 towards the proximal end 823. The relief slot 833B can be positioned in the top 824 and above the second portion 886B. The relief slots 833A and 833B can advantageously increase the flexibility of the first upper retainment tab 880A and the second upper retainment tab 880B (for example and without limitation, the second portion 886A of the first upper retainment tab 880A and the second portion 886B of the second upper retainment tab 880B) so that the first upper retainment tab 880A and the second upper retainment tab 880B and/or the second portion 886A of the first upper retainment tab 880A and the second portion 886B of the second upper retainment tab 880B, can flex together when driven into the surfaces of the teeth allowing approximation of the paralleling matrix bands in the operable state.

In some embodiments, the first upper retainment tab 880A and the second upper retainment tab 880B can be integral to the cap 829 which can be attached to the body portion 826. In some embodiments, the first upper retainment tab 880A and the second upper retainment tab 880B can be integral to the body portion 826. In some embodiments, the first upper retainment tab 880A and the second upper retainment tab 880B can be attached to the body portion 826. In some embodiments, the first upper retainment tab 880A and the second upper retainment tab 880B are separate from and attached to the body portion 826 of the guide member 810. The cap 829 can attach to or couple to the body portion 826 or be integrally formed with the body portion 826. In some embodiments, the body portion 826 can be hollow. In some embodiments, the cap 829 can snap fit to the body portion 826 through the top 824 of the body portion 826. In some embodiments, the cap 829 can include two flexible prongs 828 which can snap fit into an opening in the body portion 826.

In some embodiments, a matrix band can be received between the first upper retainment tab 880A of the guide member 810 and an outside surface of the body portion 826 of the guide member 810 such that at least a portion of the matrix band is positioned between the first upper retainment tab 880A of the guide member 810 and the body portion 826 of the guide member 810 in the operable state. In some embodiments, a matrix band can be received between the second upper retainment tab 880B of the guide member 810 and an outside surface of the body portion 826 of the guide member 810 such that at least a portion of the matrix band is positioned between the second upper retainment tab 880B of the guide member 810 and the body portion 826 of the guide member 810 in the operable state. In some embodiments, at least a portion of a matrix band can extend through the gap 832 in an operable state.

In any embodiments disclosed herein, the guide member 810 and/or any other components disclosed herein can be formed from a thermoplastic such as Polyethylene (PE), Polypropylene (PP), or Polyetheretherketone (PEEK), ABS, Nylons, Acetal Copolymer, and Composites (e.g. glass or carbon filled) in some embodiments. The guide member 810 can be formed from silicone or wood in some embodiments. The over-molds 881A and 881B can be formed from a rubberized material or silicone in some embodiments. The guide member 810 can include a rubberized overlay in some embodiments. The guide member 810 can be injection molded. The guide member 810 can have or be provided in various sizes. Some embodiments of the guide member 810 can be small to accommodate a very small tooth, for example a pediatric tooth. Some embodiments of the guide member 810 can be slightly larger than the pediatric sized guide member to accommodate a small tooth. Some embodiments of the guide member 810 can be slightly larger than the small sized guide member to accommodate a medium tooth. The guide member 810 can be slightly larger than the medium sized guide member to accommodate a large tooth.

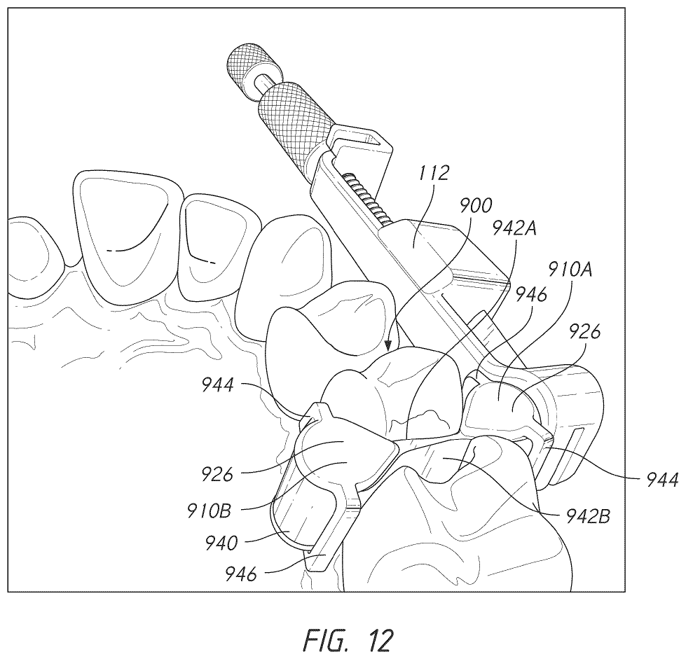

FIG. 12 illustrates a perspective view of another embodiment of a dental matrix device 900 in an operable position between a pair of teeth. As illustrated, a pair of prepared teeth in a dental model are shown. In some embodiments of the dental matrix device 900, the dental matrix device 900 includes a pair of guide members 910A, 910B, a matrix band 940, and an instrument (referred to herein as a matrix retainer or matrix tensioner) that can be used to at least tension or tighten the matrix band. In some embodiments, both ends of the matrix band 940 can be coupled with or held by the matrix retainer 112 so that a middle portion of the matrix band 940 extends from the matrix retainer 112 in looping fashion. A portion of the matrix band 940 can be positioned between a pair of teeth while the matrix band 940 extends or loops completely around a body portion 926 of one of the guide members 910B and around at least a portion of a body portion 926 of the other of the guide members 910A that is closer to the matrix retainer 112. As the matrix retainer 112 is used to tighten the matrix band 940, the tightening of the matrix band 940 will cause the two guide members 910A, 910B to move toward each other between the teeth, providing the temporary orthodontic distraction needed to perform a dental filling, for example.

The first guide member 910A can include the body portion 926 having a distal end 925, a proximal end 923, a first retainment element 944, and a second retainment element 946. In some embodiments, in an operable state, the proximal end 923 can be the end of the guide member 910A that is further from the subject teeth or is facing away from the subject teeth and the distal end 925 can be the end of the guide member 910A that is closer to the subject teeth or is facing toward the subject teeth. Additionally, in some embodiments, the body portion 926 of the first guide member 910A can be wedge shaped, having a thicker or wider proximal end 923 and tapering to a narrower distal end 925. In some embodiments, the distal end 925 can have a smooth contour or be curved. In some embodiments, the first retainment element 944 and the second retainment element 946 are positioned between the proximal end 923 and the distal end 925 of the first guide member 910A—for example and without limitation, on the sides of the body portion 926 of the first guide member 910A. For example and without limitation, the first retainment element 944 can be on an opposite side of the body portion 926 of the first guide member 910A from the second retainment element 946.

A second guide member 910B can be similar to or identical to the first guide member 910A or at least have any of the same or similar features, in some embodiments. For example and without limitation, the second guide member 910B can include the body portion 926 having a proximal end 923, a distal end 925, a first retainment element 944, and a second retainment element 946. In some embodiments, the first retainment element 944 is on an opposite side of the body portion 926 of the first guide member 910A from the second retainment element 946.

In some embodiments, the first retainment element 944 is on an opposite side of the first guide member 910A from the second retainment element 946. In some embodiments, the first retainment element 944 is on an opposite side of the second guide member 910B from the second retainment element 946. In some embodiments, the first guide member 910A and the second guide member 910B can be positioned with the distal end 925 of the first guide member 910A facing the distal end 925 of the second guide member 910B. The retainment element 944 can attach to the guide members 910A, 910B at the top and bottom of the guide member 910A, 910B and form a channel between the guide member 910A, 910B and the retainment element 944. The retainment element 946 can attach to the guide member 910A, 910B at the top and bottom of the guide member 910A, 910B and form a channel between the guide member 910A, 910B and the retainment element 946.

The matrix band 940 can, in an operable position, extend around at least a portion of the first guide member 910A, between the pair of teeth, and around at least a portion of the second guide member 910B. The matrix band 940 can provide a barrier between the teeth during a dental procedure. The matrix band 940 can have a portion 942A extending from a first side of the proximal end 923 of the first guide member 910A and around the proximal end 923 of the second guide member 910B. The matrix band 940 can have a second portion 942B extending from the proximal end 923 of the second guide member 910B to a second side of the proximal end 923 of the first guide member 910A. The first guide member 910A can receive the portion 942A of the matrix band 940 between an outside surface of the body portion 926 of first guide member 910A and the first retainment element 944 of the first guide member 910A, for example through the channel between the first retainment element 944 and the body portion 926 in some embodiments. The second guide member 910B can receive the portion 942A of the matrix band 940 between an outside surface of the body portion 926 of the second guide member 910B and the second retainment element 946 of the second guide member 910B, for example through the channel between the second retainment element 946 and the body portion 926 of the second guide member 910B in some embodiments. The second guide member 910B can receive the portion 942B of the matrix band 940 between an outside surface of the body portion 926 of the second guide member 910B and the first retainment element 944 of the second guide member 910B, for example through the channel between the first retainment element 944 and the body portion 926 of the second guide member 910B in some embodiments. The first guide member 910A can receive the portion 942B of the matrix band 940 between an outside surface of the body portion 926 of the first guide member 910A and the second retainment element 946 of the first guide member 910A for example through the channel between the second retainment element 946 and the first guide member 910A in some embodiments.

The retainment elements 944 and 946 can advantageously hold a matrix band in place around the guide member 910. The retainment elements 944 and 946 can advantageously inhibit the matrix band from sliding upward and outward from between a patient's teeth. The retainment elements 944 and 946 can reduce an aspiration risk when installing the dental matrix device 900 in a patient's mouth.

In some embodiments, the first guide member 910A can be positioned on a first side of a pair of teeth. The second guide member 910B can be positioned on a second side of the pair of teeth. In some embodiments, the matrix band 940 can pass between the pair of teeth. Both the portion 942A and the portion 942B of the matrix band 940 can pass between the pair of teeth in some embodiments. The dental matrix device 900 can force the first guide member 910A to move toward the second guide member when the matrix band 940 is tightened around at least a portion of the first and second guide members 910A, 910B. In some embodiments, both ends of the matrix band 940 can be attached to a matrix retainer 112. In some embodiments, the matrix retainer 112 can be positioned against the proximal end of the first guide member 910A. The matrix retainer 112 can generate a tension force in the matrix band 940 in some embodiments. The tension force in the matrix band 940 can force the first guide member 910A to move toward the second guide member 910B. The tension force can bias the first guide member 910A toward the second guide member 910B. In some embodiments, the tension force can be, can be about, or can be at least about 10 lbf, 11 lbf, 12 lbf, 13 lbf, 14 lbf, 15 lbf, 16 lbf, 17 lbf, 18 lbf, 19 lbf, 20 lbf, 21 lbf, 22 lbf, 23 lbf, 24 lbf, 25 lbf, 26 lbf, 27 lbf, 28 lbf, 29 lbf, 30 lbf, or any values, approximate values, or ranges of values in any of the foregoing range. In some embodiments, applying the tension force to the guide members 910A and 910B can generate temporary orthodontic distraction between the pair of teeth.

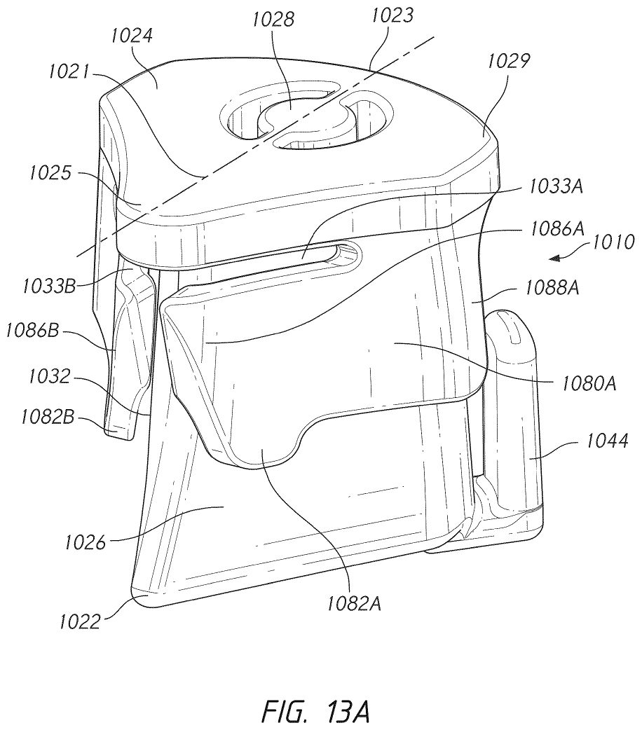

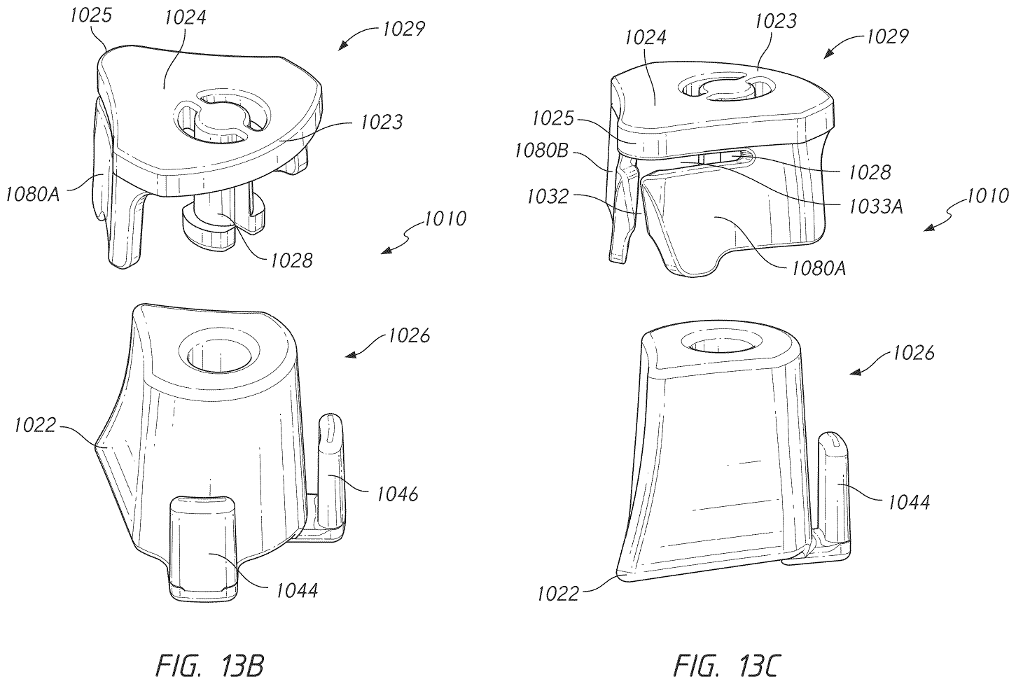

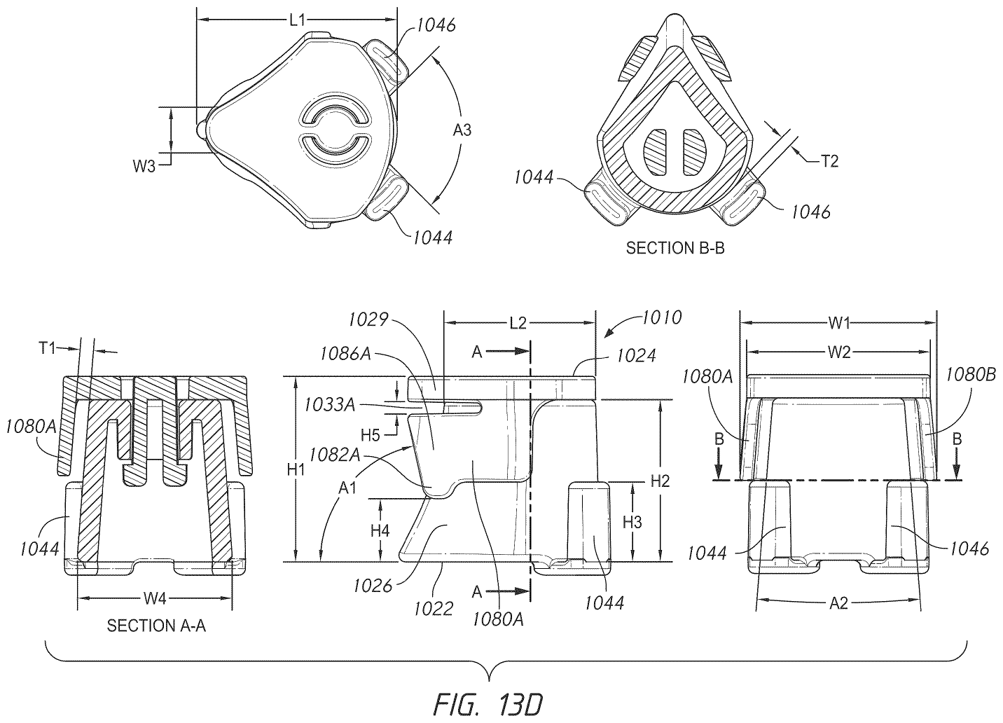

FIGS. 13A-13D illustrate another embodiment of a guide member. In some embodiments, the guide member 1010 can include a body portion 1026 having a proximal end 1023, a distal end 1025, a bottom 1022, and a top 1024. In some embodiments, the distal end 1025 of the body portion 1026 can have a wedge shape. In some embodiments, the body portion 1026 can taper to a point at the distal end 1025. In some embodiments, the distal end 1025 of the body portion 1026 can be longer at the bottom 1022 than the top 1024—e.g., the lower portion of the body portion 1026 can protrude or extend further in the distal direction than the upper portion of the body portion 1026. In some embodiments, the distal end 1025 of the body portion 1026 can be longer at a lower portion than at an upper portion of the body portion. In some embodiments, the bottom 1022 of the distal end 1025 can be 20% or about 20% longer, or at least 20% or about at least 20% longer than the top 1024 of the distal end 1025, or from 15% or about 15% to 40% or about 40% longer. In some embodiments, the top 1024 of the distal end 1025 can be 2% or about 2% longer, or at least 2% or about at least 2% longer than the middle of the distal end 1025, or from 0% or about 0% to 10% or about 10% longer. In some embodiments, the distal end 1025 of the body portion 1026 can be the same length at the bottom 1022 and the top 1024. In some embodiments, the distal end 1025 can have a curved or an hourglass shape between the bottom 1022 and the top 1024. In some embodiments, the distal end 1025 of the guide member 1010 can have a concavely curved profile in a vertical direction, such as between the bottom 1022 and the top 1024. In some embodiments, a distal edge of the distal end 1025 of the body portion 1026 can have a curved profile. In some embodiments, a distal edge of the distal end 1025 of the body portion 1026 can be shaped and configured to fill or substantially fill the embrasure space between a user's teeth. In some embodiments, the distal edge of the distal end 1025 of the body portion 1026 can be a chamfered edge.

In some embodiments, the width of the body portion 1026 can be longer at the bottom 1022 than the top 1024—e.g., the lower portion of the body portion 1026 can be wider than the upper portion of the body portion 1026. In some embodiments, the bottom 1022 of the body portion 1026 can be 16% or about 16% longer, or at least 16% or about at least 16% longer than the top 1024 of the body portion 1026, or from 5% or about 5% to 40% or about 40% longer. The body portion 1026 can taper at an angle of 60 degrees or about 60 degrees, or at least 60 degrees, or about at least 60 degrees from the bottom 1022 to the top 1024 of the body portion 1026, or from 45 degrees or about 45 degrees to 75 degrees or about 75 degrees taper. Advantageously, the taper from the bottom 1122 to the top 1124 allows the distal end 1125 to fit between the teeth at the top.

In some embodiments, the guide member 1010 can include a cap 1029 which can include a first upper retainment tab 1080A (also referred to herein as a first retainment tab, a first retainment element, or a first upper retainment element) and a second upper retainment tab 1080B (also referred to herein as a second retainment tab, a second retainment element, or a second upper retainment element). The first upper retainment tab 1080A and the second upper retainment tab 1080B can be spaced around a portion of the perimeter of the top 1024 of the cap 1029 of the guide member 1010. In some embodiments, the features and components described herein as being included in the cap 1029 can be integrally formed with the body portion 1026. In some embodiments, the first upper retainment tab 1080A and the second upper retainment tab 1080B can be positioned so that the retainment tabs 1080A and 1080B are around an outside surface of the body portion 1026. In some embodiments, the retainment tabs 1080A and 1080B can be spaced apart from the outside surface of the body portion 1026. In some embodiments, the first upper retainment tab 1080A and the second upper retainment tab 1080B can extend towards the distal end 1025 of the body portion 1026. A matrix band can loop around the proximal end 1023 of the body portion 1026 such that the matrix band positioned between the body portion 1026 and the first upper retainment tab 1080A and the body portion 1026 and the second upper retainment tab 1080B. The first upper retainment tab 1080A and the second upper retainment tab 1080B can advantageously guide or restrain a matrix band that is positioned between the outside surface of the body portion 1026 of the guide member 1010 that can receive the matrix band and an inside surface of at least the first upper retainment tab 1080A and the second upper retainment tab 1080B. A lower portion of the matrix band is positioned against or at least biased toward a surface of a tooth and the upper portion of the matrix band is pinched together or at least drawn together by the first upper retainment tab 1080A and the second upper retainment tab 1080B. The first upper retainment tab 1080A can be spaced a distance away from the body portion 1026 of the guide member 1010, thereby forming a channel between the first upper retainment tab 1080A and the body portion 1026 of the guide member 1010 that can receive the matrix band. The first upper retainment tab 1080A can be spaced apart from body portion 1026 of the guide member 1010 a distance of, of about, or of at least about 0.002 inches to 0.05 inches in some embodiments. The first upper retainment tab 1080A can be contoured to conform to the shape of the distal end 1025 of the body portion 1026. The second upper retainment tab 1080B can be spaced a distance away from the body portion 1026 of the guide member 1010, thereby forming a channel between the second upper retainment tab 1080B and the body portion 1026. The second upper retainment tab 1080B can be spaced apart from the body portion 1026 of the guide member 1010 a distance of, of about, or of at least about 0.002 inches to 0.05 inches in some embodiments. The second upper retainment tab 1080B can be contoured to conform to the shape of the distal end 1025 of the body portion 1026.

The first upper retainment tab 1080A and the second upper retainment tab 1080B can advantageously hold a matrix band in place or bias a matrix band to remain in place around the guide member 1010. The first upper retainment tab 1080A and the second upper retainment tab 1080B can, in some embodiments, advantageously inhibit the matrix band from sliding upward and outward from between a patient's teeth. The first upper retainment tab 1080A and the second upper retainment tab 1080B can, in some embodiments, reduce an aspiration risk when installing a dental matrix device including the guide member 1010 in a patient's mouth.

The first upper retainment tab 1080A can attach to or be integrally formed with the top of the cap 1029 and can include a first portion 1086A which extends towards the distal end 1025. The distal edge of the first portion 1086A can taper proximally such that the top of the distal edge of the first portion 1086A is distal from the bottom of the distal edge of the first portion 1086A. Advantageously, the taper of the distal edge of the first portion 1086A can allow a matrix band positioned between the body portion 1026 and the first upper retainment tab 1080A to flare away from the guide member 1010 towards the bottom 1022 thereby improving a gingival seal between the matrix band and a tooth. The first portion 1086A can terminate a distance proximal from the distal end 1025. The first portion 1086A terminating a distance proximal from the distal end 1025 can facilitate a slight recessing of the first portion 1086A relative to the distal edge of the distal end 1025. The first portion 1086A can connect to or be integrally formed with a second portion 1082A near the distal end of the first portion 1086A. The second portion 1082A can extend downward along the height of the guide member 1010. The second portion 1082A extending downward adjacent to the distal end 1025 can engage with a tooth lower down on the tooth. The second portion 1082A can extend from the first portion 1186A of the guide member 1010 towards the bottom 1022. In some embodiments, the second portion 1082A can extend across, across about, or across at least about 90% of the height of the body portion 1026. In some embodiments, the second portion 1082A can extend across, or across about 30% to 100% of the height of the body portion 1026. The second portion 1082A can be at an angle from the first portion 1086A. In some embodiments, the second portion 1082A can be at or at about a 90-degree angle, or at least a 90-degree angle from the first portion 1086A. In some embodiments, the second portion 1082A can be or be about from a 100-degree angle to a 120-degree from the first portion 1086A.

In some embodiments, the second upper retainment tab 1080B can be a mirror image of the first upper retainment tab 1080A. The first upper retainment tab 1080A can be positioned on a first side of a midline 1021 and the second upper retainment tab 1080B can be positioned on a second side of the midline 1021. The midline 1021 is illustrated in FIG. 13A and defined by the point or vertex of the distal end 1025. The second upper retainment tab 1080B can attach to or be integrally formed with the top of the cap 1029 and can include a first portion 1086B which extends towards the distal end 1025. The distal edge of the first portion 1086B can taper proximally such that the top of the distal edge of the first portion 1086B is distal from the bottom of the distal edge of the first portion 1086B. Advantageously, the taper of the distal edge of the first portion 1086B can allow a matrix band positioned between the body portion 1026 and the second upper retainment tab 1080B to flare away from the guide member 1010 towards the bottom 1022 thereby improving a gingival seal between the matrix band and a tooth. The first portion 1086B can connect to or be integrally formed with a second portion 1082B near the distal end of the first portion 1086B. The second portion 1082B can extend downward along the height of the guide member 1010. The second portion 1082B extending downward adjacent to the distal end 1025 can engage with a tooth lower down (e.g., closer to the root) on the tooth. The second portion 1082B can extend from the first portion 1186B of the guide member 1010 towards the bottom 1022. In some embodiments, the second portion 1082B can extend across, across about, or across at least about 90% of the height of the body portion 1026. In some embodiments, the second portion 1082B can extend across, or across about 30% to 100% of the height of the body portion 1026. The second portion 1082B can be at an angle from the first portion 1086B. In some embodiments, the second portion 1082B can be at or at about a 90-degree angle, or at least a 90-degree angle from the first portion 1086B. In some embodiments, the second portion 1082B can be or be about from a 100-degree angle to a 120-degree from the first portion 1086B.

In some embodiments, a gap 1032 can be positioned between the first and second upper retainment tabs 1080A, 1080B. In some embodiments, the gap 1032 can be positioned between the first portion 1086A of the first upper retainment tab 1080A and the first portion 1086B of the second upper retainment tab 1080B. In some embodiments, a matrix band can pass through the gap 1032. In some embodiments, a matrix band can pass through the gap 1032, around the body portion 1026 of the guide member 1010, and then back through the gap 1032. In some embodiments, when the matrix band is positioned around a pair of guide members 1010 and between a pair of teeth, the tension on the matrix band can cause the first upper retainment tab 1080A and the second upper retainment tab 1080B to flex outward, thereby increasing the width of the gap 1032. In some embodiments, a relief slot 1033A can extend from the gap 1032 towards the proximal end 1023. The relief slot 1033A can be positioned above the first portion 1086A. In some embodiments, a relief slot 1033B can extend from the gap 1032 towards the proximal end 1023. The relief slot 1033B can be positioned above the first portion 1086B. The relief slots 1033A and 1033B can advantageously increase the flexibility of the first upper retainment tab 1080A and the second upper retainment tab 1080B (for example and without limitation, the first portion 1086A of the first upper retainment tab 1080A and the first portion 1086B of the second upper retainment tab 1080B) so that the first upper retainment tab 1080A and the second upper retainment tab 1080B and/or the first portion 1086A of the first upper retainment tab 1080A and the first portion 1086B of the second upper retainment tab 1080B, can flex together when driven into the surfaces of the teeth allowing approximation of the paralleling matrix bands in the operable state. The first portion 1086A and the first portion 1086B can advantageously pinch against a matrix band positioned in the gap 1032 towards the top 1024. The contact between the second portions 1082A, 1082B and the tooth lower on the tooth can allow for the pinch to form towards the top 1024 without the first portions 1086A and 1086B extending further distally. The first portions 1086A, 1086B being slightly recessed proximally from the distal edge of the distal end 1025 can advantageously ensure that neither of the first upper retainment tab 1080A nor the second upper retainment tab 1080B extend into a cavity filling region.

In some embodiments, the first upper retainment tab 1080A and the second upper retainment tab 1080B can be integral to the cap 1029 which can be attached to the body portion 1026. In some embodiments, the first upper retainment tab 1080A and the second upper retainment tab 1080B can be integral to the body portion 1026. In some embodiments, the first upper retainment tab 1080A and the second upper retainment tab 1080B can be attached to the body portion 1026. In some embodiments, the first upper retainment tab 1080A and the second upper retainment tab 1080B are separate from and attached to the body portion 1026 of the guide member 1010. The cap 1029 can attach to or couple to the body portion 1026 or be integrally formed with the body portion 1026. In some embodiments, the body portion 1026 can be hollow. In some embodiments, the cap 1029 can snap fit to the body portion 1026 through the top 1024 of the body portion 1026. In some embodiments, the cap 1029 can include two flexible prongs 1028 which can snap fit into an opening in the body portion 1026.

In some embodiments, a matrix band can be received between the first upper retainment tab 1080A of the guide member 1010 and an outside surface of the body portion 1026 of the guide member 1010 such that at least a portion of the matrix band is positioned between the first upper retainment tab 1080A of the guide member 1010 and the body portion 1026 of the guide member 1010 in the operable state. In some embodiments, a matrix band can be received between the second upper retainment tab 1080B of the guide member 1010 and an outside surface of the body portion 1026 of the guide member 1010 such that at least a portion of the matrix band is positioned between the second upper retainment tab 1080B of the guide member 1010 and the body portion 1026 of the guide member 1010 in the operable state. In some embodiments, at least a portion of a matrix band can extend through the gap 1032 in an operable state.

In some embodiments, a first lower retainment element 1044 and/or a second lower retainment element 1046 can couple with or be integrally formed with the body portion 1026. The first lower retainment element 1044 can be positioned proximal from the first upper retainment tab 1080A. The second lower retainment element 1046 can be positioned proximal from the second upper retainment tab 1080B. The first lower retainment element 1044 can be spaced apart from body portion 1026 of the guide member 1010 a distance of, of about, or of at least about 0.002 inches to 0.05 inches in some embodiments. The second lower retainment element 1046 can be spaced apart from body portion 1026 of the guide member 1010 a distance of, of about, or of at least about 0.002 inches to 0.05 inches in some embodiments. The first lower retainment element 1044 and second lower retainment element 1046 can each extend upward from the bottom 1022. The first lower retainment element 1044 can extend across, or across about 30% to 100% of the height of the body portion 1026. In some embodiments, the first lower retainment element 1044 can extend upward to substantially the same height as the first upper retainment tab 1080A extends downward. In some embodiments, the first lower retainment element 1044 can extend upward to a height above the height to which the first upper retainment tab 1080A extends downward. The second lower retainment element 1046 can extend across, or across about 30% to 100% of the height of the body portion 1026. In some embodiments, the second lower retainment element 1046 can extend upward to substantially the same height as the second upper retainment tab 1080B extends downward. In some embodiments, the second lower retainment element 1046 can extend upward to a height above the height to which the second upper retainment tab 1080B extends downward. In some embodiments, the body portion 1026 can be formed without the first lower retainment element 1044 and a second lower retainment element 1046. In some embodiments, the guide member 1010 can be substantially symmetrical across the midline 1021. The first lower retainment element 1044 and the second lower retainment element 1046 can be positioned on opposing sides of the midline 1021 in some embodiments. The first upper retainment tab 1080A and second upper retainment tab 1080B can be positioned on opposing sides of the midline 1021 in some embodiments.

In any embodiments disclosed herein, the guide member 1010 and/or any other components disclosed herein can be formed from a thermoplastic such as Polyethylene (PE), Polypropylene (PP), or Polyetheretherketone (PEEK), ABS, Nylons, Acetal Copolymer, and Composites (e.g. glass or carbon filled) in some embodiments. The guide member 1010 can be formed from silicone or wood in some embodiments. The guide member 1010 can include a rubberized overlay in some embodiments. The guide member 1010 can be injection molded. The guide member 1010 can have or be provided in various sizes. Some embodiments of the guide member 1010 can be small to accommodate a very small tooth, for example a pediatric tooth. Some embodiments of the guide member 1010 can be slightly larger than the pediatric sized guide member to accommodate a small tooth. Some embodiments of the guide member 1010 can be slightly larger than the small sized guide member to accommodate a medium tooth. The guide member 1010 can be slightly larger than the medium band to accommodate a large tooth.

FIG. 13B illustrates a multi-view drawing of the embodiment of the guide member 1010 illustrated in FIG. 13A. FIG. 13B includes a section view A-A which sections a left side view of the guide member 1010 through the distal edge of the upper retainment tab 1080A facing the distal end of the guide member 1010 and a section view B-B which sections a rear view of the guide member 1010 at the top of the lower retainment elements 1044 and 1046 facing the bottom of the guide member 1010. The guide member 1010 can include a height H1 measured from the bottom 1022 to the top 1024, a height H2 measured from the bottom 1022 to the top surface of the body portion 1026 which can be coincident with the bottom surface of the cap 1029, a height H3 measured from the bottom 1022 to the top of the first lower retainment element 1044, a height H4 measured from the bottom 1022 to the bottom of the second portion 1082A, and a height H5 measured from the bottom of the relief slot 1033A to the top of the relief slot 1033A. The guide member 1010 can include a length L1 measured from the distal most of the body portion 1026 at the bottom 1022 to the proximal most point of the guide member 1010, and a length L2 measured from the proximal most point of the guide member 1010 to the distal most point of the body portion 1026 at the top 1024. The guide member 1010 can include a width W1 measured from the outermost point of the first upper retainment tab 1080A to the outermost point of the second upper retainment tab 1080B, a width W2 measuring the width of the top 1024, a width W3 measuring curvature of the tip of the cap 1029, and a width W4 measuring the width of the bottom 1022. In some embodiments, the width W1 can represent the largest width of the guide member. Advantageously, the width W3 can facilitate a shorter nose on the cap which can allow for better access to placing and shaping the dental composite filling material disposed between a tooth and the matrix band when a dental matrix device including the guide member 1010 is disposed in a patient's mouth. The guide member 1010 can include a thickness T1 measuring the gap between the body portion 1026 and the upper retainment tab 1080A, and a thickness T2 measuring the gap between the body portion 1026 and the retainment element 1046. The guide member 1010 can include an angle A1 measuring the angle of the taper of the distal edge of the first portion 1086A, an angle A2 measuring the angle of the slope of the body portion from the bottom 1022 to the top 1024, and an angle A3 measured between the proximal most edge of the first lower retainment element 1044 and the proximal most edge of the second lower retainment element 1046.

The height H1 can be, be about, or be at least about 0.18 inches to 0.4 inches in some embodiments. The height H1 can be, be about, or be at least about 0.20 inches to 0.32 inches in some embodiments. In some embodiments, the height H1 can be, be about, or be at least about 0.20 inches, 0.24 inches, 0.28 inches, or 0.32 inches or any range of values therebetween. The height H2 can be, be about, or be at least about 0.15 inches to 0.32 inches in some embodiments. The height H2 can be, be about, or be at least about 0.16 inches to 0.28 inches in some embodiments. In some embodiments, the height H2 can be, be about, or be at least about 0.16 inches, 0.20 inches, 0.24 inches, or 0.28 inches or any range of values therebetween. In some embodiments, the height H2 can be between, or between about 75% and 95% of the height of H1. In some embodiments, the height H2 can be between, or between about 80% and 90% of the height H1. In some embodiments, the height H2 can be between, or between about 85% and 90% of the height H1. In some embodiments, the height H2 can be, or be about 85%, 87%, or 90% of the height H1. The height H3 can be, be about, or be at least about 0.04 inches to 0.2 inches in some embodiments. The height H3 can be, be about, or be at least about 0.08 inches to 0.16 inches in some embodiments. In some embodiments, the height H3 can be, be about, or be at least about 0.08 inches, 0.1 inches, 0.12 inches, or 0.16 inches or any range of values therebetween. In some embodiments, the height H3 can be between, or between about 20% and 100% of the height of H2. In some embodiments, the height H3 can be between, or between about 25% and 75% of the height H2. In some embodiments, the height H3 can be between, or between about 40% and 60% of the height H2. In some embodiments, the height H3 can be, or be about 40%, 50%, or 60% of the height H2. The height H4 can be, be about, or be at least about 0.03 inches to 0.18 inches in some embodiments. The height H4 can be, be about, or be at least about 0.06 inches to 0.14 inches in some embodiments. In some embodiments, the height H4 can be, be about, or be at least about 0.06 inches, 0.09 inches, 0.12 inches, or 0.16 inches or any range of values therebetween. In some embodiments, the height H4 can be between, or between about 20% and 100% of the height of H2. In some embodiments, the height H4 can be between, or between about 25% and 75% of the height H2. In some embodiments, the height H4 can be between, or between about 35% and 55% of the height H2. In some embodiments, the height H4 can be, or be about 35%, 40%, or 45% of the height H2. The height H5 can be, be about, or be at least about 0 inches to 0.05 inches in some embodiments. The height H5 can be, be about, or be at least about 0 inches to 0.03 inches in some embodiments. In some embodiments, the height H5 can be, be about, or be at least about 0 inches, 0.02 inches, 0.03 inches, or 0.05 inches or any range of values therebetween.

The length L1 can be, be about, or be at least about 0.25 inches to 0.35 inches in some embodiments. The length L1 can be, be about, or be at least about 0.28 inches to 0.32 inches in some embodiments. In some embodiments, the length L1 can be, be about, or be at least about 0.28 inches, 0.29 inches, 0.3 inches, 0.31 inches, 0.32 inches or any range of values therebetween. The length L2 can be, be about, or be at least about 0.2 inches to 0.3 inches in some embodiments. The length L2 can be, be about, or be at least about 0.22 inches to 0.24 inches in some embodiments. In some embodiments, the length L2 can be, be about, or be at least about 0.22 inches, 0.23 inches, or 0.24 inches, or any range of values therebetween. In some embodiments, the length L2 can be between, or between about 70% and 90% of the length L1. In some embodiments, the length L2 can be between, or between about 75% and 85% of the length L1. In some embodiments, the length L2 can be between, or between about 76% and 80% of the length L1. In some embodiments, the length L2 can be, or be about 76%, 77%, or 78% of the length L1.

The width W1 can be, be about, or be at least about 0.2 inches to 0.4 inches in some embodiments. The width W1 can be, be about, or be at least about 0.22 inches to 0.32 inches in some embodiments. In some embodiments, the width W1 can be, be about, or be at least about 0.22 inches, 0.26 inches, 0.3 inches, or 0.32 inches or any range of values therebetween. The width W2 can be, be about, or be at least about 0.18 inches to 0.38 inches in some embodiments. The width W2 can be, be about, or be at least about 0.2 inches to 0.3 inches in some embodiments. In some embodiments, the width W2 can be, be about, or be at least about 0.2 inches, 0.24 inches, 0.28 inches, or 0.3 inches or any range of values therebetween. In some embodiments, the width W2 can be between, or between about 88% and 98% of the width of W1. In some embodiments, the width W2 can be between, or between about 90% and 95% of the width W1. In some embodiments, the width W2 can be between, or between about 92% and 94% of the width W1. In some embodiments, the width W2 can be, or be about 92%, 93%, or 94% of the width W1. The width W3 can be, be about, or be at least about 0 inches to 0.1 inches in some embodiments. The width W3 can be, be about, or be at least about 0.02 inches to 0.08 inches in some embodiments. In some embodiments, the width W3 can be, be about, or be at least about 0.02 inches, 0.04 inches, 0.5 inches, 0.06 inches, 0.07 inches, or 0.08 inches or any range of values therebetween. In some embodiments, the width W3 can be between, or between about 10% and 30% of the width of W1. In some embodiments, the width W3 can be between, or between about 15% and 30% of the width W1. In some embodiments, the width W3 can be between, or between about 20% and 25% of the width W1. In some embodiments, the width W3 can be, or be about 20%, 21%, 22%, 23%, 24%, or 25% of the width W1. The width W4 can be, be about, or be at least about 0.18 inches to 0.28 inches in some embodiments. The width W4 can be, be about, or be at least about 0.2 inches to 0.26 inches in some embodiments. In some embodiments, the width W4 can be, be about, or be at least about 0.2 inches, 0.21 inches, 0.22 inches, 0.23 inches, 0.24 inches, 0.25 inches or 0.26 inches or any range of values therebetween. In some embodiments, the width W4 can be between, or between about 70% and 90% of the width of W1. In some embodiments, the width W4 can be between, or between about 75% and 85% of the width W1. In some embodiments, the width W4 can be between, or between about 78% and 82% of the width W1. In some embodiments, the width W4 can be, or be about 78%, 79%, 80%, 81% or 82% of the width W1.

The thickness T1 can be, be about, or be at least about 0.005 inches to 0.04 inches in some embodiments. The thickness T1 can be, be about, or be at least about 0.01 inches to 0.03 inches in some embodiments. In some embodiments, thickness T1 can be, be about, or be at least about 0.01 inches, 0.015 inches, 0.02 inches, 0.025 inches, or 0.03 inches, or any range of values therebetween. The thickness T2 can be, be about, or be at least about 0.005 inches to 0.04 inches in some embodiments. The thickness T2 can be, be about, or be at least about 0.01 inches to 0.03 inches in some embodiments. In some embodiments, thickness T2 can be, be about, or be at least about 0.01 inches, 0.015 inches, 0.02 inches, 0.025 inches, or 0.03 inches, or any range of values therebetween.

The angle A1 can be, be about, or be at least about 20 degrees to 90 degrees in some embodiments. The angle A1 can be, be about, or be at least about 45 degrees to 90 degrees in some embodiments. In some embodiments, angle A1 can be, be about, or be at least about 45 degrees, 60 degrees, 78 degrees, 90 degrees, or any range of values therebetween. The angle A2 can be, be about, or be at least about 5 degrees to 15 degrees in some embodiments. The angle A2 can be, be about, or be at least about 8 degrees to 12 degrees in some embodiments. In some embodiments, angle A2 can be, be about, or be at least about 8 degrees, 9 degrees, 10 degrees, 11 degrees or 12 degrees, or any range of values therebetween. The angle A3 can be, be about, or be at least about 45 degrees to 180 degrees in some embodiments. The angle A3 can be, be about, or be at least about 60 degrees to 150 degrees in some embodiments. In some embodiments, angle A3 can be, be about, or be at least about 60 degrees, 90 degrees, 120 degrees, or 150 degrees, or any range of values therebetween.

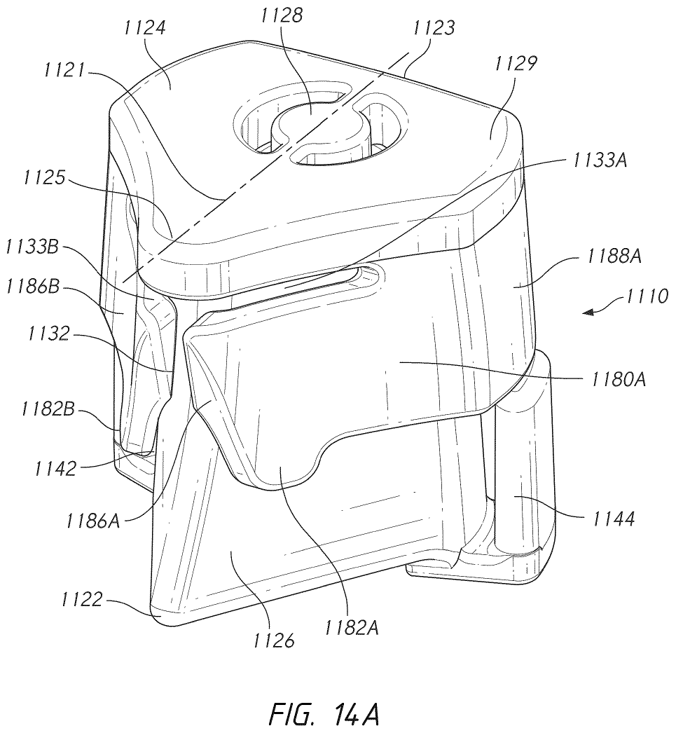

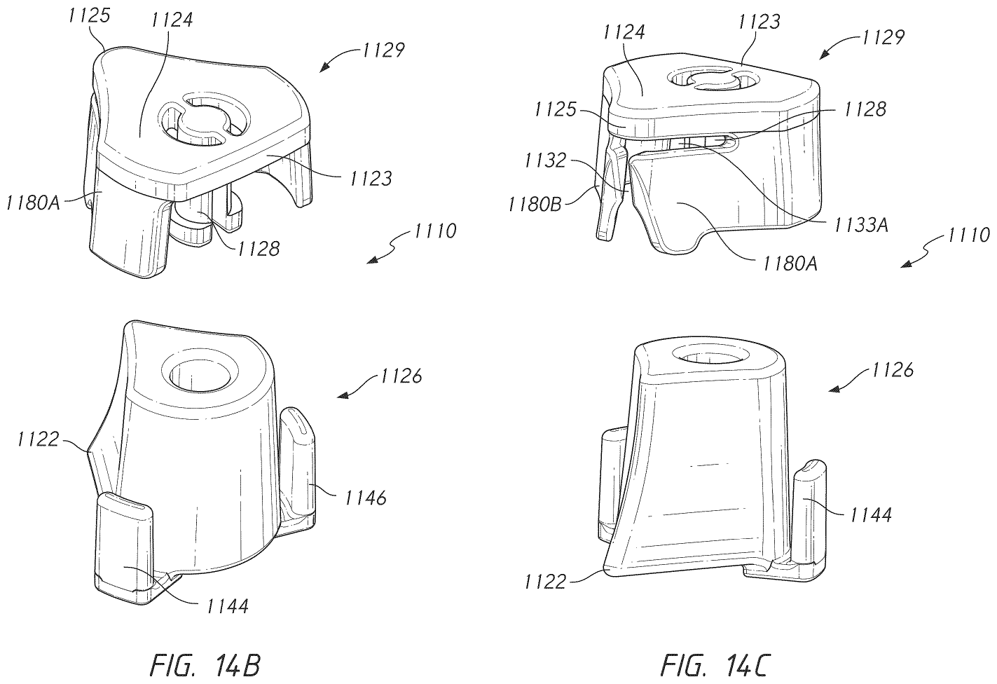

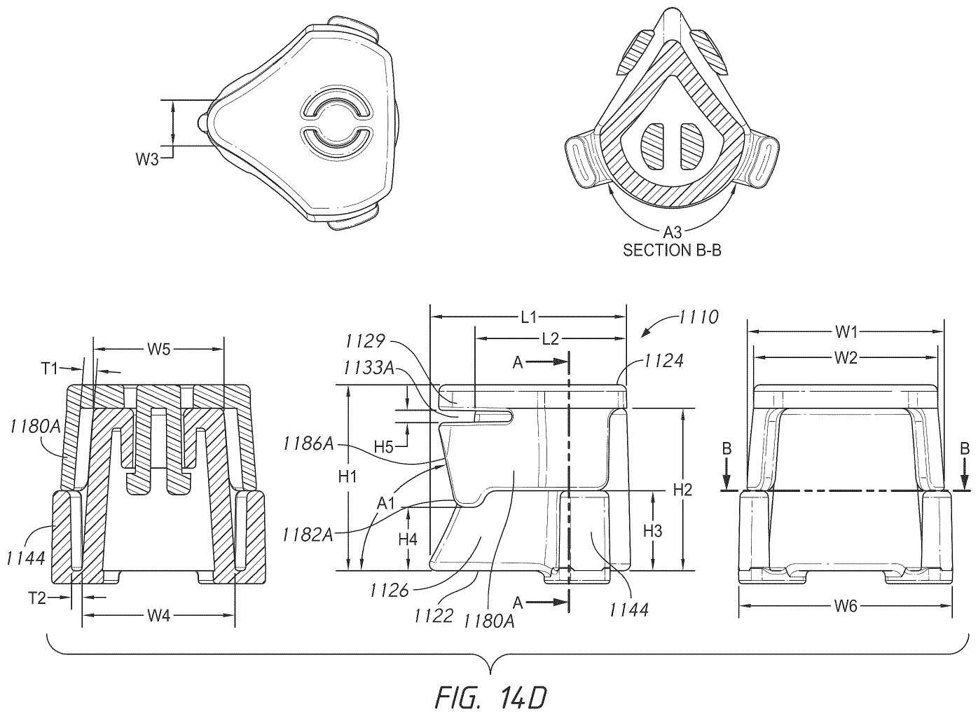

FIGS. 14A-14D illustrate another embodiment of a guide member. In some embodiments, the guide member 1110 can include a body portion 1126 having a proximal end 1123, a distal end 1125, a bottom 1122, and a top 1124. In some embodiments, the distal end 1125 of the body portion 1126 can have a wedge shape. In some embodiments, the body portion 1126 can taper to a point at the distal end 1125. In some embodiments, the distal end 1125 of the body portion 1126 can be longer at the bottom 1122 than the top 1124—e.g., the lower portion of the body portion 1126 can protrude or extend further in the distal direction than the upper portion of the body portion 1126. In some embodiments, the distal end 1125 of the body portion 1126 can be longer at a lower portion than at an upper portion of the body portion. In some embodiments, the bottom 1122 of the distal end 1125 can be 20% or about 20% longer, or at least 20% or about at least 20% longer than the top 1124 of the distal end 1125, or from 15% or about 15% to 40% or about 40% longer. In some embodiments, the top 1124 of the distal end 1125 can be 2% or about 2% longer, or at least 2% or about at least 2% longer than the middle of the distal end 1125, or from 0% or about 0% to 10% or about 10% longer. In some embodiments, the distal end 1125 of the body portion 1126 can be the same length at the bottom 1122 and the top 1124. In some embodiments, the distal end 1125 can have a curved or an hourglass shape between the bottom 1122 and the top 1124. In some embodiments, the distal end 1125 of the guide member 1110 can have a concavely curved profile in a vertical direction, such as between the bottom 1122 and the top 1124. In some embodiments, a distal edge of the distal end 1125 of the body portion 1126 can have a curved profile. In some embodiments, a distal edge of the distal end 1125 of the body portion 1126 can be shaped and configured to fill or substantially fill the embrasure space between a user's teeth. In some embodiments, the distal edge of the distal end 1125 of the body portion 1126 can be a chamfered edge.

In some embodiments, the width of the body portion 1126 can be longer at the bottom 1122 than the top 1124—e.g., the lower portion of the body portion 1126 can be wider than the upper portion of the body portion 1126. In some embodiments, the bottom 1122 of the body portion 1126 can be 16% or about 16% longer, or at least 16% or about at least 16% longer than the top 1124 of the body portion 1126, or from 5% or about 5% to 40% or about 40% longer. The body portion 1126 can taper at an angle of 60 degrees or about 60 degrees, or at least 60 degrees, or about at least 60 degrees from the bottom 1122 to the top 1124 of the body portion 1126, or from 45 degrees or about 45 degrees to 75 degrees or about 75 degrees taper. Advantageously, the taper from the bottom 1122 to the top 1124 allows the distal end 1125 to fit between the teeth at the top.

In some embodiments, the guide member 1110 can include a cap 1129 which can include a first upper retainment tab 1180A (also referred to herein as a first retainment tab, a first retainment element, or a first upper retainment element) and a second upper retainment tab 1180B (also referred to herein as a first retainment tab, a first retainment element, or a first upper retainment element). In some embodiments, the features and components described herein as being included in the cap 1129 can be integrally formed with the body portion 1126. The first upper retainment tab 1180A and the second upper retainment tab 1180B can be spaced around a portion of the perimeter of the top 1124 of the cap 1129 of the guide member 1110. In some embodiments, the first upper retainment tab 1180A and the second upper retainment tab 1180B can be positioned so that the retainment tabs 1180A and 1180B are around an outside surface of the body portion 1126. In some embodiments, the retainment tabs 1180A and 1180B can be spaced apart from the outside surface of the body portion 1126. In some embodiments, the first upper retainment tab 1180A and the second upper retainment tab 1180B can extend towards the distal end 1125 of the body portion 1126. A matrix band can loop around the proximal end 1123 of the body portion 1126 such that the matrix band positioned between the body portion 1126 and the first upper retainment tab 1180A and the body portion 1126 and the second upper retainment tab 1180B. The first upper retainment tab 1180A and the second upper retainment tab 1180B can advantageously guide or restrain a matrix band that is positioned between the outside surface of the body portion 1126 of the guide member 1110 that can receive the matrix band and an inside surface of at least the first upper retainment tab 1180A and the second upper retainment tab 1180B. A lower portion of the matrix band is positioned against or at least biased toward a surface of a tooth and the upper portion of the matrix band is pinched together or at least drawn together by the first upper retainment tab 1180A and the second upper retainment tab 1180B. The first upper retainment tab 1180A can be spaced a distance away from the body portion 1126 of the guide member 1110, thereby forming a channel between the first upper retainment tab 1180A and the body portion 1126 of the guide member 1110 that can receive the matrix band. The first upper retainment tab 1180A can be spaced apart from body portion 1126 of the guide member 1110 a distance of, of about, or of at least about 0.002 inches to 0.05 inches in some embodiments. The first upper retainment tab 1180A can be contoured to conform to the shape of the distal end 1125 of the body portion 1126. The second upper retainment tab 1180B can be spaced a distance away from the body portion 1126 of the guide member 1110, thereby forming a channel between the second upper retainment tab 1180B and the body portion 1126. The second upper retainment tab 1180B can be spaced apart from the body portion 1126 of the guide member 1110 a distance of, of about, or of at least about 0.002 inches to 0.05 inches in some embodiments. The second upper retainment tab 1180B can be contoured to conform to the shape of the distal end 1125 of the body portion 1126.

The first upper retainment tab 1180A and the second upper retainment tab 1180B can advantageously hold a matrix band in place or bias a matrix band to remain in place around the guide member 1110. The first upper retainment tab 1180A and the second upper retainment tab 1180B can, in some embodiments, advantageously inhibit the matrix band from sliding upward and outward from between a patient's teeth. The first upper retainment tab 1180A and the second upper retainment tab 1180B can, in some embodiments, reduce an aspiration risk when installing a dental matrix device including the guide member 1110 in a patient's mouth.

The first upper retainment tab 1180A can attach to or be integrally formed with the top of the cap 1129 and can include a first portion 1186A which extends towards the distal end 1125. The first portion 1186A can terminate a distance proximal from the distal end 1125. The first portion 1186A terminating the distance proximal from the distal end 1125 can facilitate a slight recessing of the first portion 1186A relative to the distal edge of the distal end 1125. The first portion 1186A can connect to or be integrally formed with a second portion 1182A near the distal end of the first portion 1186A. The second portion 1182A can extend downward along the height of the guide member 1110. The second portion 1182A extending downward adjacent to the distal end 1125 can engage with a tooth lower down on the tooth. The second portion 1182A can extend from the first portion 1186A of the guide member 1110 towards the bottom 1122. In some embodiments, the second portion 1182A can extend across, across about, or across at least about 90% of the height of the body portion 1126. In some embodiments, the second portion 1182A can extend across, or across about 30% to 100% of the height of the body portion 1126. The second portion 1182A can be at an angle from the first portion 1186A. In some embodiments, the second portion 1182A can be at or at about a 90-degree angle, or at least a 90-degree angle from the first portion 1186A. In some embodiments, the second portion 1182A can be or be about from a 100-degree angle to a 120-degree from the first portion 1186A.

In some embodiments, the second upper retainment tab 1180B can be a mirror image of the first upper retainment tab 1180A. The first upper retainment tab 1180A can be positioned on a first side of a midline 1121 and the second upper retainment tab 1180B can be positioned on a second side of the midline 1121. The midline 1121 is illustrated in FIG. 14A and defined by the point or vertex of the distal end 1125. The second upper retainment tab 1180B can attach to or be integrally formed with the top of the cap 1129 and can include a first portion 1186B which extends towards the distal end 1125. The first portion 1186B can connect to or be integrally formed with a second portion 1182B near the distal end of the first portion 1186B. The second portion 1182B can extend downward along the height of the guide member 1110. The second portion 1182B extending downward adjacent to the distal end 1125 can engage with a tooth lower down on the tooth. The second portion 1182B can extend from the first portion 1186B of the guide member 1110 towards the bottom 1122. In some embodiments, the second portion 1182B can extend across, across about, or across at least about 90% of the height of the body portion 1126. In some embodiments, the second portion 1182B can extend across, or across about 30% to 100% of the height of the body portion 1126. The second portion 1182B can be at an angle from the first portion 1186B. In some embodiments, the second portion 1182B can be at or at about a 90-degree angle, or at least a 90-degree angle from the first portion 1186B. In some embodiments, the second portion 1182B can be or be about from a 100-degree angle to a 120-degree from the first portion 1186B.

In some embodiments, a gap 1132 can be positioned between the first and second upper retainment tabs 1180A, 1180B. In some embodiments, the gap 1132 can be positioned between the first portion 1186A of the first upper retainment tab 1180A and the first portion 1186B of the second upper retainment tab 1180B. In some embodiments, a matrix band can pass through the gap 1132. In some embodiments, a matrix band can pass through the gap 1132, around the body portion 1126 of the guide member 1110, and then back through the gap 1132. In some embodiments, when the matrix band is positioned around a pair of guide members 1110 and between a pair of teeth, the tension on the matrix band can cause the first upper retainment tab 1180A and the second upper retainment tab 1180B to flex outward, thereby increasing the width of the gap 1132. In some embodiments, a relief slot 1133A can extend from the gap 1132 towards the proximal end 1123. The relief slot 1133A can be positioned above the first portion 1186A. In some embodiments, a relief slot 1133B can extend from the gap 1132 towards the proximal end 1123. The relief slot 1133B can be positioned above the first portion 1186B. The relief slots 1133A and 1133B can advantageously increase the flexibility of the first upper retainment tab 1180A and the second upper retainment tab 1180B (for example and without limitation, the first portion 1186A of the first upper retainment tab 1180A and the first portion 1186B of the second upper retainment tab 1180B) so that the first upper retainment tab 1180A and the second upper retainment tab 1180B and/or the first portion 1186A of the first upper retainment tab 1180A and the first portion 1186B of the second upper retainment tab 1180B, can flex together when driven into the surfaces of the teeth allowing approximation of the paralleling matrix bands in the operable state. The first portion 1186A and the first portion 1186B can advantageously pinch against a matrix band positioned in the gap 1132 towards the top 1124. The contact between the second portions 1182A, 1182B and the tooth lower on the tooth can allow for the pinch to form towards the top 1124 without the first portions 1186A and 1186B extending further distally. The first portions 1186A, 1186B being slightly recessed proximally from the distal edge of the distal end 1125 can advantageously ensure that neither of the first upper retainment tab 1180A or the second upper retainment tab 1180B extend into a cavity filling region.

In some embodiments, the first upper retainment tab 1180A and the second upper retainment tab 1180B can be integral to the cap 1129 which can be attached to the body portion 1126. In some embodiments, the first upper retainment tab 1180A and the second upper retainment tab 1180B can be integral to the body portion 1126. In some embodiments, the first upper retainment tab 1180A and the second upper retainment tab 1180B can be attached to the body portion 1126. In some embodiments, the first upper retainment tab 1180A and the second upper retainment tab 1180B are separate from and attached to the body portion 1126 of the guide member 1110. The cap 1129 can attach to or couple to the body portion 1126 or be integrally formed with the body portion 1126. In some embodiments, the body portion 1126 can be hollow. In some embodiments, the cap 1129 can snap fit to the body portion 1126 through the top 1124 of the body portion 1126. In some embodiments, the cap 1129 can include two flexible prongs 1128 which can snap fit into an opening in the body portion 1126.

In some embodiments, a matrix band can be received between the first upper retainment tab 1180A of the guide member 1110 and an outside surface of the body portion 1126 of the guide member 1110 such that at least a portion of the matrix band is positioned between the first upper retainment tab 1180A of the guide member 1110 and the body portion 1126 of the guide member 1110 in the operable state. In some embodiments, a matrix band can be received between the second upper retainment tab 1180B of the guide member 1110 and an outside surface of the body portion 1126 of the guide member 1110 such that at least a portion of the matrix band is positioned between the second upper retainment tab 1180B of the guide member 1110 and the body portion 1126 of the guide member 1110 in the operable state. In some embodiments, at least a portion of a matrix band can extend through the gap 1132 in an operable state.

In some embodiments, a first lower retainment element 1144 and/or a second lower retainment element 1146 can attach to or be integrally formed with the body portion 1126. The first lower retainment element 1144 can be positioned distal from a proximal edge of the first upper retainment tab 1180A. The second lower retainment element 1146 can be positioned distal from a proximal edge of the second upper retainment tab 1180B. The first lower retainment element 1144 can be spaced apart from body portion 1126 of the guide member 1110 a distance of, of about, or of at least about 0.002 inches to 0.05 inches in some embodiments. The second lower retainment element 1146 can be spaced apart from body portion 1126 of the guide member 1110 a distance of, of about, or of at least about 0.002 inches to 0.05 inches in some embodiments. The first lower retainment element 1144 and second lower retainment element 1146 can each extend upward from the bottom 1122. The first lower retainment element 1144 can extend across, or across about 30% to 100% of the height of the body portion 1126. In some embodiments, the first lower retainment element 1144 can extend upward to substantially the same height as the first upper retainment tab 1180A extends downward. In some embodiments, the first lower retainment element 1144 can extend upward to a height above the height to which the first upper retainment tab 1180A extends downward. The second lower retainment element 1146 can extend across, or across about 30% to 100% of the height of the body portion 1126. In some embodiments, the second lower retainment element 1146 can extend upward to substantially the same height as the second upper retainment tab 1180B extends downward. In some embodiments, the second lower retainment element 1146 can extend upward to a height above the height to which the second upper retainment tab 1180B extends downward. In some embodiments, the body portion 1126 can be formed without the first lower retainment element 1144 and a second lower retainment element 1146. In some embodiments, the guide member 1110 can be substantially symmetrical across the midline 1121. The first lower retainment element 1144 and the second lower retainment element 1146 can be positioned on opposing sides of the midline 1121 in some embodiments. The first upper retainment tab 1180A and second upper retainment tab 1180B can be positioned on opposing sides of the midline 1121 in some embodiments.

In any embodiments disclosed herein, the guide member 1110 and/or any other components disclosed herein can be formed from a thermoplastic such as Polyethylene (PE), Polypropylene (PP), or Polyetheretherketone (PEEK), ABS, Nylons, Acetal Copolymer, and Composites (e.g. glass or carbon filled) in some embodiments. The guide member 1110 can be formed from silicone or wood in some embodiments. The guide member 1110 can include a rubberized overlay in some embodiments. The guide member 1110 can be injection molded. The guide member 1110 can have or be provided in various sizes. Some embodiments of the guide member 1110 can be small to accommodate a very small tooth, for example a pediatric tooth. Some embodiments of the guide member 1110 can be slightly larger than the pediatric sized guide member to accommodate a small tooth. Some embodiments of the guide member 1110 can be slightly larger than the small sized guide member to accommodate a medium tooth. The guide member 1110 can be slightly larger than the medium band to accommodate a large tooth.

FIG. 14B illustrates a multi-view drawing of the embodiment of the guide member 1110 illustrated in FIG. 14A. FIG. 14B includes a section view A-A which sections a left side view of the guide member 1110 through the distal edge of the upper retainment tab 1180A facing the distal end of the guide member 1110 and a section view B-B which sections a rear view of the guide member 1110 at the top of the lower retainment elements 1144 and 1146 facing the bottom of the guide member 1110. The guide member 1110 can include a height H1 measured from the bottom 1122 to the top 1124, a height H2 measured from the bottom 1122 to the top surface of the body portion 1126 which can be coincident with the bottom surface of the cap 1129, a height H3 measured from the bottom 1122 to the top of the first lower retainment element 1144, a height H4 measured from the bottom 1122 to the bottom of the second portion 1182A, and a height H5 measured from the bottom of the relief slot 1133A to the top of the relief slot 1133A. The guide member 1010 can include a length L1 measured from the distal most of the body portion 1026 at the bottom 1022 to the proximal most point of the guide member 1010, and a length L2 measured from the proximal most point of the guide member 1010 to the distal most point of the body portion 1026 at the top 1024. The guide member 1110 can include a width W1 measured from the outermost point of the first upper retainment tab 1180A to the outermost point of the second upper retainment tab 1180B, a width W2 measuring the width of the top 1124, a width W3 measuring curvature of the tip of the cap 1129, a width W4 measuring the width of the bottom 1122, and a width W5 measuring the width of the top 1124 of the body portion 1126. Advantageously, the width W3 can facilitate a shorter nose on the cap which can allow for better access to placing and shaping the dental composite filling material disposed between a tooth and the matrix band when a dental matrix device including the guide member 1110 is disposed in a patient's mouth. The guide member 1110 can include a thickness T1 measuring the gap between the body portion 1126 and the upper retainment tab 1180A, and a thickness T2 measuring the gap between the body portion 1126 and the first lower retainment element 1144. The guide member 1110 can include an angle A1 measuring the angle of the taper of the distal edge of the first portion 1086A, and an angle A3 measured between the proximal most edge of the first lower retainment element 1044 and the proximal most edge of the second lower retainment element 1046.

The height HI can be, be about, or be at least about 0.18 inches to 0.4 inches in some embodiments. The height H1 can be, be about, or be at least about 0.20 inches to 0.32 inches in some embodiments. In some embodiments, the height H1 can be, be about, or be at least about 0.20 inches, 0.24 inches, 0.28 inches, or 0.32 inches or any range of values therebetween. The height H2 can be, be about, or be at least about 0.15 inches to 0.32 inches in some embodiments. The height H2 can be, be about, or be at least about 0.16 inches to 0.28 inches in some embodiments. In some embodiments, the height H2 can be, be about, or be at least about 0.16 inches, 0.20 inches, 0.24 inches, or 0.28 inches or any range of values therebetween. In some embodiments, the height H2 can be between, or between about 75% and 95% of the height of H1. In some embodiments, the height H2 can be between, or between about 80% and 90% of the height H1. In some embodiments, the height H2 can be between, or between about 85% and 90% of the height H1. In some embodiments, the height H2 can be, or be about 85%, 87%, or 90% of the height H1. The height H3 can be, be about, or be at least about 0.04 inches to 0.2 inches in some embodiments. The height H3 can be, be about, or be at least about 0.08 inches to 0.16 inches in some embodiments. In some embodiments, the height H3 can be, be about, or be at least about 0.08 inches, 0.1 inches, 0.12 inches, or 0.16 inches or any range of values therebetween. In some embodiments, the height H3 can be between, or between about 20% and 100% of the height of H2. In some embodiments, the height H3 can be between, or between about 25% and 75% of the height H2. In some embodiments, the height H3 can be between, or between about 40% and 60% of the height H2. In some embodiments, the height H3 can be, or be about 40%, 50%, or 60% of the height H2. The height H4 can be, be about, or be at least about 0.03 inches to 0.18 inches in some embodiments. The height H4 can be, be about, or be at least about 0.06 inches to 0.14 inches in some embodiments. In some embodiments, the height H4 can be, be about, or be at least about 0.06 inches, 0.09 inches, 0.12 inches, or 0.16 inches or any range of values therebetween. In some embodiments, the height H4 can be between, or between about 20% and 100% of the height of H2. In some embodiments, the height H4 can be between, or between about 25% and 75% of the height H2. In some embodiments, the height H4 can be between, or between about 35% and 55% of the height H2. In some embodiments, the height H4 can be, or be about 35%, 40%, or 45% of the height H2. The height H5 can be, be about, or be at least about 0 inches to 0.05 inches in some embodiments. The height H5 can be, be about, or be at least about 0 inches to 0.03 inches in some embodiments. In some embodiments, the height H5 can be, be about, or be at least about 0 inches, 0.02 inches, 0.03 inches, or 0.05 inches or any range of values therebetween.

The length L1 can be, be about, or be at least about 0.25 inches to 0.35 inches in some embodiments. The length L1 can be, be about, or be at least about 0.28 inches to 0.32 inches in some embodiments. In some embodiments, the length L1 can be, be about, or be at least about 0.28 inches, 0.29 inches, 0.3 inches, 0.31 inches, 0.32 inches or any range of values therebetween. The length L2 can be, be about, or be at least about 0.2 inches to 0.3 inches in some embodiments. The length L2 can be, be about, or be at least about 0.22 inches to 0.24 inches in some embodiments. In some embodiments, the length L2 can be, be about, or be at least about 0.22 inches, 0.23 inches, or 0.24 inches, or any range of values therebetween. In some embodiments, the length L2 can be between, or between about 70% and 90% of the length L1. In some embodiments, the length L2 can be between, or between about 75% and 85% of the length L1. In some embodiments, the length L2 can be between, or between about 76% and 80% of the length L1. In some embodiments, the length L2 can be, or be about 76%, 77%, or 78% of the length L1.

The width W1 can be, be about, or be at least about 0.2 inches to 0.4 inches in some embodiments. The width W1 can be, be about, or be at least about 0.22 inches to 0.32 inches in some embodiments. In some embodiments, the width W1 can be, be about, or be at least about 0.22 inches, 0.26 inches, 0.3 inches, or 0.32 inches or any range of values therebetween. The width W2 can be, be about, or be at least about 0.18 inches to 0.38 inches in some embodiments. The width W2 can be, be about, or be at least about 0.2 inches to 0.3 inches in some embodiments. In some embodiments, the width W2 can be, be about, or be at least about 0.2 inches, 0.24 inches, 0.28 inches, or 0.3 inches or any range of values therebetween. In some embodiments, the width W2 can be between, or between about 88% and 98% of the width of W1. In some embodiments, the width W2 can be between, or between about 90% and 95% of the width W1. In some embodiments, the width W2 can be between, or between about 92% and 94% of the width W1. In some embodiments, the width W2 can be, or be about 92%, 93%, or 94% of the width W1. The width W3 can be, be about, or be at least about 0 inches to 0.1 inches in some embodiments. The width W3 can be, be about, or be at least about 0.02 inches to 0.08 inches in some embodiments. In some embodiments, the width W3 can be, be about, or be at least about 0.02 inches, 0.04 inches, 0.5 inches, 0.06 inches, 0.07 inches, or 0.08 inches or any range of values therebetween. In some embodiments, the width W3 can be between, or between about 10% and 30% of the width of W1. In some embodiments, the width W3 can be between, or between about 15% and 30% of the width W1. In some embodiments, the width W3 can be between, or between about 20% and 25% of the width W1. In some embodiments, the width W3 can be, or be about 20%, 21%, 22%, 23%, 24%, or 25% of the width W1. The width W4 can be, be about, or be at least about 0.18 inches to 0.28 inches in some embodiments. The width W4 can be, be about, or be at least about 0.2 inches to 0.26 inches in some embodiments. In some embodiments, the width W4 can be, be about, or be at least about 0.2 inches, 0.21 inches, 0.22 inches, 0.23 inches, 0.24 inches, 0.25 inches or 0.26 inches or any range of values therebetween. In some embodiments, the width W4 can be between, or between about 70% and 90% of the width of W1. In some embodiments, the width W4 can be between, or between about 75% and 85% of the width W1. In some embodiments, the width W4 can be between, or between about 78% and 82% of the width W1. In some embodiments, the width W4 can be, or be about 78%, 79%, 80%, 81% or 82% of the width W1. The width W5 can be, be about, or be at least about 0.15 inches to 0.25 inches in some embodiments. The width W5 can be, be about, or be at least about 0.18 inches to 0.22 inches in some embodiments. In some embodiments, the width W4 can be, be about, or be at least about 0.18 inches, 0.19 inches, 0.20 inches, 0.21 inches, or 0.22 inches, or any range of values therebetween. In some embodiments, the width W5 can be between, or between about 75% and 95% of the width of W4. In some embodiments, the width W5 can be between, or between about 80% and 90% of the width W5. In some embodiments, the width W5 can be between, or between about 82% and 88% of the width W4. In some embodiments, the width W5 can be, or be about 82%, 83%, 84%, 85%, 86%, 87%, or 88% of the width W5.

The thickness T1 can be, be about, or be at least about 0.005 inches to 0.04 inches in some embodiments. The thickness T1 can be, be about, or be at least about 0.01 inches to 0.03 inches in some embodiments. In some embodiments, thickness T1 can be, be about, or be at least about 0.01 inches, 0.015 inches, 0.02 inches, 0.025 inches, or 0.03 inches, or any range of values therebetween. The thickness T2 can be, be about, or be at least about 0.005 inches to 0.04 inches in some embodiments. The thickness T2 can be, be about, or be at least about 0.01 inches to 0.03 inches in some embodiments. In some embodiments, thickness T2 can be, be about, or be at least about 0.01 inches, 0.015 inches, 0.02 inches, 0.025 inches, or 0.03 inches, or any range of values therebetween.

The angle A1 can be, be about, or be at least about 20 degrees to 90 degrees in some embodiments. The angle A1 can be, be about, or be at least about 45 degrees to 90 degrees in some embodiments. In some embodiments, angle A1 can be, be about, or be at least about 45 degrees, 60 degrees, 78 degrees, 90 degrees, or any range of values therebetween. The angle A3 can be, be about, or be at least about 45 degrees to 180 degrees in some embodiments. The angle A3 can be, be about, or be at least about 90 degrees to 180 degrees in some embodiments. In some embodiments, angle A3 can be, be about, or be at least about 90 degrees, 120 degrees, 150 degrees, or 180 degrees, or any range of values therebetween.

Advantageously, in an operable state, the first and second retainment tabs of any of the embodiments of guide members illustrated in FIGS. 5A-11 and 13A-14D (e.g., guide members 210, 310, 410, 510, 610, 710, 810, 1010, and 1110) can apply pressure to the upper portions of a matrix band while under tension. The pressure applied to the upper portions of the matrix band can cause the matrix band to be pressed against itself. The proximity of the upper portions of the matrix band can advantageously improve the shape and quality of a filling retained in a dental matrix device in an operable state. The combination of the shape (e.g., wedge shaped and/or having a longer bottom portion than top portion) of the distal end of the body portion with the first and second retainment tabs can advantageously cause temporary orthodontic distraction and provide a dual purpose of pressing a bottom portion of the matrix band against the teeth and pressing the upper portion of the matrix band against itself. This dual purpose can advantageously provide anatomical replication of tooth contour from the proximal cervical margin to the top of the marginal ridge. Advantageously, the relief slots can reduce the likelihood of creasing of the matrix band during assembly. Additionally the relief slots allow the matrix bands to pinch together when in the operable state.

Advantageously, the cap of any of the embodiments of guide members illustrated in FIGS. 5A-11 and 13A-14D (e.g., guide members 210, 310, 410, 510, 610, 710, 810, 1010, and 1110) can make the assembly of guide member into a dental matrix device casier by allowing for a matrix band to be laced around a first guide member and a second guide member and then installing a cap onto each respective guide member. The assembly of the matrix band onto the guide members and then assembling the caps can reduce the likelihood of misassembling the system. Additionally, the caps can reduce the likelihood that the matrix band will slide off of the guide members, thereby reducing the risk of aspiration of the dental matrix device and improve the ease of installation of the device in a patient's mouth.

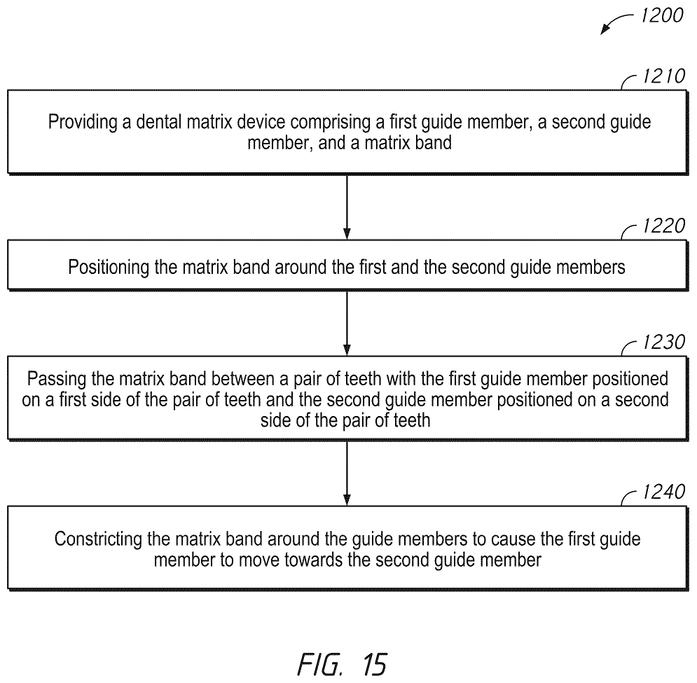

FIG. 15 illustrates an embodiment of a method 1200 of providing stable confinement during placement of dental filling material when repairing an interproximal tooth structure. At step 1210, the method 1200 can include providing a dental matrix device comprising a first guide member, a second guide member, and a matrix band. In some embodiments, the first guide member can include a cap, a pair of upper retainment elements, and a pair of lower retainment elements, and the second guide member can include a cap, a pair of upper retainment elements, and a pair of lower retainment elements. At step 1220, the method 1200 can include positioning the matrix band around the first and the second guide members. In some embodiments, the matrix band can be positioned around the distal end of the first guide member and around the distal end of the second guide member. In some embodiments, the method can include positioning the matrix band between the lower retainment elements and the body of the first guide member. In some embodiments, the method can include positioning the matrix band between the lower retainment elements and the body of the second guide member. In some embodiments, the method can include positioning the cap of the first guide member over the matrix band. In some embodiments, the method can include positioning the cap of the second guide member over the matrix band. At step 1230, the method 1200 can include passing the matrix band between a pair of teeth with the first guide member positioned on a first side of the pair of teeth and the second guide member positioned on a second side of the pair of teeth. In some embodiments, the matrix band passes through the space between the pair of teeth twice, once on a first side of the first and second guide members and once on a second side of the first and second guide members. In some embodiments, a matrix retainer can attach to the ends of the matrix band at the distal end of one of the first guide member or the second guide member. At step 1240, the method 1200 can matrix include constricting the band around the guide members to cause the first guide member to move toward the second guide member. In some embodiments, the matrix band can be constricted around the guide members via the matrix retainer. In some embodiments, the constriction of the matrix band can cause the two guide members to move toward each other between the teeth, providing the temporary orthodontic distraction needed to perform a dental filling. Note that the steps of the foregoing method can be changed so that certain steps can be performed before other steps. For example, and without limitation, in some embodiments, the matrix band can be positioned between a pair of teeth before positioning the matrix band around the first and second guide members.

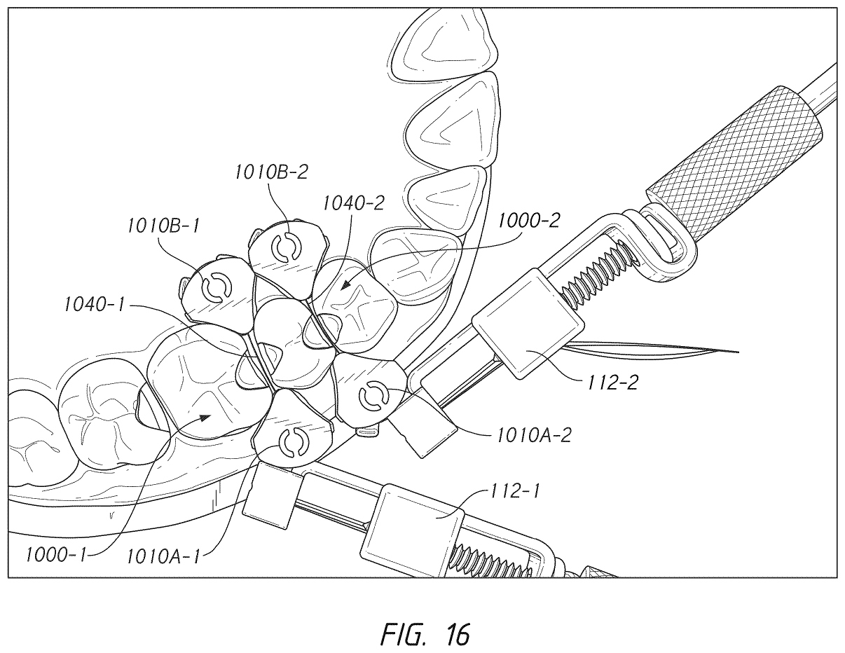

FIG. 16 illustrates a perspective view of a pair of dental matrix devices 1000, a portion of each dental matrix device 1000 is placed between a pair of teeth in successive pairs of teeth (e.g., back to back). As illustrated, a first pair of prepared teeth in a dental model and a second pair of prepared teeth adjacent to the first pair are shown. A first dental matrix device 1000-1 can be positioned between the first pair of teeth. A second dental matrix device 1000-2 can be positioned between the second pair of teeth. In some embodiments, the first dental matrix device 1000-1 can be placed between the first pair of teeth and then the second dental matrix device 1000-2 can be placed between the second pair of teeth.

In some embodiments of the dental matrix device 1000-1 includes a pair of guide members 1010A-1, 1010B-1, a matrix band 1040-1, and an instrument 112-1 (referred to herein as a matrix retainer or matrix tensioner) that can be used to at least tension or tighten the matrix band 1040-1. In some embodiments, both ends of the matrix band 1040-1 can be coupled with or held by the matrix retainer 112-1 so that a middle portion of the matrix band 1040-1 extends from the matrix retainer 112-1 in looping fashion. A portion of the matrix band 1040-1 can be positioned between a pair of teeth while the matrix band 1040-1 extends or loops completely around at least a proximal end of a body portion 1026-1 of one of the guide members 1010B-1 and around at least a portion of a body portion 1026-1 of the other of the guide members 1010A-1 that is closer to the matrix retainer 112-1. Advantageously, a cap 1029-1 can be coupled with (e.g., without limitation, snapped onto) each of the body portions 1026-1 to retain the matrix band 1040-1. In some embodiments, as the matrix retainer 112-1 is used to tighten the matrix band 1040-1, the tightening of the matrix band 1040-1 will cause the two guide members 1010A-1, 1010B-1 to move toward each other between the teeth, providing the temporary orthodontic distraction needed to perform a dental filling, for example.

In some embodiments of the dental matrix device 1000-2 includes a pair of guide members 1010A-2, 1010B-2, a matrix band 1040-2, and an instrument 112-2 (referred to herein as a matrix retainer or matrix tensioner) that can be used to at least tension or tighten the matrix band 1040-2. In some embodiments, both ends of the matrix band 1040-2 can be coupled with or held by the matrix retainer 112-2 so that a middle portion of the matrix band 1040-2 extends from the matrix retainer 112-2 in a looping fashion. A portion of the matrix band 1040-2 can be positioned between a pair of teeth while the matrix band 1040-2 extends or loops completely around a body portion 1026-2 of one of the guide members 1010B-2 and around at least a portion of a body portion 1026-2 of the other of the guide members 1010A-2 that is closer to the matrix retainer 112-2. Advantageously, a cap 1029-2 can be snapped onto each of the body portions 1026-2 to retain the matrix band 1040-2. As the matrix retainer 112-2 is used to tighten the matrix band 1040-2, the tightening of the matrix band 1040-2 will cause the two guide members 1010A-2, 1010B-2 to move toward each other between the teeth, providing the temporary orthodontic distraction needed to perform a dental filling, for example.

Advantageously, the guide members 1010A-1, 1010B-1, 1010A-2, 1010B-2 are all sized such that the dental matrix devices 1000-1 and 1000-2 can be placed between successive pairs of teeth. The width of the guide members 1010A-1, 1010B-1, 1010A-2, and 1010B-2 are advantageously narrower than half the width of a tooth. In some embodiments, further dental matrix devices can be placed between successive pairs of teeth. In some embodiments, 2, 3, 4, 5, 6, or more dental matrix devices, or any range of values therebetween, can be place between successive pairs of teeth.

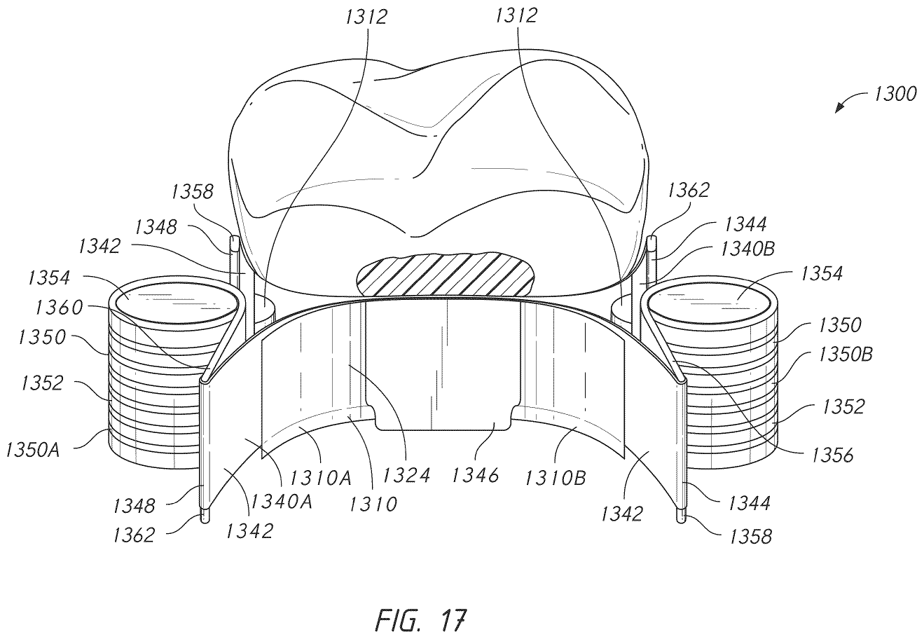

FIG. 17 illustrates a perspective view of some embodiments of a dental matrix device 1300 in an operable position between a pair of teeth. As illustrated, a prepared tooth is shown, and the adjacent tooth is omitted from this figure for a clearer view of the dental matrix device 1300. But, in normal operating conditions, the dental matrix devices disclosed herein would typically be positioned between two adjacent teeth. In some embodiments of the dental matrix device 1300, the dental matrix device 1300 includes a pair of guide members 1310A, 1310B, a pair of matrix bands 1340A, 1340B, and a pair of retainment members 1350A, 1350B.

In some embodiments, the dental matrix device 1300 includes two matrix bands: a first matrix band 1340A and a second matrix band 1340B. Each matrix band 1340A, 1340B can include a matrix band body 1342. A first end of the matrix band body 1342 can include a first coupling element 1344 and a second end of the first matrix band body 1342 can include a second coupling element 1348. In some embodiments, the first coupling element 1344 and the second coupling element 1348 are each a partially or fully cylindrical loop formed into a respective end of the matrix band 1340.

In some embodiments, the first coupling element 1344 of the first matrix band 1340A attaches to a first retainment portion 1358 of a second retainment member 1350B. In some embodiments, the second coupling element 1348 of the first matrix band 1340A attaches to a second retainment portion 1362 of a first retainment member 1350A. In some embodiments, the first coupling element 1344 of the second matrix band 1340B attaches to a second retainment portion 1362 of the second retainment member 1350B. In some embodiments, the second coupling element 1348 of the second matrix band 1340B attaches to a first retainment portion 1358 of the first retainment member 1350A. A first guide member 1310A can be positioned around the first matrix band 1340A and the second matrix band 1340B. The first guide member 1310A can include a first side wall 1322 (not shown in FIG. 17) and a second side wall 1324. In some embodiments, the first side wall 1322 can have or form a wall of a first channel. The second matrix band 1340B can be positioned at least partially within the first channel. The second side wall 1324 can have or form a wall of a second channel. The first matrix band 1340A can be positioned at least partially within the second channel. In some embodiments, a second guide member 1310B is positioned around the first matrix band 1340A and the second matrix band 1340B. The second guide member 1310B can include a first side wall 1322 adjacent to the first matrix band 1340A and a second side wall 1324 (not shown in FIG. 17) adjacent to the second matrix band 1340B. In some embodiments, the first side wall 1322 can have or form wall of a first channel which the first matrix band 1340A can be positioned at least partially within. The second side wall 1324 can have or form a wall of a second channel which the second matrix band 1340B can be positioned at least partially within.

In some embodiments, the matrix band body 1342 of the first matrix band 1340A is positioned interior of the first guide member 1310A and adjacent to the second side wall 1324 of the first guide member 1310A (e.g., the matrix band body 1342 of the first matrix band 1340A is positioned within the second channel of the first guide member 1310A) and the matrix band body 1342 of the first matrix band 1340A is positioned interior to the second guide member 1310B and adjacent to the first side wall 1322 of the second guide member 1310B (e.g., the matrix band body 1342 of the first matrix band 1340A is positioned within the first channel of the second guide member 1310B). In some embodiments, the matrix band body 1342 of the second matrix band 1340B is positioned interior of the first guide member 1310A and adjacent to the first side wall 1322 of the first guide member 1310A (e.g., the matrix band body 1342 of the second matrix band 1340B is positioned within the first channel of the first guide member 1310A) and the matrix band body 1342 of the second matrix band 1340B is positioned interior to the second guide member 1310B and adjacent to the second side wall 1324 of the second guide member 1310B (e.g., the matrix band body 1342 of the second matrix band 1340B is positioned within the second channel of the second guide member 1310B). The first guide member 1310A can be adjacent to the first retainment member 1350A. The second guide member 1310B can be adjacent to the second retainment member 1350B. In some embodiments, the retainment members are housed within the guide members.

In some embodiments, each matrix band 1340A and 1340B can include an extension portion 1346 which is positioned between the first guide member 1310A and the second guide member 1310B. The first guide member 1310A and the second guide member 1310B can be sized to accommodate matrix bands 1340A and 1340B of varying heights (e.g., pediatric, small, medium, or large matrix bands), matrix bands 1340A and 1340B that include an extension portion 1346, and/or matrix bands 1340A and 1340B that do not include an extension portion 1346.

In some embodiments, each retainment member 1350 is or includes a torsional spring and can include a helically coiled portion 1352, a first connecting portion 1356 which connects the helically coiled portion 1352 to the first retainment portion 1358, and a second connecting portion 1360 which connects the helically coiled portion 1352 to the second retainment portion 1362. A single wire can form the entirety of the retainment member 1350. The single wire structure can advantageously simplify the retainment member 1350 and reduce the cost of the retainment member 1350. The wire can form the helically coiled portion 1352 and a first end of the wire can extend tangentially from the helically coiled portion 1352 to form the first connecting portion 1356 and the first retainment portion 1358 and a second end of the wire can extend tangentially from the helically coiled portion 1352 to form the second connecting portion 1360 and the second retainment portion 1362. In some embodiments, the first retainment portion 1358 and the second retainment portion 1362 are each a wire arm. The first retainment portion 1358 can slide into to a first coupling element 1344 of a matrix band 1340. The second retainment portion 1362 can slide into a second coupling element 1348 of a matrix band 1340. The first retainment portion 1358 can be positioned parallel to the central axis of the helically coiled portion 1352 and the second retainment portion 1362 can be positioned parallel to the central axis of the helically coiled portion 1352. The helically coiled portion 1352 can have a space 1354 in its center. The retainment members can be made from a Nitinol alloy, a stainless-steel alloy, a chromium-nickel-cobalt alloy, a titanium chromium alloy, or another material.

As illustrated, in some embodiments, the dental matrix device 1300 is positioned between a pair of teeth and each matrix band 1340A, 1340B spans between the pair of teeth. The first matrix band 1340A can be positioned adjacent to the adjacent tooth (not shown) and the second matrix band 1340B can be positioned adjacent to the prepared tooth. The matrix bands 1340A and 1340B may be symmetrical with each other, or they may be asymmetrical so that the matrix band better matches the anatomy of the tooth adjacent to the matrix band. The first guide member 1310A and the first retainment member 1350A can be positioned at a first end of the gap between the pair of teeth. The first end of the gap can be on the buccal side of the teeth. The second guide member 1310B and the second retainment member 1350B can be positioned at a second end of the gap between pair of teeth. The second end of the gap can be on the lingual side of the teeth. The first guide member 1310A may be symmetrical with the second guide member 1310B. The first retainment member 1350A may be symmetrical with the second retainment member 1350B. The dental matrix device 1300 may be symmetrical from the buccal side of the teeth to the lingual side of the teeth.

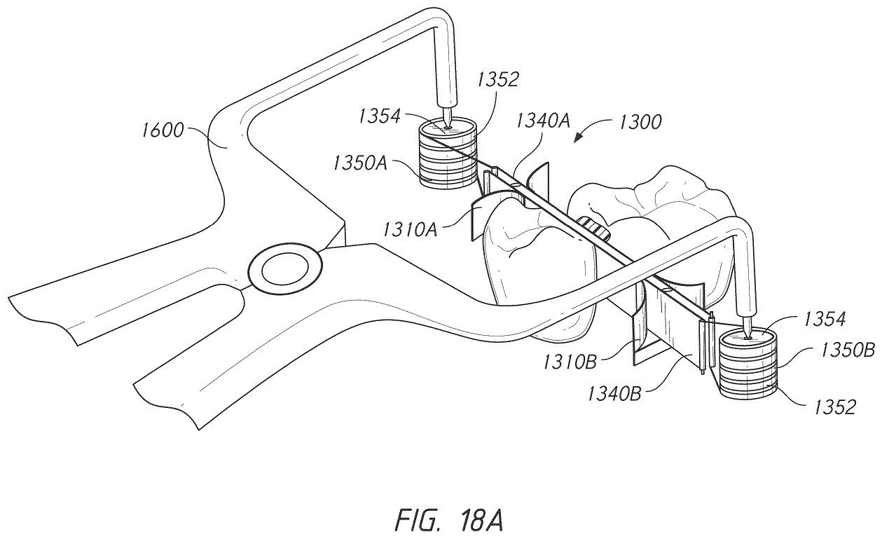

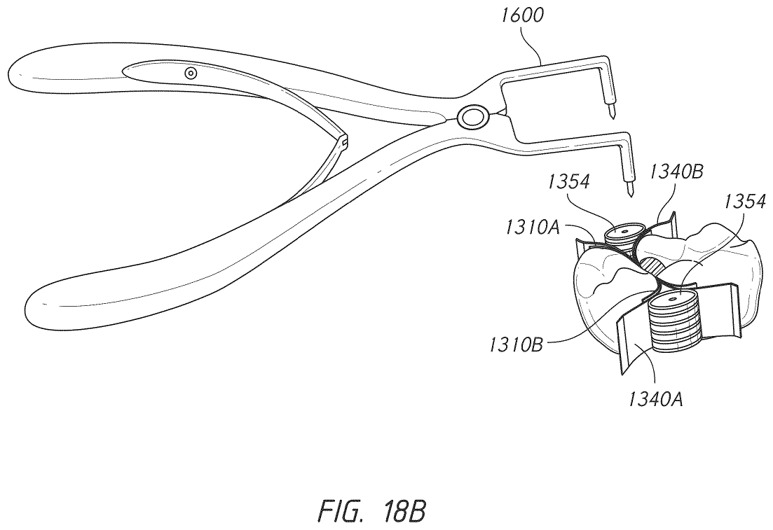

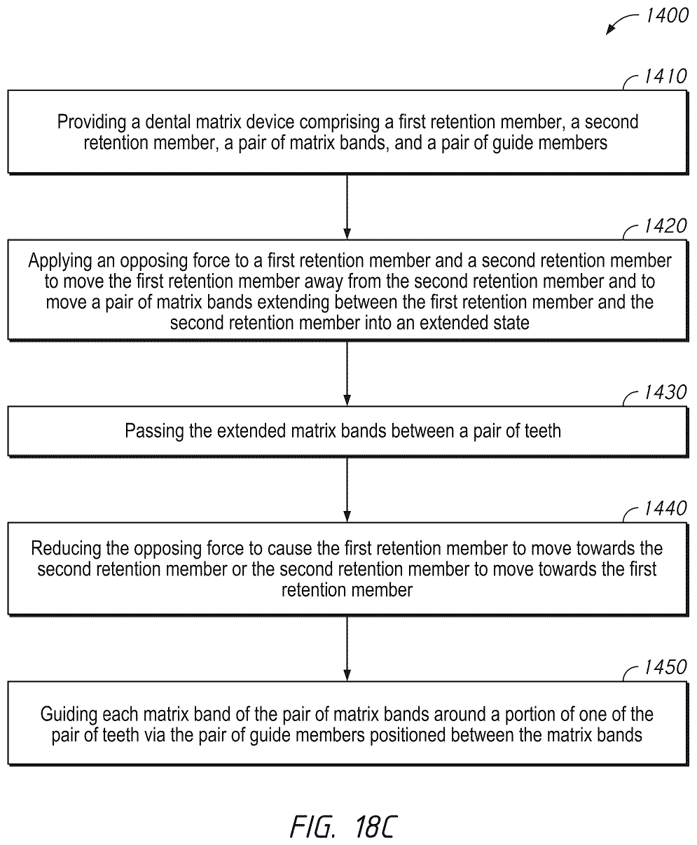

FIGS. 18A-18C illustrate the placement of the dental matrix device illustrated in FIG. 17. As illustrated in FIG. 18A, in some embodiments, the tips of snap ring pliers 1600 are inserted into the space 1354 of the helically coiled portion 1352 of each of the retainment members 1350A and 1350B. By squeezing the snap ring pliers 1600, the retainment members 1350A and 1350B can be compressed and the matrix bands 1340A and 1340B can be placed in tension, extending into an elongate and extended state, and pressed lengthwise against each other in an extended state. In this extended state, the matrix bands 1340A and 1340B can pass between a pair of teeth. Advantageously, the dental matrix device 1300 can be self-contained, therefore, during the placement of the dental matrix device 1300, the dental matrix device 1300 can be placed as a single unit using a single pair of snap ring pliers 1600. The placement of the dental matrix device 1300 may not require separate placement of any single component of the dental matrix device 1300.

As illustrated in FIG. 18B, in some embodiments, once the matrix bands 1340A, 1340B are positioned between the pair of teeth, the snap ring pliers 1600 are released from the space 1354 of the helically coiled portion 1352 of each of the retainment member 1350A, 1350B. The retainment members 1350A and 1350B can decompress after releasing the snap ring pliers 1600. In some embodiments, as the retainment member 1350B decompresses, the first coupling element 1344 of matrix band 1340A and the first coupling element 1344 of matrix band 1340B are pulled apart from each other and the guide member 1310B is pushed between the teeth. As the retainment member 1350A decompresses, the second coupling element 1348 of the matrix band 1340A and the second coupling element 1348 of the matrix band 1340B can be pulled apart from each other and the guide member 1310A is pushed between the teeth. In some embodiments, the guide members 1310A and 1310B limit (e.g., inhibit or stop) the inward movement of the retainment member 1350A and 1350B which can cause first matrix band 1340A to re-tension around a first tooth and second matrix band 1340B to re-tension around a second tooth. The guide members 1310A and 1310B can also create temporary orthodontic distraction (e.g., the teeth are moved slightly apart from one another while the guide members are in position, then, when the guide members are removed, the teeth return to their original position). In some embodiments, the temporary orthodontic distraction advantageously allows the filled tooth to be properly spaced from the adjacent tooth once the filling has cured and the dental matrix device has been removed. The matrix band re-tensioning and temporary orthodontic distraction can advantageously create a stable confinement for the placement and curing of a dental filling while repairing an interproximal tooth structure.

In some embodiments, FIG. 18C illustrates a method 1400 of placing the dental matrix device 1300. At step 1410 the method 1400 can include providing a dental matrix device comprising a first retainment member, a second retainment member, a pair of matrix bands, and a pair of guide members. At step 1420, an opposing force can be applied to the first retainment member and the second retainment member to move the first retainment member away from the second retainment member and to move the pair of matrix bands extending between the first retainment member and the second retainment member into an extended state. At step 1430, the extended matrix bands can be passed between a pair of teeth. At step 1440, the method 1400 can include reducing the opposing force to cause the first retainment member to move toward the second retainment member or the second retainment member to move toward the first retainment member. At step 1450, the method 1400 can include guiding each matrix band around a portion of one of the pair of teeth via the pair of guide members positioned between the matrix bands.

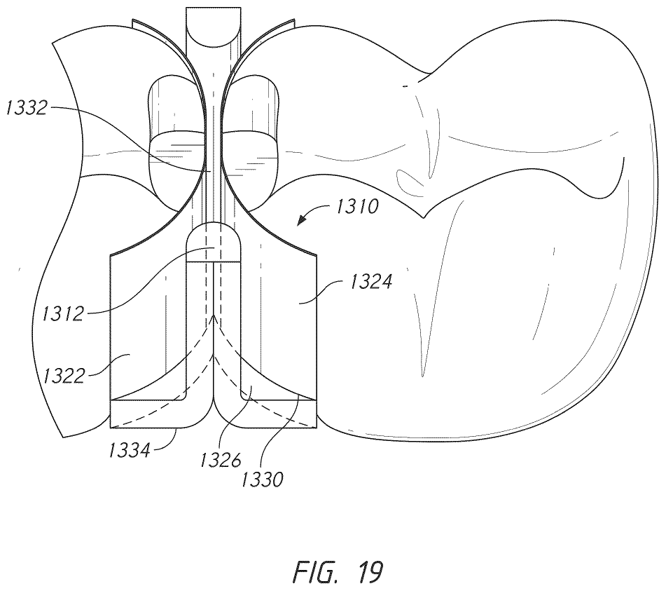

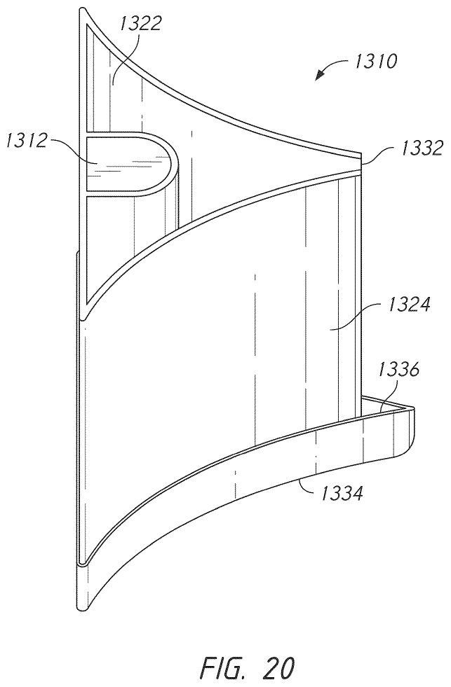

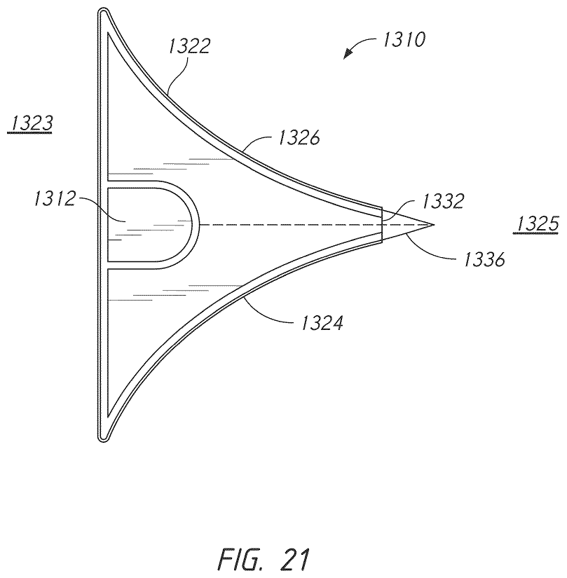

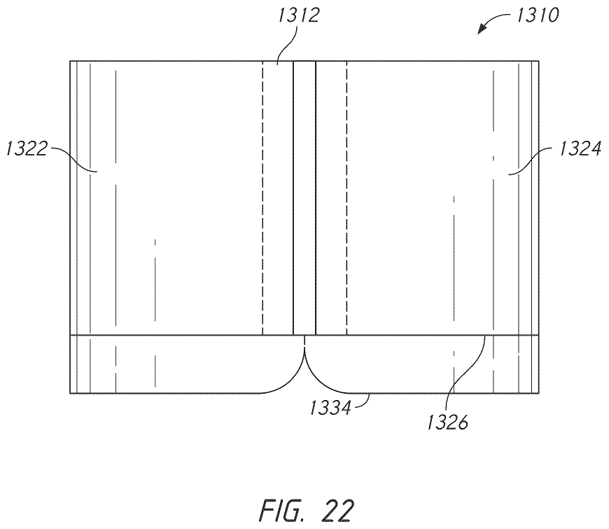

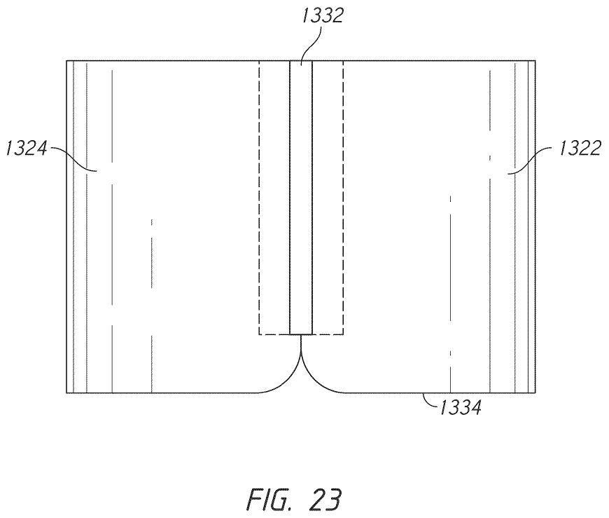

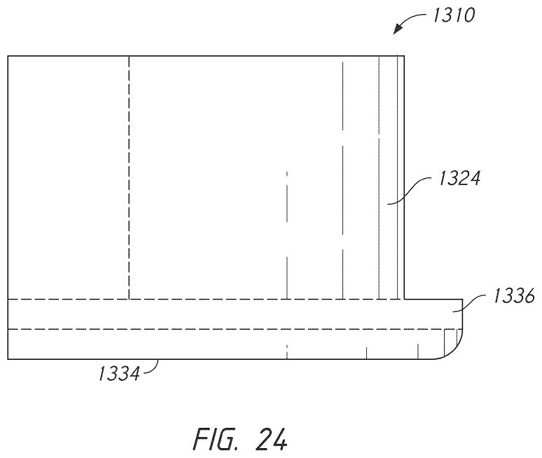

FIGS. 19-24 illustrate a guide member 1310. In some embodiments, the guide member 1310 includes a first side wall 1322 and a second side wall 1324. The guide member 1310 can include a tapered shape. The side walls 1322 and 1324 can form a wedge shape having a wide end 1323 and a narrow end 1325. An inner side of the first side wall 1322 can form a first channel configured to guide a matrix band 1340 and an inner side of the second side wall 1324 can form a second channel configured to guide another matrix band 1340. There can be a gap 1392 between the first side wall 1322 and the second side wall 1324 at the narrow end 1325 of the guide member 1310. The first side wall 1322 and the second side wall 1324 can attach to an inner base 1326 and an outer base 1334. The outer base 1334 can sit against the gums between a pair of teeth. A mounting feature 1312 can protrude from the inner base 1326. The mounting feature 1312 can attach to a cover element 1370. As best shown in FIG. 20, the guide member 1310 can include a lip 1336. The lip 1336 can extend past the gap 1332. The lip 1336 can include a curved surface extending from the outer base 1334 toward the inner base 1326.

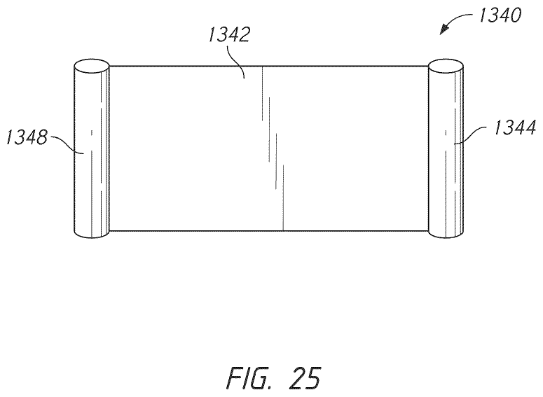

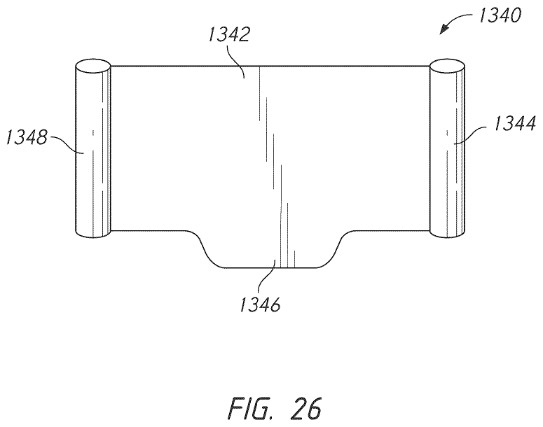

FIGS. 25 and 26 illustrate some embodiments of a matrix band 1340. In some embodiments, the matrix band 1340 includes a matrix band body 1342. The matrix band body 1342 can be configured to slide between a pair of teeth and span the vertical height of a tooth to retain a cavity filling. The matrix band body 1342 can be thin, elongate, and flexible. The matrix band body 1342 can be made from a Nitinol alloy, a stainless-steel alloy, a chromium-nickel-cobalt alloy, a titanium chromium alloy, or another material. The matrix band body 1342 can be contoured to form to the shape of a tooth. The matrix band body 1342 can be rectangular. The matrix band body 1342 can have various vertical heights. The vertical height of the matrix band body 1342 can be small to accommodate a very small tooth height, for example a pediatric tooth. The vertical height of the matrix band body 1342 can be slightly taller than pediatric band to accommodate a small tooth height, for example a small tooth. The vertical height of the matrix band body 1342 can be slightly taller than the small band to accommodate a medium tooth height, for example a medium tooth. The vertical height of the matrix band body 1342 can be slightly taller than the medium band to accommodate a large tooth height, for example a large tooth. Advantageously, the dental matrix device 1300 can be used with any height of matrix band body described herein. For example, the same guide members 1310 and retainment members 1350 can be used with a pediatric sized band, a small sized band, a medium sized band, or a large sized band.

In some embodiments, a first end of the matrix band body 1342 includes a first coupling element 1344 and a second end of the first matrix band body 1342 includes a second coupling element 1348. The first coupling element 1344 can be integral to the matrix band body 1342. The second coupling element 1348 can be integral to the matrix band body 1342. In some embodiments, the first coupling element 1344 can attach to a first end of the matrix band body 1342 and the second coupling element 1348 can attach to a second end of the matrix band body 1342. In some embodiments, the first coupling element 1344 and the second coupling element 1348 are each a loop formed in a respective end of the matrix band 1340, which can be made from a sheet of metal, such as spring steel, stainless steel, Nitinol, or otherwise. In some embodiments, the first coupling element 1344 and the second coupling element 1348 are each a clamping portion (e.g., a cutout, hole, or protrusion which a retainment member can attach to) formed into a respective end of the matrix band 1340.

As illustrated in FIG. 26, in some embodiments, the matrix band 1340 can include an extension portion 1346 extending from a position at or near a midpoint in the elongate length of the matrix band body 1342. The extension portion 1346 can increase the effective height of the matrix band body 1342 near a cavity. The extension portion 1346 allows for the filling of cavities where the damaged portion of a tooth extends toward the gumline or below. The extension portion 1346 can have a height between 0 mm and 3.5 mm. As illustrated in FIG. 25, in some embodiments, the matrix band 1340 cannot include an extension portion 1346 (i.e., can be formed without the extension portion 1346). Advantageously, the dental matrix device 1300 can be used with a matrix band 1340 including an extension portion 1346 and/or with a matrix band 1340 without an extension portion 1346. For example, the same guide members 1310 and retainment members 1350 can be used with a matrix band 1340 including an extension portion 1346 and/or with a matrix band 1340 without an extension portion 1346.

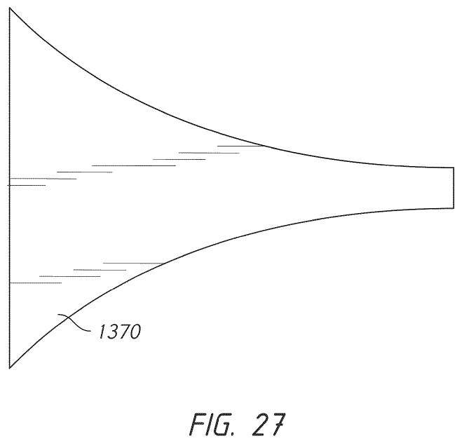

FIG. 27 illustrates an embodiment of the cover element 1370. In some embodiments, the cover element 1370 is wedge shaped, matching the shape of the guide member 1310. The cover element 1370 can fit over the matrix bands 1340A and 1340B which can pass through the guide member 1310. The cover element 1370 can hold the dental matrix device 1300 together. The cover element 1370 can advantageously retain the guide members 1310 around the matrix bands 1340 while placing the dental matrix device 1300. The cover element 1370 can fit onto the guide member 1310 without a retainment mechanism. The cover element 1370 can snap onto the guide member 1310 or attach to the guide member 1310 through other means.

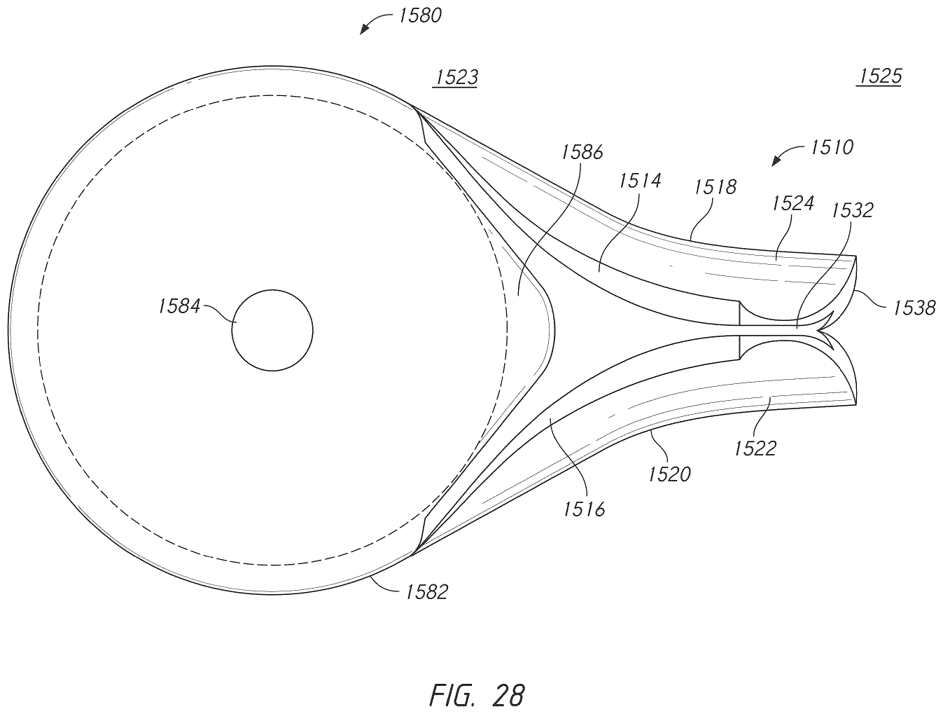

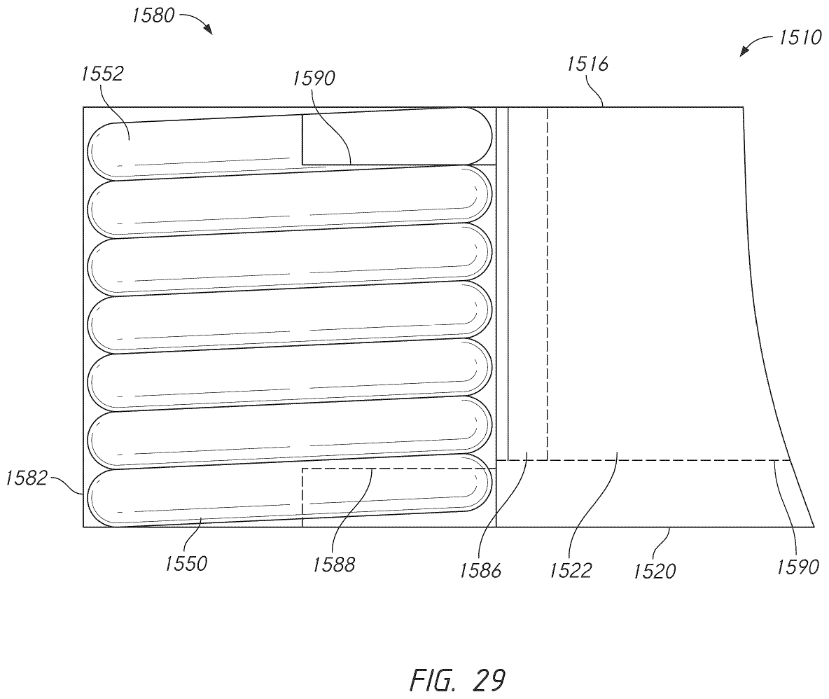

FIGS. 28 and 29 illustrate another example of a guide member 1510. In some embodiments, guide member 1510 can include many similar components and features as the guide member 1310 illustrated in FIGS. 17-24. The components and features of the guide member 1510 can be applied to the guide member 1310. Additionally, dental matrix device 1300 can utilize guide member 1510.

In some embodiments, guide member 1510 includes a first side wall 1522 and a second side wall 1524. The side walls 1522 and 1524 form a wedge shape having a wide end 1523 and a narrow end 1525. An inner side of the first side wall 1522 can form a first channel configured to guide a matrix band 1140 and an inner side of the second side wall 1524 can form a second channel configured to guide another matrix band 1140. There is a gap 1532 between the first side wall 1522 and the second side wall 1524 at the narrow end 1525. The first side wall 1522 can have a bottom edge 1520 and a top edge 1516. The second side wall 1524 can have a bottom edge 1518 and a top edge 1514. In some embodiments, the first side wall 1522 and second side wall 1524 each have a contoured profile. In some embodiments, the bottom edge 1520 of the first side wall 1522 is spaced apart from the from the bottom edge 1518 of the second side wall 1524. In some embodiments, the top edge 1516 of the first side wall 1522 is spaced apart from the top edge 1514 of the second side wall 1524. In some embodiments, the space between the top edge 1516 of the first side wall 1522 and the top edge 1514 of the second side wall 1524 can be less than the space between the bottom edge 1520 of the first side wall 1522 and the bottom edge 1518 of the second side wall. In some embodiments, between the bottom edge 1520 and the top edge 1516, the first side wall 1522 contours towards the second side wall 1524 and between the bottom edge 1518 and the top edge 1514, the second side wall 1524 contours towards the first side wall 1522. The contour of the first side wall 1522 and the second side wall 1524 can form an hourglass shape.

In some embodiments, the curved contour of the first side wall 1522 can be anatomically curved to contact and conform to the shape of a tooth. The curved contour of the second side wall 1524 can be anatomically curved to contact and conform to the shape of another tooth. In the gap 1532 the guide member 1510 includes a relief channel 1538 which can span the length of the guide member 1510. The relief channel 1538 can create space for the interdental papilla when the dental matrix device 1100 is installed. When the dental matrix device 1100 is positioned between a pair of teeth, the hourglass curvature of the first side wall 1522 and the second side wall 1524 can maintain the tension force on the matrix bands 1140A and 1140B in a horizontal direction. In some embodiments, the horizontal direction of the tension force advantageously stops the matrix bands from sliding downward and driving into the gingival tissue between the teeth.

In some embodiments, the guide member 1510 mounts to a housing 1580. The housing 1580 can include a mounting feature 1586 which attaches to the guide member 1510. The mounting feature 1586 may attach to the guide member 1510 with various means. For example, the mounting feature 1586 may slide into a portion of the guide member 1510, the mounting feature 1586 may snap onto the guide member 1510, or the mounting feature 1586 may be bolted to the guide member 1510.

In some embodiments, a retainment member 1150 can fit within the housing 1580. The housing 1580 can have a cylindrical body 1552. The retainment member 1150 can be positioned within the cylindrical body 1552. The housing 1580 can include a hole 1584 an upper surface of the cylindrical body 1552. The hole 1584 can be positioned concentrical to the cylindrical body 1552. The hole 1584 can engage a snap ring plier. As best shown in FIG. 29, the cylindrical body 1552 can have a lower cutout 1588 and an upper cutout 1590. The lower cutout 1588 and upper cutout 1590 can be positioned on opposing sides of the cylindrical body 1552. When housing 1580 is mounted to the guide member 1510, the upper cutout 1590 can be positioned adjacent to the first side wall 1522 of the guide member 1510 and the lower cutout 1588 can be positioned adjacent to the second side wall 1524 of the guide member 1510. The lower cutout 1588 can be sized to have one of the retainment portions of a retainment member pass through the lower cutout 1588 and out of the housing 1580. The upper cutout 1590 can be sized to have another of the retainment portions of a retainment member can pass through the upper cutout 1590 and out of the housing 1580. The housing 1580 can advantageously increase the stability of the dental matrix device 1100, improving the case with which the dental matrix device 1100 can be placed as a single unit.

In some embodiments, the dental matrix device 1100 can be a kit having a pair of guide members 1510 a pair of matrix bands 1140 and a pair of retainment members 1150. The pair of guide members 1510 can each include any of the features described herein. The pair of matrix bands 1140 can each include any of the features described herein, and the pair of retainment members 1150 can include any of the features described herein.

Terms of orientation used herein, such as “top,” “bottom,” “proximal,” “distal,” “longitudinal,” “lateral,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures but can encompass structures that are reasonably close approximations.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

Several illustrative examples of dental matrix band devices and/or methods of use have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one example in this disclosure can be combined or used with (or instead of) any other portion of any of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain embodiments, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of this disclosure. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain embodiments, advantages, and features of this disclosure have been described herein. Not all, or any such advantages are necessarily achieved in accordance with any particular example of the present disclosure. No embodiments of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of dental matrix devices and related methods have been disclosed. This disclosure extends beyond the specifically disclosed examples to other alternative examples and/or other uses of the examples, as well as to certain modifications and equivalents thereof. Moreover, this disclosure expressly contemplates that various features and embodiments of the disclosed examples can be combined with, or substituted for, one another. Accordingly, the scope of this disclosure should not be limited by the particular disclosed examples described above but should be determined only by a fair reading of the claims.

What is claimed is:

1. A dental matrix device, comprising:
a first guide member comprising a body portion having a proximal end and a distal end, the first guide member configured to be positioned on a first side of a pair of teeth such that, in an operable state of the dental matrix device, the distal end of the body portion of the first guide member is positioned closer to the pair of teeth than the proximal end of the first guide member;
a second guide member comprising a body portion comprising a proximal end and a distal end, the second guide member configured to be positioned on a second side of the pair of teeth such that, in the operable state, the distal end of the body portion of the second guide member is positioned closer to the pair of teeth than the proximal end of the second guide member; and
a matrix band configured to, in the operable state of the dental matrix device, extend around at least a portion of the first guide member, between the pair of teeth, and around at least a portion of the second guide member;
wherein:
the second side of the pair of teeth is opposite the first side of the pair of teeth; and
the matrix band is configured to provide a barrier between the teeth during a dental procedure.

2. The dental matrix device of claim 1, wherein the distal end of the first guide member comprises a wedge shape, and wherein the distal end of the second guide member comprises a wedge shape.

3. The dental matrix device of claim 1, wherein, in the operable state of the dental matrix device, the dental matrix device is configured to force the first guide member to move toward the second guide member when the matrix band is tightened around at least a portion of the first and the second guide members.

4. The dental matrix device of claim 1, wherein the first guide member comprises a first retainment element, wherein the first guide member is configured to receive the matrix band between the first retainment element of the first guide member and an outside surface of the body portion of the first guide member such that at least a portion of the matrix band is positioned between the first retainment element of the first guide member and the body portion of the first guide member in the operable state.

5. The dental matrix device of claim 4, wherein the first guide member comprises a second retainment element, wherein the first guide member is configured to receive the matrix band between the second retainment element of the first guide member and an outside surface of the body portion of the first guide member such that at least a portion of the matrix band is positioned between the second retainment element of the first guide member and the body portion of the first guide member in the operable state.

6. The dental matrix device of claim 5, wherein the first retainment element comprises a first portion extending towards the distal end of the body portion and a second portion extending towards a bottom of the body portion, and wherein the second retainment element comprises a first portion extending towards the distal end of the body portion and a second portion extending towards the bottom of the body portion.

7. The dental matrix device of claim 6, wherein the second portion of the first retainment element is positioned towards the distal end of the body portion and the second portion of the second retainment element is positioned towards the distal end of the body portion.

8. The dental matrix device of claim 6, wherein a distal edge of the first portion of the first retainment element tapers proximally from a top of the first portion to the bottom of the first portion such that the top of the first portion of the first retainment element extends further in a distal direction than the bottom of the first portion of the first retainment element, and wherein a distal edge of the first portion of the second retainment element tapers proximally from a top of the first portion to the bottom of the first portion such that the top of the first portion of the second retainment element extends further in a distal direction than the bottom of the first portion of the second retainment element.

9. The dental matrix device of claim 5, further comprising a gap between the first retainment element and the second retainment element such that at least a portion of the matrix band extends through the gap.

10. The dental matrix device of claim 5, wherein the first retainment element and the second retainment element are integral to a cap positioned over the body portion of the first guide member.

11. The dental matrix device of claim 5, wherein the first guide member comprises a first lower retainment element positioned closer to a bottom than a top of the first guide member, wherein the first guide member is configured to receive the matrix band between the first lower retainment element of the first guide member and an outside surface of the body portion of the first guide member such that at least a portion of the matrix band is positioned between the first lower retainment element of the first guide member and the body portion of the first guide member in the operable state.

12. The dental matrix device of claim 11, wherein the first guide member comprises a second lower retainment element positioned closer to the bottom than the top of the first guide member, wherein the first guide member is configured to receive the matrix band between the second retainment element of the first guide member and the outside surface of the body portion of the first guide member such that at least a portion of the matrix band is positioned between the second retainment element of the first guide member and the body portion of the first guide member in the operable state.

13. The dental matrix device of claim 12, wherein the first and the second retainment elements of the first guide member are integral to the body portion of the first guide member.

14. The dental matrix device of claim 12, wherein an angle between a proximal edge of the first lower retainment element and a proximal edge of the second retainment element of the second guide member is between 90 and 150 degrees.

15. The dental matrix device of claim 2, wherein the distal end of the body portion of each of the first and the second guide members is longer at a lower portion than at an upper portion.

16. The dental matrix device of claim 15, wherein the body portion of each of the first and the second guide members comprises a first width at a bottom of the body portion and a second width at a top of the body portion wherein the first width is wider than the second width.

17. A method of providing stable confinement during placement of dental filling material when repairing an interproximal tooth structure, the method comprising:
providing a dental matrix device comprising a first guide member, a second guide member, and a matrix band;
positioning the matrix band around the first and the second guide members;
passing the matrix band between a first pair of teeth with the first guide member positioned on a first side of the first pair of teeth and the second guide member positioned on a second side of the first pair of teeth; and
constricting the matrix band around the first and the second guide members to cause the first guide member to move toward the second guide member.

18. The method of claim 17, further comprising:
providing a second dental matrix device comprising a first guide member, a second guide member, and a matrix band;
positioning the matrix band around the first and the second guide members;
passing the matrix band between a second pair of teeth with the first guide member positioned on a first side of the second pair of teeth and the second guide member positioned on a second side of the second pair of teeth, wherein the second pair of teeth is in successive to the first pair of teeth; and
constricting the matrix band around the first and the second guide members to cause the first guide member to move towards the second guide member.

19. The method of claim 18, further comprising:
attaching a cap to the first guide member over the matrix band and attaching a second cap to the second guide member over the matrix band.

20. A system for performing a repair of dental defects, the system comprising:
a first guide member comprising a body portion comprising a proximal end and a distal end, the first guide member configured to be positioned on a first side of a pair of teeth such that, in an operable state, the distal end of the body portion of the first guide member is positioned closer to the pair of teeth than the proximal end of the first guide member;
a second guide member comprising a body portion comprising a proximal end and a distal end, the second guide member configured to be positioned on a second side of the pair of teeth such that, in the operable state, the distal end of the body portion of the second guide member faces toward the pair of teeth;
a matrix band configured to, in the operable state, extend around at least a portion of the first guide member, between the pair of teeth, and around at least a portion of the second guide member; and
a matrix retainer configured to selectively tighten the matrix band around the first and the second guide members in the operable state of the system.
